(19) United States
(12) Patent Application Publication
(10) Pub. No.: US 2026/0249439 A1
(43) Pub. Date: Aug. 27, 2026

(54) POWER TOOL WITH HIGH AND LOW FIELD WEAKENING STATES

(71) Applicant: MILWAUKEE ELECTRIC TOOL CORPORATION, Brookfield, WI (US)

(72) Inventors: Matthew Leidel, Wind Lake, WI (US); Jacob G. Wood, Waukesha, WI (US); Jacob P. Schneider, Cedarburg, WI (US)

(21) Appl. No.: 19/104,465

(22) PCT Filed: Aug. 24, 2023
(86) PCT No.: PCT/US2023/072780

§ 371 Date: Feb. 18, 2025

Related U.S. Application Data
(60) Provisional application No. 63/400,480, filed on Aug. 24, 2022.

(51) Int. Cl. B25F 5/00; B25B 23/147; H02K 7/14; H02K 21/16; H02P 21/00; H02P 21/09; H02P 21/18

(52) U.S. Cl. CPC B25F 5/001; H02K 7/145; H02K 21/16; H02P 21/0089; H02P 21/09; H02P 21/18; B25B 23/1475; H02P 2207/05

(57) ABSTRACT

A power tool that includes a housing, a brushless motor, a power switching circuit, an impact mechanism, and an electronic controller. The brushless motor is within the housing and includes a rotor and a stator. The rotor is coupled to a motor shaft to produce a rotational output. The power switching circuit provides a supply of power to the brushless motor. The impact mechanism is configured to be driven by the motor between a first position and a second position. The electronic controller is configured to determine whether the impact mechanism is in the first position, operate in a high power state while the impact mechanism is moved from the first position to the second position, determine whether the impact mechanism is in the second position, and operate in a low power state while the impact mechanism is moved from the second position to the first position.

### RELATED APPLICATIONS

This application is a 35 U.S.C. § 371 U.S. national phase application of PCT Patent Application No. PCT/US2023/072780, filed Aug. 24, 2023, which claims the benefit of U.S. Provisional Patent Application No. 63/400,480, filed Aug. 24, 2022, the entire content of each of which is hereby incorporated by reference.

### FIELD

Embodiments described herein relate to controlling power tools.

### SUMMARY

Power tools described herein include a housing, a motor within the housing, a power switching circuit that provides a supply of power from a battery pack to the motor, and an impact mechanism connected to the motor. The impact mechanism includes a hammer driven by the motor and an anvil configured to receive an impact from the hammer. Power tools described herein also include an output drive device configured to be driven by the impact mechanism, a position sensor configured to generate an output signal indicative of a position of the hammer, and an electronic controller. The electronic controller is configured to determine the position of the hammer based on the output signal received from the position sensor, determine whether the position of the hammer is at a hammer rebound threshold, and adjust, in response to determining that the position of the hammer is not at the hammer rebound threshold, an average power supplied to the motor.

In some aspects, the electronic controller is further configured to determine that the position of the hammer is less than the hammer rebound threshold and increase a conduction angle of the motor to increase the average power supplied to the motor.

In some aspects, the electronic controller is further configured to determine that the position of the hammer is greater than the hammer rebound threshold and decrease the conduction angle of the motor to decrease the average power supplied to the motor.

In some aspects, the electronic controller is further configured to determine that the position of the hammer is less than the hammer rebound threshold and increase a phase advance angle of the motor to increase the average power supplied to the motor.

In some aspects, the electronic controller is further configured to determine that the position of the hammer is greater than the hammer rebound threshold and decrease the phase advance angle of the motor to decrease the average power supplied to the motor.

In some aspects, the electronic controller is further configured to determine that the position of the hammer is less than the hammer rebound threshold and increase a duty cycle of a pulse-width modulated (PWM) signal supplied to the motor to increase the average power supplied to the motor.

In some aspects, the electronic controller is further configured to determine that the position of the hammer is greater than the hammer rebound threshold and decrease the duty cycle of the PWM signal supplied to the motor to decrease the average power supplied to the motor.

In some aspects, the electronic controller is further configured to determine that the position of the hammer is less than the hammer rebound threshold and increase a torque current signal associated with the motor to increase the average power supplied to the motor.

In some aspects, the electronic controller is further configured to determine that the position of the hammer is greater than the hammer rebound threshold and decrease the torque current signal associated with the motor to decrease the average power supplied to the motor.

In some aspects, the electronic controller is further configured to determine that the position of the hammer is less than the hammer rebound threshold and increase a flux current signal associated with the motor to increase the average power supplied to the motor.

In some aspects, the electronic controller is further configured to determine that the position of the hammer is greater than the hammer rebound threshold and decrease the flux current signal associated with the motor to decrease the average power supplied to the motor.

Methods described herein provide for adjusting average power supplied to a motor of a power tool. The power tool includes an impact mechanism having a hammer driven by the motor and an anvil configured to receive an impact from the hammer. The methods include determining, via an electronic controller, a position of the hammer based on an output signal received from a position sensor. The methods also include determining, via the electronic controller, whether the position of the hammer is at a hammer rebound threshold. The methods also include adjusting, via the electronic controller and in response to determining that the position of the hammer is not at the hammer rebound threshold, an average power supplied to the motor.

In some aspects, the methods described herein further include determining, via the electronic controller, that the position of the hammer is less than the hammer rebound threshold and increasing, via the electronic controller, a conduction angle of the motor to increase the average power supplied to the motor.

In some aspects, the methods described herein further include determining, via the electronic controller, that the position of the hammer is greater than the hammer rebound threshold and decreasing, via the electronic controller, the conduction angle of the motor to decrease the average power supplied to the motor.

In some aspects, the methods described herein further include determining, via the electronic controller, that the position of the hammer is less than the hammer rebound threshold and increasing, via the electronic controller, a phase advance angle of the motor to increase the average power supplied to the motor.

In some aspects, the methods described herein further include determining, via the electronic controller, that the position of the hammer is greater than the hammer rebound threshold and decreasing, via the electronic controller, the phase advance angle of the motor to decrease the average power supplied to the motor.

In some aspects, the methods described herein further include determining, via the electronic controller, that the position of the hammer is less than the hammer rebound threshold and increasing, via the electronic controller, a duty cycle of a pulse-width modulated (PWM) signal supplied to the motor to increase the average power supplied to the motor.

In some aspects, the methods described herein further include determining, via the electronic controller, that the position of the hammer is greater than the hammer rebound threshold and decreasing, via the electronic controller, the duty cycle of the PWM signal supplied to the motor to decrease the average power supplied to the motor.

In some aspects, the methods described herein further include determining, via the electronic controller, that the position of the hammer is less than the hammer rebound threshold and increasing, via the electronic controller, a torque current signal associated with the motor to increase the average power supplied to the motor.

In some aspects, the methods described herein further include determining, via the electronic controller, that the position of the hammer is greater than the hammer rebound threshold and decreasing, via the electronic controller, the torque current signal associated with the motor to decrease the average power supplied to the motor.

In some aspects, the methods described herein further include determining, via the electronic controller, that the position of the hammer is less than the hammer rebound threshold and increasing, via the electronic controller, a flux current signal associated with the motor to increase the average power supplied to the motor.

In some aspects, the methods described herein further include determining, via the electronic controller, that the position of the hammer is greater than the hammer rebound threshold and decreasing, via the electronic controller, the flux current signal associated with the motor to decrease the average power supplied to the motor.

Power tools described herein include a housing, a brushless direct current (DC) motor, a power switching circuit, an impact mechanism, an output drive device, and an electronic controller. The brushless DC motor is located within the housing and includes a rotor and a stator. The rotor is coupled to a motor shaft to produce a rotational output. The power switching circuit provides a supply of power from a battery pack to the brushless DC motor. The impact mechanism is connected to the motor shaft. The impact mechanism includes a first position and a second position. The output drive device is configured to be driven by the impact mechanism as the impact mechanism moves between the first position and the second position. The electronic controller is configured to determine whether the impact mechanism is in the first position and operate, in response to determining that the impact mechanism is in the first position, in a high power state while the impact mechanism is moved from the first position to the second position. The electronic controller is further configured to determine whether the impact mechanism is in the second position and operate, in response to determining that the impact mechanism is in the second position, in a low power state while the impact mechanism is moved from the second position to the first position.

In some aspects, power tools described herein further include a sensor configured to generate a sensor signal. The electronic controller is further configured to receive the sensor signal from the sensor.

In some aspects, the sensor signal indicates whether the impact mechanism is in the first position.

In some aspects, the sensor is a non-contact sensor.

In some aspects, the high power state is configured to apply a greater amount of field weakening than the low power state.

In some aspects, the electronic controller is further configured to apply a phase advance angle to control the brushless DC motor during the high power state.

In some aspects, the electronic controller is further configured to apply a field-oriented control (“FOC”) algorithm to control the brushless DC motor.

In some aspects, the electronic controller is further configured to apply a synchronous rectification mode when controlling the brushless DC motor.

In some aspects, the electronic controller is further configured to control a conduction angle of the brushless DC motor.

In some aspects, the electronic controller includes a machine learning controller.

Methods described herein provide for controlling a power tool. The methods include driving a brushless direct current (DC) motor. The brushless DC motor includes a rotor and a stator. The rotor is connected to a motor shaft to produce a rotational output. The methods also include supplying, via a power switching circuit, power from a battery pack to the brushless DC motor and driving an output drive device using an impact mechanism. The impact mechanism includes a first position and a second position. The methods also include determining, using an electronic controller, whether the impact mechanism is in the first position, operating, in response to determining that the impact mechanism is in the first position, in a high power state while the impact mechanism is moved from the first position to the second position, determining whether the impact mechanism is in the second position, and operating, in response to determining that the impact mechanism is in the second position, in a low power state while the impact mechanism is moved from the second position to the first position.

In some aspects, the methods described herein further include generating, via a sensor, a sensor signal, and receiving, via the electronic controller, the sensor signal from the sensor.

In some aspects, the sensor signal indicates whether the impact mechanism is in the first position.

In some aspects, the sensor is a non-contact sensor.

In some aspects, operating in the high power state applies a greater amount of field weakening than operating in the low power state.

In some aspects, the methods described herein further include applying, via the electronic controller, a phase advance angle to control the brushless DC motor during the high power state.

In some aspects, the methods described herein further include applying, via the electronic controller, a field-oriented control (“FOC”) algorithm to control the brushless motor.

In some aspects, the methods described herein further include applying, via the electronic controller, a synchronous rectification mode when controlling the brushless DC motor.

In some aspects, the methods described herein further include controlling, via the electronic controller, a conduction angle of the brushless DC motor.

In some aspects, the electronic controller includes a machine learning controller.

Power tools described herein include a housing, a motor within the housing, a power switching circuit that provides a supply of power from a battery pack to the motor, an impact mechanism connected to the motor, an output drive device, and an electronic controller. The impact mechanism includes a first position and a second position. The output drive device is configured to be driven by the impact mechanism as the impact mechanism moves between the first position and the second position. The electronic controller is configured to determine whether the impact mechanism is in the first position, operate in a high power state while the impact mechanism is moved from the first position to the second position, determine whether the impact mechanism is in the second position, and operate in a low power state while the impact mechanism is moved from the second position to the first position.

In some aspects, the power tool further includes a sensor configured to generate a sensor signal, wherein the electronic controller is further configured to receive the sensor signal from the sensor.

In some aspects, the sensor signal indicates whether the impact mechanism is in the first position.

In some aspects, the sensor is a non-contact sensor.

In some aspects, the high power state is configured to apply a greater amount of field weakening than the low power state.

In some aspects, the electronic controller is further configured to apply a phase advance angle to control the brushless DC motor during the high power state.

In some aspects, the electronic controller is further configured to apply a field-oriented control (“FOC”) algorithm to control the brushless DC motor.

In some aspects, the electronic controller is further configured to apply a synchronous rectification mode when controlling the brushless DC motor.

In some aspects, the electronic controller is further configured to control a conduction angle of the brushless DC motor.

In some aspects, the electronic controller is further configured to determine whether a hammer of the impact mechanism rebounds to a hammer rebound threshold.

In some aspects, the electronic controller is further configured to increase the conduction angle if the hammer of the impact mechanism does not rebound to the hammer rebound threshold.

In some aspects, the electronic controller is further configured to decrease the conduction angle if the hammer of the impact mechanism rebound exceeds the hammer rebound threshold.

In some aspects, the electronic controller includes a machine learning controller.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a power tool, in accordance with embodiments described herein.

FIG. 2 is a block diagram of the power tool of FIG. 1, in accordance with embodiments described herein.

FIG. 3 illustrates a block diagram of a wireless communication controller, in accordance with embodiments described herein.

FIG. 4 illustrates a communication system for the power tool of FIG. 1, in accordance with embodiments described herein.

FIG. 5 illustrates a block diagram of a machine learning controller, in accordance with embodiments described herein.

FIGS. 6A and 6B illustrate an impact mechanism of the power tool of FIG. 1, in accordance with embodiments described herein.

FIGS. 7A, 7B, 8A, 8B, 9A, 9B, 10A, and 10B illustrate an exemplary operation of a hammer and an anvil of the power tool of FIG. 1, in accordance with embodiments described herein.

FIG. 11 illustrates an exemplary translating hammer of the impact mechanism of FIGS. 6A and 6B advancing towards a first position, in accordance with embodiments described herein.

FIG. 12 illustrates an exemplary translating hammer of the impact mechanism of FIGS. 6A and 6B retreating from a first position, in accordance with the embodiments described herein.

FIG. 13 is a graph illustrating a change in conduction angle of a brushless DC motor between a high power state and a low power state for use in the power tool of FIG. 1, in accordance with embodiments described herein.

FIGS. 14A-C are graphs illustrating a relationship between revolutions per minute (“RPM”) and torque for determining impact timing, in accordance with embodiments described herein.

FIG. 15 is a graph illustrating a relationship between torque and revolutions per minute (“RPM”), in accordance with embodiments described herein.

FIG. 16 is a flow chart of a method for implementing a high power state and a low power state, in accordance with some embodiments.

FIG. 17 illustrates a block diagram of a power tool including sensored motor control, such as in the power tool of FIG. 1.

FIGS. 18A and 18B illustrate a sensor board of a brushless direct current motor incorporated in the power tool of FIG. 1.

FIG. 19 is a block diagram for the control system of a sensorless field-oriented control (“FOC”) algorithm for use in the power tool of FIG. 1, in accordance with embodiments described herein.

FIG. 20 is a graph illustrating a relationship between stator flux current and stator torque current, in accordance with embodiments described herein.

FIG. 21 is a graph illustrating a negative stator flux current for use in sensorless FOC determined by a max-torque-per-amps (“MTPA”) algorithm, in accordance with embodiments described herein.

FIG. 22 is a block diagram of a control system for implementing an MTPA algorithm, in accordance with embodiments described herein.

FIG. 23 is a flow chart of a method for implementing an MTPA algorithm, in accordance with embodiments described herein.

FIG. 24 is a graph illustrating a relationship between stator flux current and stator torque current, in accordance with embodiments described herein.

FIG. 25 is a graph illustrating the results of a sensorless field weakening operation, in accordance with embodiments described herein.

FIG. 26A is a block diagram of a control system for implementing a max-torque-per-volt (“MTPV”) algorithm, in accordance with embodiments described herein.

FIG. 26B is a block diagram of a control system for implementing an MTPV algorithm, in accordance with embodiments described herein.

FIG. 27 is a flow chart of a method for implementing an MTPV algorithm, in accordance with embodiments described herein.

FIG. 28 is a flow chart of a method for implementing sensorless field weakening in the power tool of FIG. 1, in accordance with embodiments described herein.

FIG. 29 is a graph showing commutation of a brushless motor, in accordance with embodiments described herein.

FIGS. 30A, 30B, and 30C are schematic views of a power switching network for driving the motor of the power tool of FIG. 1 during freewheeling and synchronous rectification modes, in accordance with embodiments described herein.

FIG. 31 is a diagram illustrating the phase motor current during on and off intervals under freewheeling and synchronous rectification modes, in accordance with embodiments described herein.

FIG. 32 is a flowchart of an example method for controlling the rectification mode of the motor of the power tool of FIG. 1, in accordance with embodiments described herein.

FIGS. 33A and 33B are timing diagrams illustrating rectification mode changes using the method of FIG. 32, in accordance with embodiments described herein.

FIG. 34 is a diagram illustrating a rectification mode curve for implementing freewheeling and synchronous rectification modes, in accordance with embodiments described herein.

FIGS. 35A and 35B are graphs illustrating changes in conduction angle of a motor by controlling a high power state and a low power state, in accordance with embodiments described herein.

FIGS. 36A and 36B are graphs illustrating changes in conduction angle of a motor by controlling a high power state and a low power state, in accordance with embodiments described herein.

FIGS. 37A and 37B are graphs illustrating changes in conduction angle of a motor by controlling a high power state and a low power state, in accordance with embodiments described herein.

FIGS. 38A and 38B are graphs illustrating changes in conduction angle of a motor by controlling a high power state and a low power state, in accordance with embodiments described herein.

FIGS. 39A and 39B are graphs illustrating changes in conduction angle of a motor by controlling a high power state and a low power state, in accordance with embodiments described herein.

FIGS. 40A and 40B are graphs illustrating changes in conduction angle of a motor by controlling a high power state and a low power state, in accordance with embodiments described herein.

FIG. 41 is a flow chart of a method for adjusting average power supplied to a motor of a power tool, in accordance with embodiments described herein.

FIGS. 42A and 42B are graphs illustrating changes in conduction angle of a motor, in accordance with embodiments described herein.

FIGS. 43A and 43B are graphs illustrating changes in conduction angle of a motor, in accordance with embodiments described herein.

### DETAILED DESCRIPTION

Embodiments described herein relate to a power tool that is configured to operate in a high power state (e.g., a first field weakening motor control mode) to increase the speed and energy of an operation of the power tool (e.g., an impact operation). The power tool is further configured to operate in a low power state (e.g., a second field weakening motor control mode) to reduce power consumption after the completion of the operation of the power tool. The low power state cools the motor by reducing heating effects experienced by the motor during an operation of the power tool prior to a subsequent operation of the power tool. The high power state and the low power state can be accomplished using sensored motor control, sensorless motor control, conduction angle motor control, and/or synchronous rectification motor control. The high power state is applied to the operation of the power tool during the movement of an impact mechanism from a first position (e.g., prior to an impact event) to a second position (e.g., an impact). The high power state increases the speed of the impact mechanism moving from the first position to the second position, thereby increasing impact energy prior to the impact event. The high power state increases torque applied by the motor during the high power state prior to the impact event. The low power state is applied to the operation of the power tool during the movement of an impact mechanism from the second position (e.g., an impact) to the first position (e.g., resetting the impact mechanism for a subsequent operation). The low power state reduces the speed of the impact mechanism moving from the second position to the first position, thereby decreasing the power drawn by the power tool and cooling the motor while resetting the impact mechanism for a subsequent operation. The combination of the high power state and the low power state allows the motor to create more torque from a similar size or smaller size motor than other conventional power tools.

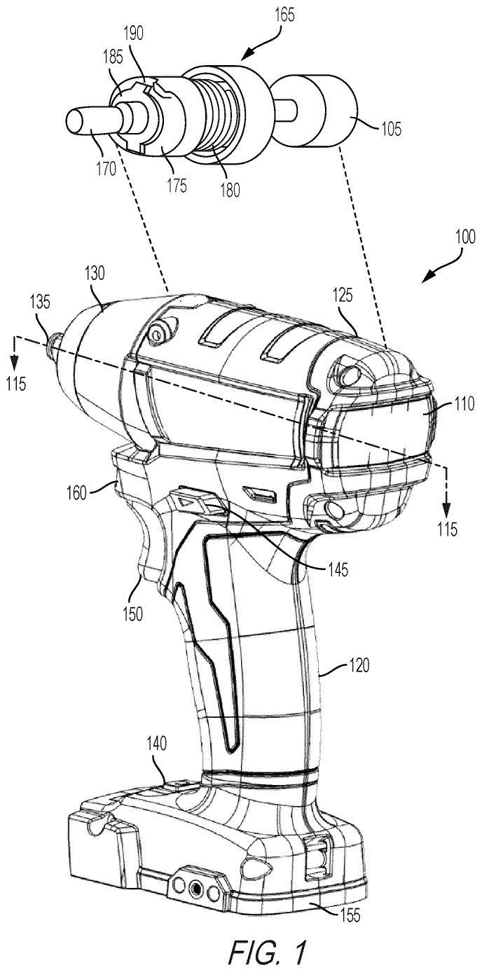

FIG. 1 illustrates a power tool 100 including a brushless direct current (“BLDC”) motor 105. In a brushless motor power tool, such as power tool 100, switching elements are selectively enabled and disabled by control signals from a controller to selectively apply power from a power source (e.g., battery pack) to drive (e.g., control) a brushless motor. In some embodiments, the power tool 100 is a brushless impact driver having a housing 110 with a central axis 115, a handle portion 120, and a motor housing portion 125. The motor housing portion 125 is mechanically coupled to an impact case 130 that houses an output unit 135. The impact case 130 forms a nose of the power tool 100, and can be made from a different material than the housing 110. For example, the impact case 130 may be metal, while the housing 110 may be plastic. The power tool 100 further includes a mode select button 140, forward/reverse selector 145, trigger 150, battery interface 155, and light 160. Although the power tool 100 illustrated in FIG. 1 is an impact driver, the power tool 100 can also be a different type of tool, such as, for example, a hammer drill, an impact hole saw, an impact wrench, an impact ratchet, a nailer, and the like.

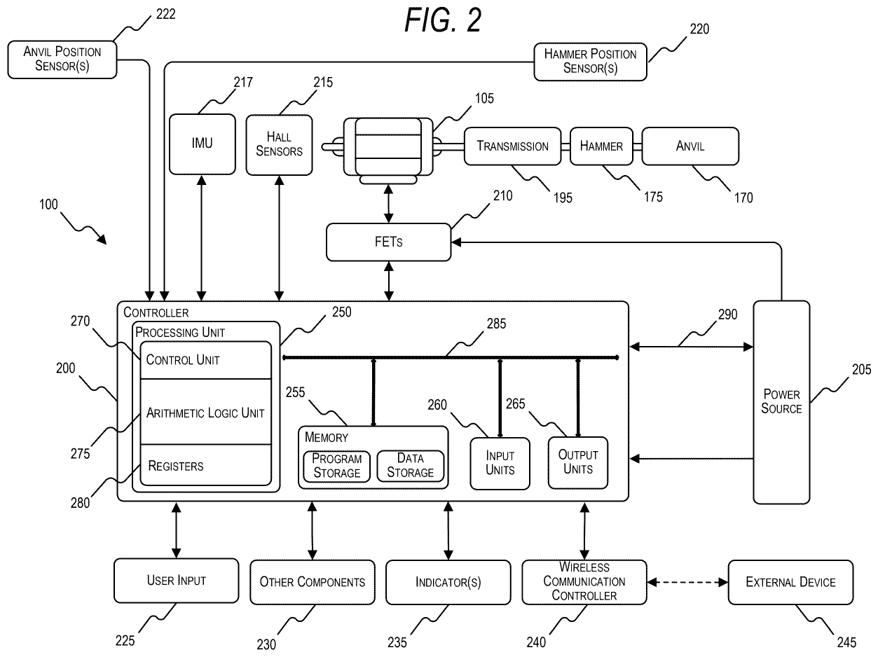

The power tool 100 also includes an impact mechanism 165 including an anvil 170, and a hammer 175. The impact mechanism 165 is positioned within the impact case 130 and is mechanically coupled to the motor 105 via a transmission 195 (see FIG. 2). The transmission 195 may include, for example, gears or other mechanisms to transfer the rotational power from the motor 105 to the impact mechanism 165, and in particular, to the hammer 175. The hammer 175 is axially biased to engage the anvil 170 via a spring 180. The hammer 175 impacts the anvil 170 periodically to increase the amount of torque delivered by the power tool 100 (e.g., the anvil 170 drives the output unit 135). The anvil 170 includes an engagement structure 185 that is rotationally fixed with portions of the anvil 170. The engagement structure 185 includes a plurality of protrusions 190 (e.g., two protrusions in the illustrated embodiment) to engage the hammer 175 and receive the impact from the hammer 175. During an impacting event or cycle, as the motor 105 continues to rotate, the power tool 100 encounters a higher resistance and winds up the spring 180 coupled to the hammer 175. As the spring 180 compresses, the spring 180 retracts toward the motor 105, pulling along the hammer 175 until the hammer 175 disengages from the anvil 170 and surges forward to strike and re-engage the anvil 170. An impact refers to the event in which the spring 180 releases and the hammer 175 strikes the anvil 170. The impacts increase the amount of torque delivered by the anvil 170.

FIG. 2 illustrates an electromechanical diagram of the brushless power tool 100, which includes a controller 200. The controller 200 is electrically and/or communicatively connected to a variety of modules or components of the power tool 100. For example, the illustrated controller 200 is connected to a power source 205, Field Effect Transistors (“FETs”) 210, the motor 105, Hall Effect sensors 215 (also referred to as Hall sensors), an inertial measurement unit (“IMU”) 217, one or more hammer position sensors 220, one or more anvil position sensors 222, a user input 225, other components 230 (e.g., a battery pack fuel gauge, work lights [e.g., LEDs], current/voltage sensors, etc.), one or more indicators 235 (e.g., LEDs), and a wireless communication controller 240 (e.g., a transceiver) configured to communicate with an external device 245 (e.g., a smartphone, a tablet computer, a laptop computer, and the like). The wireless communication controller 240 and its communication with the external device 245 is described in greater detail in, for example, U.S. Patent Application Publication No. 2017/0246732, published on Aug. 31, 2017 and entitled “POWER TOOL INCLUDING AN OUTPUT POSITION SENSOR,” the entire content of which is hereby incorporated by reference.

The controller 200 includes combinations of hardware and software that are operable to, among other things, control the operation of the power tool 100, detect linear and/or rotational positions associated with the impact mechanism 165, control power provided to the motor 105, etc. In some embodiments, the controller 200 includes a plurality of electrical and electronic components that provide power, operational control, and protection to the components and modules within the controller 200 and/or power tool 100. For example, the controller 200 includes, among other things, a processing unit 250 (e.g., a microprocessor, a microcontroller, or another suitable programmable device), a memory 255, input units 260, and output units 265. The processing unit 250 includes, among other things, a control unit 270, an arithmetic logic unit (“ALU”) 275, and a plurality of registers 280 (shown as a group of registers in FIG. 2), and is implemented using a known computer architecture (e.g., a modified Harvard architecture, a von Neumann architecture, etc.). The processing unit 250, the memory 255, the input units 260, and the output units 265, as well as the various modules connected to the controller 200 are connected by one or more control and/or data buses (e.g., common bus 285). The control and/or data buses are shown generally in FIG. 2 for illustrative purposes. The use of one or more control and/or data buses for the interconnection between and communication among the various modules and components would be known to a person skilled in the art in view of the embodiments described herein.

The memory 255 is a non-transitory computer readable medium that includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 250 is connected to the memory 255 and executes software instructions that are capable of being stored in a RAM of the memory 255 (e.g., during execution), a ROM of the memory 255 (e.g., on a generally permanent basis), or another non-transitory computer readable medium such as another memory or a disc. Software included in the implementation of the power tool 100 can be stored in the memory 255 of the controller 200. The software includes, for example, firmware, one or more applications, program data, filters, rules, one or more program modules, and other executable instructions. The controller 200 is configured to retrieve from memory and execute, among other things, instructions related to the control of the power tool 100 described herein. In other constructions, the controller 200 includes additional, fewer, or different components.

The power source 205 provides DC power to the various components of the power tool 100. In some embodiments, the power source 205 is a power tool battery pack that is rechargeable and uses, for example, lithium ion battery cell technology. In other embodiments, the power source 205 may receive AC power (e.g., 120V/60 Hz) from a tool plug that is coupled to a standard wall outlet, and then filter, condition, and rectify the received power to output DC power. In some embodiments, the power tool 100 includes, for example, a communication line 290 for providing a communication line or link between the controller 200 and the power source 205.

Each of the Hall sensors 215 outputs motor feedback information, such as an indication (e.g., a pulse) related to when a magnet of the motor 105's rotor rotates across the face of that Hall sensor 215. Based on the motor feedback information from the Hall sensors 215, the controller 200 is able to directly determine the rotational position, speed, and acceleration of the rotor. In addition to the direct measurement of the rotor position, the Hall sensors 215 can provide indirect information regarding the position of the anvil 170. The inertial measurement unit (“IMU”) 217 (e.g., accelerometers, gyroscopes, magnetometers, etc.) outputs information regarding the linear motion of the anvil 170, the hammer 175, and/or the power tool 100. The one or more hammer position sensors 220 output information regarding the position of, for example, the hammer 175, the spring 180, etc. The one or more anvil position sensors 222 output information regarding the position of the anvil 170. In some embodiments, the one or more hammer position sensors 220 and the one or more anvil position sensors 222 are non-contact sensors. For example, the one or more hammer position sensors 220 and the one or more anvil position sensors 222 are inductive sensors that sense a change in a magnetic field produced by the inductive sensors. The change in the magnetic field is caused by a relative proximity of the inductive sensor to a conductive material (e.g., the hammer 175 and the anvil 170, respectively). Based on the sensed change in the magnetic field, the one or more hammer position sensors 220 and the one or more anvil position sensors 222 output the information regarding the position of the anvil 170, the hammer 175, the spring 180, etc. Although described herein as inductive sensors, the one or more hammer position sensors 220 and the one or more anvil position sensors 222 may be another non-contact sensor.

The power tool 100 is configured to operate in various modes. For example, the controller 200 receives user controls from user input 225, such as by selecting an operating mode with the mode select button 140, shifting the forward/reverse selector 145, or depressing the trigger 150. In response to the motor feedback information and user controls, the controller 200 generates control signals to control the FETs 210 to drive the motor 105. By selectively enabling and disabling the FETs 210, power from the power source 205 is selectively applied to stator coils of the motor 105 to cause rotation of the motor 105's rotor. Although not shown explicitly, the one or more hammer position sensors 220, the one or more anvil position sensors 222, and other components of the power tool 100 are electrically coupled to the power source 205 such that the power source 205 provides power to those components.

In some embodiments, controller 200 also controls other aspects of the power tool 100 such as, for example, operation of the work light 160 and/or the fuel gauge, recording usage data, communication with an external device, and the like. In some embodiments, the power tool 100 is configured to control the operation of the motor based on the detected position of the hammer portion of the power tool 100. For example, in some embodiments, the controller 200 is configured to monitor a change in position, speed, and/or acceleration associated with the hammer 175 based on the position of the hammer 175 within the impact mechanism 165 via the information output by the one or more hammer position sensors 220. The controller 200 can then control the motor 105 based on the detected position of the hammer 175. In some embodiments, the controller 200 determines an average power over a duration of the impact event supplied to the hammer 175 via the motor 105 based on the position of the hammer 175. For example, the controller 200 can determine the average power supplied to the hammer 175 based on the position of the hammer 175 after rebounding from engaging the anvil 170 (e.g., a rebound position). As such, the controller 200 can then control the motor 105 to adjust the average power supplied to the motor 105 (and subsequently the hammer 175) based on the position of the hammer 175. In other embodiments, the power tool 100 is configured to control the operation of the motor 105 based on the detected position of the anvil portion of the power tool 100. For example, in some embodiments, the controller 200 is configured to monitor a change in position, speed, and/or acceleration associated with the anvil 170 based on the position of the anvil 170 within the impact mechanism 165 via the information output by the one or more anvil position sensors 222. The controller 200 can then control the motor 105 based on the detected position of the anvil 170. By monitoring the impact mechanism 165 directly, the controller 200 can effectively control, for example, the number of impacts, the impact energy, and the time between impacts over the entire range of the tool's battery charge and motor speeds (i.e., regardless of the battery charge or the motor speed).

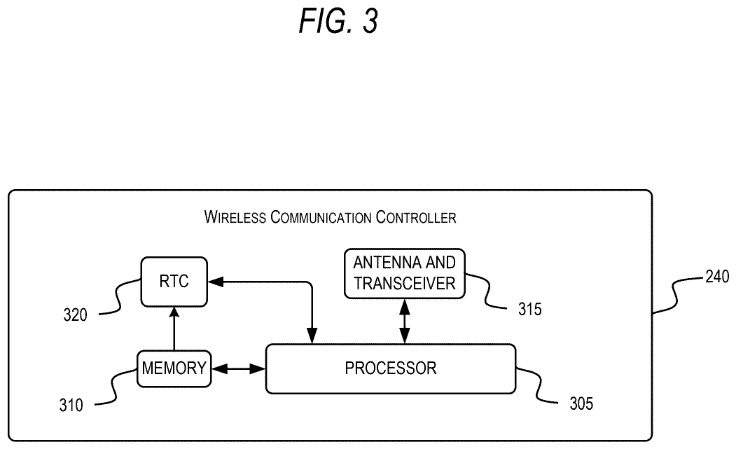

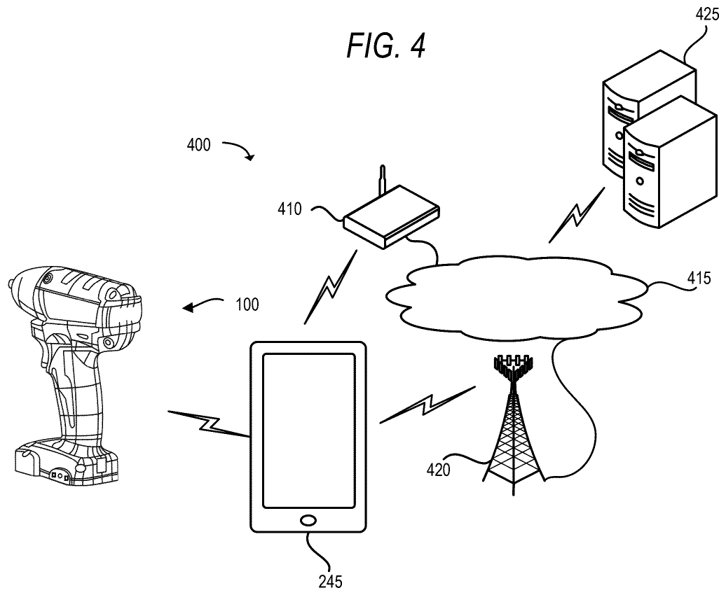

In some embodiments, any of the proposed power tool devices may include a wireless communication controller 240 coupled to their respective controllers for communicating over a wireless network. FIG. 3 illustrates an example wireless communication controller 240. As shown in FIG. 3, the wireless communication controller 300 includes a processor 305, a memory 310, an antenna and transceiver 315, and a real-time clock (RTC) 320. The wireless communication controller 240 enables a power tool device to communicate with an external device 245 (see, e.g., FIGS. 2 and 4). The radio antenna and transceiver 315 operate together and send and receive wireless messages to and from the external device 245 and the processor 305. The memory 310 can store instructions to be implemented by the processor 305 and/or may store data related to communications between the power tool device and the external device 245. For example, the processor 305 associated with the wireless communication controller 240 buffers incoming and/or outgoing data, communicates with the power tool device controller 200, and determines the communication protocol and/or settings to use in wireless communications. The communication via the wireless communication controller 240 can be encrypted to protect the data exchanged between the power tool device and the external device 245 from third parties.

In the illustrated embodiment, the wireless communication controller 240 is a Bluetooth® controller. The Bluetooth® controller communicates with the external device 245 employing the Bluetooth® protocol. Therefore, in the illustrated embodiment, the external device 245 and the power tool device are within a communication range (i.e., in proximity) of each other while they exchange data. In other embodiments, the wireless communication controller 240 communicates using other protocols (e.g., Wi-Fi, ZigBee, a proprietary protocol, etc.) over different types of wireless networks. For example, the wireless communication controller 240 may be configured to communicate via Wi-Fi through a wide area network such as the Internet or a local area network, or to communicate through a piconet (e.g., using infrared or NFC communications).

In some embodiments, the network is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a 4G LTE network, 5G New Radio, a Digital Enhanced Cordless Telecommunications (“DECT”) network, a Digital AMPS (“IS-136/TDMA”) network, or an Integrated Digital Enhanced Network (“iDEN”) network, etc.

The wireless communication controller 240 is configured to receive data from the power tool device controller 200 and relay the information to the external device 245 via the antenna and transceiver 315. In a similar manner, the wireless communication controller 240 is configured to receive information (e.g., configuration and programming information) from the external device 245 via the antenna and transceiver 315 and relay the information to the power tool device controller 200.

FIG. 4 illustrates a communication system 400. The communication system 400 includes at least one power tool device 100 (illustrated as power tool 100) and the external device 245. Each power tool device 100 and the external device 245 can communicate wirelessly while they are within a communication range of each other. Each power tool device 100 may communicate power tool device status, power tool device operation statistics, power tool device identification, power tool device sensor data, stored power tool device usage information, power tool device maintenance information, and the like.

The external device 245 is, for example, a smart phone (as illustrated), a laptop computer, a tablet computer, a personal digital assistant (PDA), or another electronic device capable of communicating wirelessly with the power tool device 100 and providing a user interface. The external device 245 provides the user interface and allows a user to access and interact with the power tool device 100. The external device 245 can receive user inputs to determine operational parameters, enable or disable features (such as a low-power operating mode), and the like. The user interface of the external device 245 provides an easy-to-use interface for the user to control and customize operation of the power tool device 100. The external device 245, therefore, grants the user access to tool operational data of the power tool device 100, and provides a user interface such that the user can interact with the controller of the power tool device 100.

In addition, as shown in FIG. 4, the external device 245 can also share the tool operational data obtained from the power tool device 100 with a remote server 425 connected through a network 415. The remote server 425 may be used to store the tool operational data obtained from the external device 245, provide additional functionality and services to the user, or a combination thereof. In some embodiments, storing the information on the remote server 425 allows a user to access the information from a plurality of different locations. In some embodiments, the remote server 425 collects information from various users regarding their power tool devices and provide statistics or statistical measures to the user based on information obtained from the different power tools. For example, the remote server 425 may provide statistics regarding the experienced efficiency of the power tool device 100, typical usage of the power tool device 100, and other relevant characteristics and/or measures of the power tool device 100. The network 415 may include various networking elements (routers 410, hubs, switches, cellular towers 420, wired connections, wireless connections, etc.) for connecting to, for example, the Internet, a cellular data network, a local network, or a combination thereof as previously described. In some embodiments, the power tool device 100 is configured to communicate directly with the server 425 through an additional wireless interface or with the same wireless interface that the power tool device 100 uses to communicate with the external device 245.

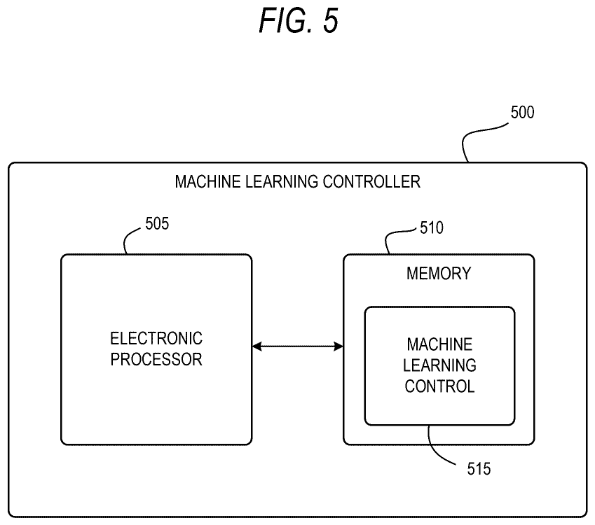

In some embodiments, the controller 200 includes a machine learning controller. As shown in FIG. 5, the machine learning controller 500 includes a machine learning electronic processor 505 and a machine learning memory 510. The machine learning memory 510 stores a machine learning control 515. The machine learning control 515 may include a trained machine learning program as described below. In some embodiments, the trained machine learning program is instead stored in the memory 255 of the power tool 100 and implemented by the processing unit 250. The machine learning control 515 may be built and operated by the power tool 100 or a remote device (e.g., the remote server 425). In other embodiments, the machine learning control 515 is built on and/or implemented by an intermediate external device, such as external device 245 which is, for example, a phone, tablet, gateway, hub, or other power tool separate from the power tool 100.

The machine learning controller 500 implements a machine learning program. For example, the machine learning controller 500 is configured to construct a model (e.g., building one or more algorithms) based on example inputs. Supervised learning involves presenting a computer program with example inputs and their actual outputs (e.g., categorizations). The machine learning controller 500 is configured to learn a general rule or model that maps the inputs to the outputs based on the provided example input-output pairs. The machine learning algorithm may be configured to perform machine learning using various types of methods. For example, the machine learning controller 500 may implement the machine learning program using decision tree learning (such as random decision forests), associates rule learning, artificial neural networks, recurrent artificial neural networks, long short term memory neural networks, inductive logic programming, support vector machines, clustering, Bayesian networks, reinforcement learning, representation learning, similarity and metric learning, sparse dictionary learning, genetic algorithms, k-nearest neighbor (KNN), among others, such as those listed in Table 1 below. In some embodiments the machine learning program is implemented by the controller 200, the external device 245, or a combination of the controller 200, the external device 245, and/or the machine learning controller 500.

TABLE 1

| | |
|---|---|
| Recurrent | Recurrent Neural Networks [“RNNs”], Long Short-Term Memory |
| Models | [“LSTM”] models, Gated Recurrent Unit [“GRU”] models, Markov |
| | Processes, Reinforcement learning |
| Non-Recurrent | Deep Neural Network [“DNN”], Convolutional Neural Network [“CNN”], |
| Models | Support Vector Machines [“SVM”], Anomaly detection (ex: Principle |
| | Component Analysis [“PCA”]), logistic regression, decision trees/forests, |
| | ensemble methods (combining models), polynomial/Bayesian/other |
| | regressions, Stochastic Gradient Descent [“SGD”], Linear Discriminant |
| | Analysis [“LDA”], Quadratic Discriminant Analysis [“QDA”], Nearest |
| | neighbors classifications/regression, naïve Bayes, attention networks, |
| | transformer networks, etc. |

The machine learning controller 500 is programmed and trained to perform a particular task. For example, in some embodiments, the machine learning controller 500 is trained to identify an application (or operation) performed by the power tool 100 (e.g., control field weakening based on a position of an impact mechanism). The training examples used to train the machine learning controller 500 may be graphs or tables of operating profiles, such as hammer speed over time, hammer position over time, current over time, and the like for a given application. The training examples may be previously collected training examples, from, for example, a plurality of the same type of power tools. For example, the training examples may have been previously collected from a plurality of power tools of the same type (e.g., the same impact mechanism) over a span of, for example, one year.

A plurality of different training examples is provided to the machine learning controller 500. The machine learning controller 500 uses these training examples to generate a model (e.g., a rule, a set of equations, and the like) that helps categorize or estimate the output based on new input data. The machine learning controller 500 may weight different training examples differently to, for example, prioritize different conditions or inputs and outputs to and from the machine learning controller 500. For example, certain observed operating characteristics may be weighed more heavily than others, such as hammer speed and hammer position.

In one example, the machine learning controller 500 implements an artificial neural network. The artificial neural network includes an input layer, a plurality of hidden layers or nodes, and an output layer. Typically, the input layer includes as many nodes as inputs provided to the machine learning controller 500. As described above, the number (and the type) of inputs provided to the machine learning controller 500 may vary based on the particular task for the machine learning controller 500. Accordingly, the input layer of the artificial neural network of the machine learning controller 500 may have a different number of nodes based on the particular task for the machine learning controller 500. The input layer connects to the hidden layers. The number of hidden layers varies and may depend on the particular task for the machine learning controller 500. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. However, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is associated with an activation function. The activation function defines how the hidden layer is to process the input received from the input layer or from a previous input layer. These activation functions may vary and be based on not only the type of task associated with the machine learning controller 500, but may also vary based on the specific type of hidden layer implemented.

Each hidden layer may perform a different function. For example, some hidden layers can be convolutional hidden layers which can, in some instances, reduce the dimensionality of the inputs, while other hidden layers can perform statistical functions such as max pooling, which may reduce a group of inputs to the maximum value, an averaging layer, among others. In some of the hidden layers (also referred to as “dense layers”), each node is connected to each node of the next hidden layer. Some neural networks including more than, for example, three hidden layers may be considered deep neural networks. The last hidden layer is connected to the output layer. Similar to the input layer, the output layer typically has the same number of nodes as the possible outputs.

During training, the artificial neural network receives the inputs for a training example and generates an output using the bias for each node, and the connections between each node and the corresponding weights. The artificial neural network then compares the generated output with the actual output of the training example. Based on the generated output and the actual output of the training example, the neural network changes the weights associated with each node connection. In some embodiments, the neural network also changes the weights associated with each node during training. The training continues until a training condition is met. The training condition may correspond to, for example, a predetermined number of training examples being used, a minimum accuracy threshold being reached during training and validation, a predetermined number of validation iterations being completed, and the like. Different types of training algorithms can be used to adjust the bias values and the weights of the node connection based on the training examples. The training algorithms may include, for example, gradient descent, newton's method, conjugate gradient, quasi newton, and levenberg marquardt, among others.

In another example, the machine learning controller 500 implements a support vector machine to perform classification. The machine learning controller 500 may receive inputs from the sensors 215, 217, 220, 222, etc. The machine learning controller 500 then defines a margin using combinations of some of the input variables as support vectors to maximize the margin. In some embodiments, the machine learning controller 500 defines a margin using combinations of more than one of similar input variables. The margin corresponds to the distance between the two closest vectors that are classified differently. In other embodiments, a single support vector machine can use more than two input variables and define a hyperplane that separates the types of applications.

The training examples for a support vector machine include an input vector including values for the input variables (e.g., hammer speed, motor voltage, motor current, motor speed, hammer position, anvil position, and the like), and an output classification indicating the application performed by the power tool 100 (e.g., the state of an impact event). During training, the support vector machine selects the support vectors (e.g., a subset of the input vectors) that maximize the margin. In some embodiments, the support vector machine may be able to define a line or hyperplane that accurately separates the types of applications. In other embodiments (e.g., in a non-separable case), however, the support vector machine may define a line or hyperplane that maximizes the margin and minimizes the slack variables, which measure the error in a classification of a support vector machine. After the support vector machine has been trained, new input data can be compared to the line or hyperplane to determine how to classify the new input data. In other embodiments, as mentioned above, the machine learning controller 500 can implement different machine learning algorithms to make an estimation or classification based on a set of input data. For example, a random forest classifier may be used, in which multiple decision trees are implemented to observe different operational features of the power tool 100. Each decision tree has its own output, and majority voting may be used to determine the final output of the machine learning controller 500.

To train the machine learning control 515, the machine learning controller 500 may be provided with a plurality of application profiles. The plurality of application profiles related to various combinations of input parameters, such as hammer speed, hammer position, anvil rotation, anvil position, etc. The application profiles can also correspond to tables of values or other sets of numerical values that represent the application profiles. Each application profile provides, for example, a rotational speed of the hammer 175, a hammer position, anvil rotation, anvil position, etc. Additionally, each application profile may be labelled such that the machine learning controller 500 can learn the expected profile for each application.

In embodiments where the machine learning program is implemented by the controller 200 (e.g., locally on the power tool 100), the machine learning control 515 may benefit from firmware or memory updates. Accordingly, a prompt asking a user to update the machine learning program may be provided via the indicators 235 or on a display of the external device 245.

The machine learning controller 500 could be used to help determine the proper settings for the power tool 100 based on combinations of any of the sensors/parameters described herein. A machine learning model can be built as described above by collecting training data that would include measured values from any available sensors. The training data would then be used to build a model to predict, e.g., hammer position, anvil position, etc., during an impacting operation based on input sensor values. The model could also continue to learn and improve over time by giving the user the ability to manually adjust operation while in use. This could be useful in helping the power tool 100 to adapt to specific user preferences. This would work by starting with a model built from a collected set of training data. The power tool 100 would use that model to set the initial operational values based on input sensor data. A user could then manually adjust operation as desired. These adjustments would be recorded by the controller 200 or machine learning controller 500, and then be used to adjust the model for future use. The machine learning controller 500 could also be used to control field weakening for the power tool 100 (e.g., based on a determined hammer position, anvil position, etc.).

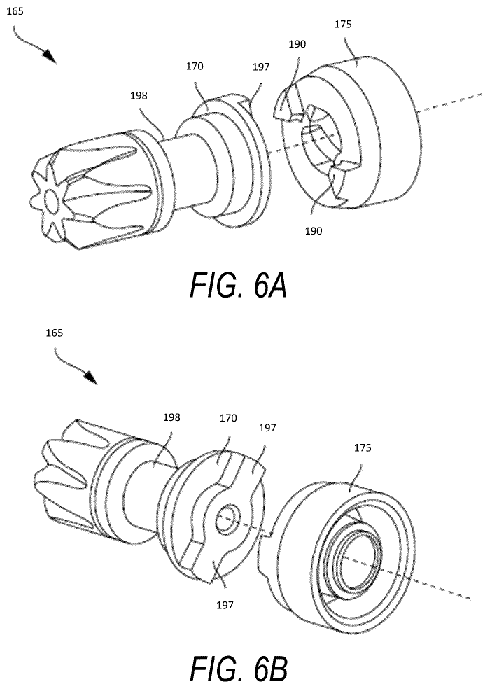

FIGS. 6A and 6B show an impact mechanism 165, which is an example of an impact mechanism of the power tool 100. Based on the design of the impact mechanism 165 of the power tool 100, the motor 105 rotates at least a predetermined number of degrees between impacts (i.e., 180 degrees for the impact mechanism 165). The impact mechanism 165 includes the hammer 175 with outwardly extending lugs 190 (e.g., the plurality of protrusions) and the anvil 170 with outwardly extending lugs 197 (e.g., the plurality of protrusions). The anvil 170 is coupled to an output drive device 198. In some embodiments, the output drive device 198 includes a gearbox output for interfacing with a gearbox to drive another output shaft. FIGS. 6A and 6B illustrate a helical bevel gearbox output, however, other types of gearbox outputs may be used, such as a straight bevel, a spiral bevel, or the like. In some embodiments, the gearbox output is omitted and the output drive device 198 directly interfaces with a workpiece. For example, the output drive device 198 may be a socket, a chuck, or some other type of workpiece interface. During operation, impacting occurs when the anvil 170 encounters a certain amount of resistance, e.g., when driving a fastener into a workpiece. When this resistance is met, the hammer 175 continues to rotate. The spring 180 coupled to the back-side of the hammer 175 causes the hammer 175 to disengage the anvil 170 by axially retreating. Once disengaged, the hammer 175 will advance both axially and rotationally to again engage (i.e., impact) the anvil 170. When the impact mechanism 165 is operated, the hammer lugs 190 impact the anvil lugs 197 every 180 degrees. Accordingly, when the power tool 100 is impacting, the hammer 175 rotates 180 degrees without the anvil 170, impacts the anvil 170, and then rotates with the anvil 170 a certain amount before repeating this process. For further reference on the functionality of the impact mechanism 165, see, for instance, the impact mechanism discussed in U.S. patent application Ser. No. 14/210,812, filed Mar. 14, 2014, which is herein incorporated by reference.

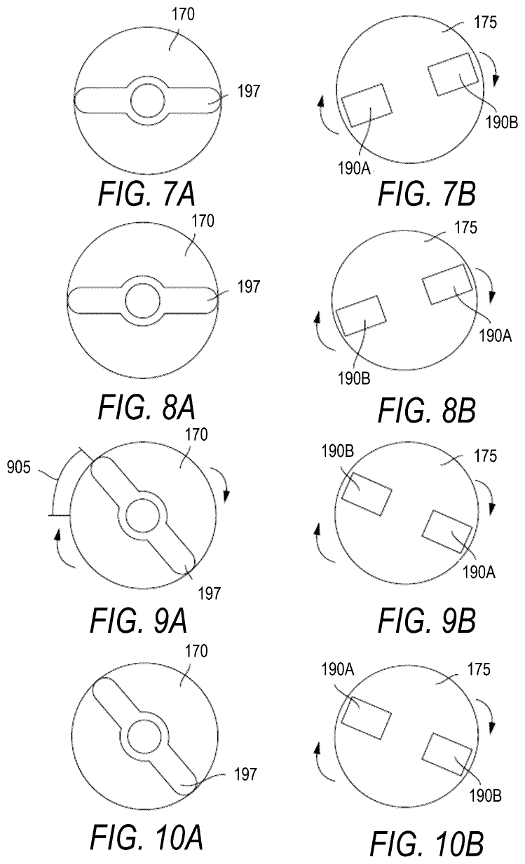

The controller 200 can determine how far the hammer 175 and the anvil 170 rotated together by monitoring the angle of rotation of the shaft of the motor 105 between impacts using the Hall sensors 215 or by monitoring the anvil position using the one or more anvil position sensors 222. For example, when the power tool 100 is driving an anchor into a softer joint, the hammer 175 may rotate 225 degrees in between impacts. In this example of 225 degrees, 45 degrees of the rotation includes hammer 175 and anvil 170 engaged with each other and 180 degrees includes just the hammer 175 rotating before the hammer lugs 190 impact the anvil 170 again. FIGS. 7A-10B illustrate this exemplary rotation of the hammer 175 and the anvil 170 at different stages of operation.

FIGS. 7A and 7B show the rotational positions of the anvil 170 and the hammer 175, respectively, just after the hammer 175 disengages the anvil 170 (i.e., after an impact and engaged rotation by both the hammer 175 and the anvil 170 has occurred). FIG. 7B shows the position of the hammer 175 just as the hammer 175 begins to axial retreat from the anvil 170. In FIGS. 7A and 7B, the hammer 175 and anvil 170 are in a first rotational position. After the hammer 175 disengages the anvil 170 by axially retreating, the hammer 175 continues to rotate (as indicated by the arrows in FIG. 7B) while the anvil 170 remains in the first rotational position. FIGS. 8A and 8B show the rotational positions of the anvil 170 and the hammer 175, respectively, just as the next impact is occurring. As shown in FIG. 8A, the anvil 170 is still located in the first rotational position. As shown in FIG. 8B, the hammer 175 has rotated 180 degrees to a second rotational position (as indicated by the arrows in FIG. 8B).

Upon impact, the hammer 175 and the anvil 170 rotate together (as indicated by the arrows in FIGS. 9A and 9B) which generates torque that is provided to the output drive device 198 to drive an anchor into concrete, for example. FIGS. 9A and 9B show the rotational positions of the anvil 170 and the hammer 175, respectively, after the hammer 175 again disengages the anvil 170 by axially retreating. In FIGS. 9A and 9B, the hammer 175 and anvil 170 are in a third rotational position that is approximately 45 degrees from the second rotational position as indicated by drive angle 905. The drive angle 905 indicates the number of degrees that the anvil 170 rotated which corresponds to the number of degrees that the output drive device 198 rotated.

As stated above, after the hammer 175 disengages the anvil 170, the hammer 175 continues to rotate (as indicated by the arrows in FIG. 10B) while the anvil 170 remains in the same rotational position. FIGS. 10A and 10B show the rotational positions of the anvil 170 and the hammer 175, respectively, just as another impact is occurring. As shown in FIG. 10A, the anvil 170 is still located in the third rotational position. As shown in FIG. 10B, the hammer 175 has rotated 180 degrees from the third rotational position to a fourth rotational position. Relative to FIG. 8B (i.e., since the previous impact occurred), the hammer 175 has rotated 225 degrees (i.e., 45 degrees while engaged with the anvil 170 after the previous impact and 180 degrees after disengaging from the anvil 170).

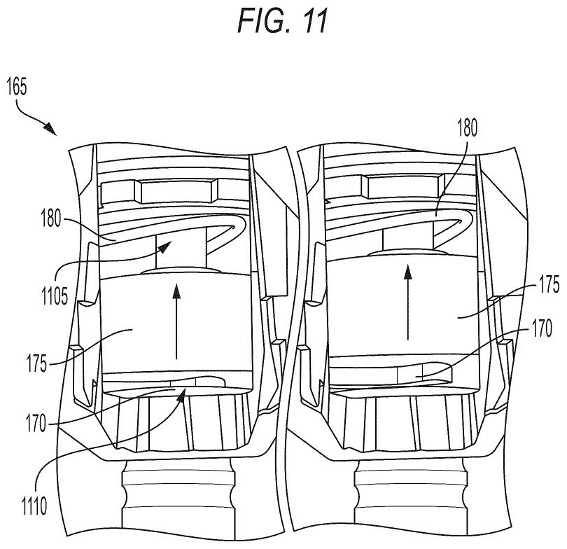

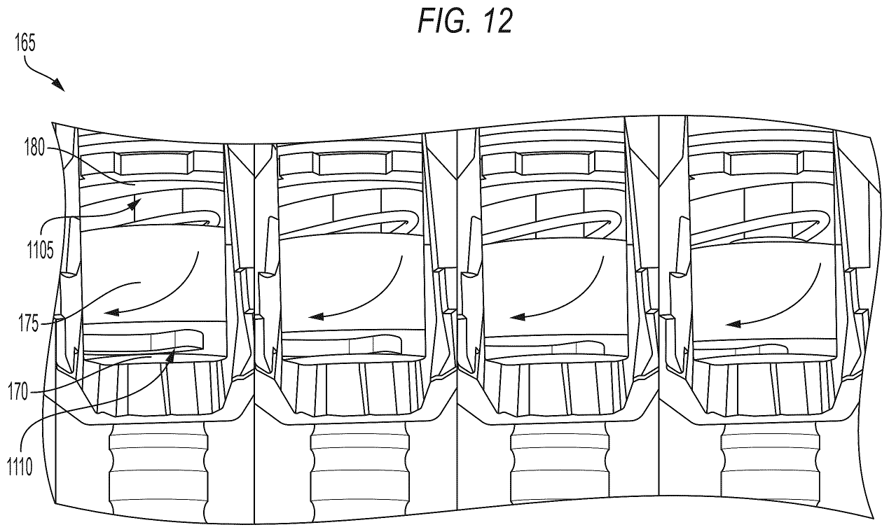

FIG. 11 illustrates an exemplary translation of the hammer 175 incorporated within the impact mechanism 165. As shown in FIG. 11, after the hammer 175 disengages the anvil 170, the hammer 175 advances towards a first position 1105 (e.g., a peak position) in which the spring 180 is fully compressed. In some embodiments, the first position 1105 is variable between power tools based on the compression capability of the spring 180, the rebounding speed of the hammer 175 after disengaging the anvil 170, etc. In some embodiments, the first position is variable between impact events based on the compression capability of the spring 180, the rebounding speed of the hammer 175 after disengaging the anvil 170, etc. The first position is opposite a second position 1110, in which the spring 180 is in tension enough for the hammer 175 to engage the anvil 170. The hammer 175 advances towards the first position 1105 in a helical motion to reset the hammer 175 for a subsequent impact following an impact at the second position 1110. The helical motion results in a linear translation of the hammer 175 from the second position 1110 to the first position 1105 following an impact or from the first position 1105 to the second position 1110 prior to an impact. The linear translation of the hammer 175 from the first position 1105 to the second position 1110 is in accordance with the rotation of the motor 105, as described above, with regard to FIGS. 6A and 6B.

FIG. 12 illustrates an exemplary translation of the hammer 175 incorporated within the impact mechanism 165, similar to FIG. 11. As shown in FIG. 12, after the hammer 175 reaches the first position 1105, the hammer 175 retreats from the first position 1105 towards the second position 1100 in a helical motion opposite the direction of the helical motion as described above with regard to FIG. 11. The second position 1110 occurs once the hammer 175 engages the anvil 170 creating an impact. In some embodiments, the inertial measurement unit (“IMU”) 217 generates a signal indicative of an impact and communicates the signal to the controller 200. In some embodiments, the hammer 175 is determined to reach the second position 1110 indirectly based on the signal received by the controller 200 from the IMU 217. In other embodiments, the hammer 175 is determined to be in the first position 1105 or the second position 1110 based on the information output by the one or more hammer position sensors 220. The linear translation of the hammer 175 from the second position 1110 to the first position 1105 is in accordance with the rotation of the motor 105, as described above, with regard to FIGS. 6A and 6B. Following the hammer 175 reaching the second position 1110, the hammer 175 advances to the first position 1105 similarly to the exemplary translation as described with regard to FIG. 11.

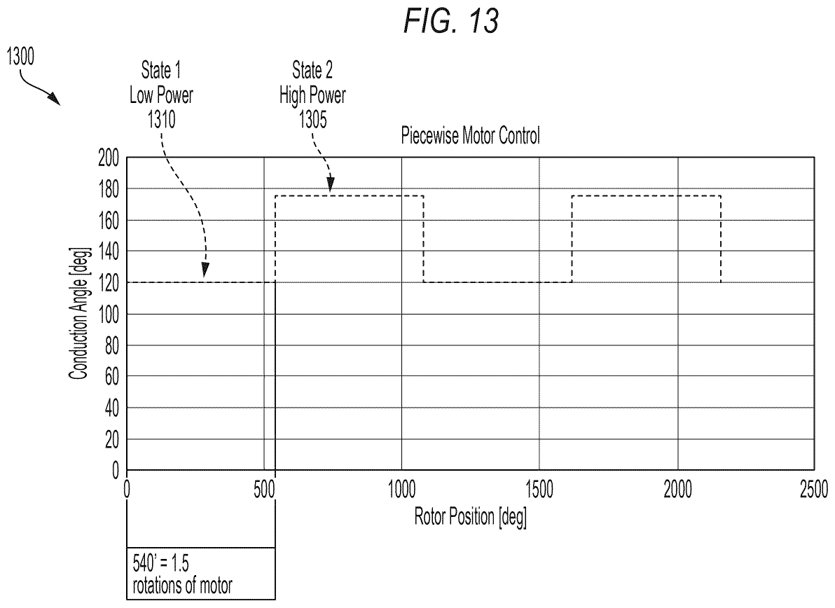

FIG. 13 is a graph 1300 illustrating a change in conduction angle of a brushless DC motor based on rotor position between a high power state 1305 (e.g., a first field weakening control mode) and a low power state 1310 (e.g., a second field weakening control mode). In some embodiments, the high power state 1305 and the low power state 1310 correspond to respective rotational positions of the motor 105 or the hammer 175. As described in further detail below, the high power state 1305 occurs as the hammer 175 translates from the first position 1105 to the second position 1110. The low power state occurs as the hammer 175 translates from the second position 1110 to the first position 1105 following an impact. As shown in FIG. 13, the conduction angle of the motor 105 during the low power state 1310 is maintained at a first value (e.g., 90 degrees to 120 degrees). During the low power state 1310, the phase advance or conduction angle of the motor 105 is varied via a pulse-width modulated (“PWM”) signal received by the motor 105 from the controller 200. In some embodiments, the PWM signal includes an 100% duty cycle. In other embodiments, the duty cycle of the PWM signal is less than 100% to reduce power supplied to the motor 105. As further shown in FIG. 13, the conduction angle of the motor 105 is increased to a conduction angle value less than 180 degrees (e.g., 175 degrees) as the rotor position reaches 540 degrees, or 1.5 rotations of the motor 105 as the motor 105 transitions from the low power state 1310 to the high power state 1305. In some embodiments, the phase advance or conduction angle of the motor 105 remains constant and the duty cycle of the PWM signal is varied to achieve the high power state 1305 and the low power state 1310. In some embodiments, the conduction angle of the motor 105 can be advanced at a plurality of rotor positions. In some embodiments, the rotor position in which the conduction angle of the motor 105 is advanced is determined based on the gear ratio of the motor and the number of hammer lugs 190 (e.g., a gear ratio of 12 with 2 hammer lugs 190). Different field weakening techniques can be used to achieve the high power state 1305 and the low power state 1310. For example, sensored field weakening, sensorless field weakening, field-oriented control (“FOC”), and conduction angle motor control can be used to achieve the high power state 1305 and the low power state 1310. In other examples, controlling the duty cycle of the PWM signal and synchronous rectification can be used to achieve the high power state 1305 and the low power state 1310.

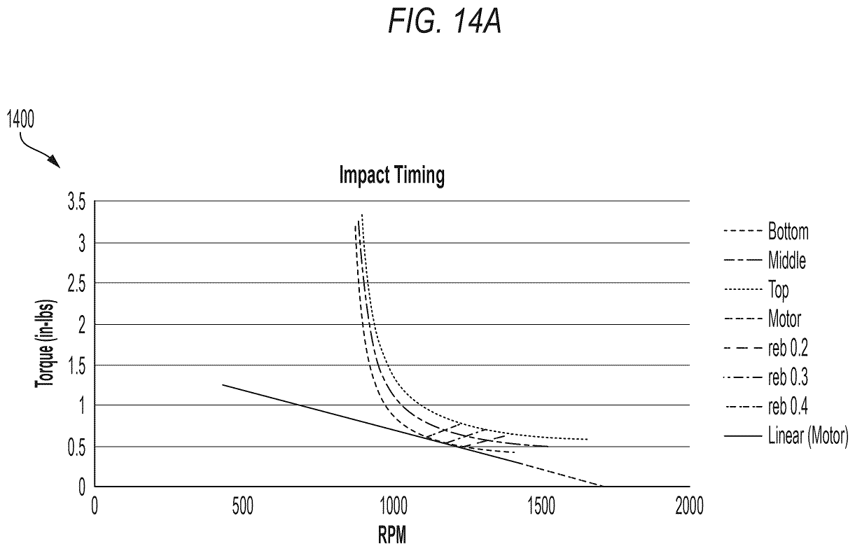

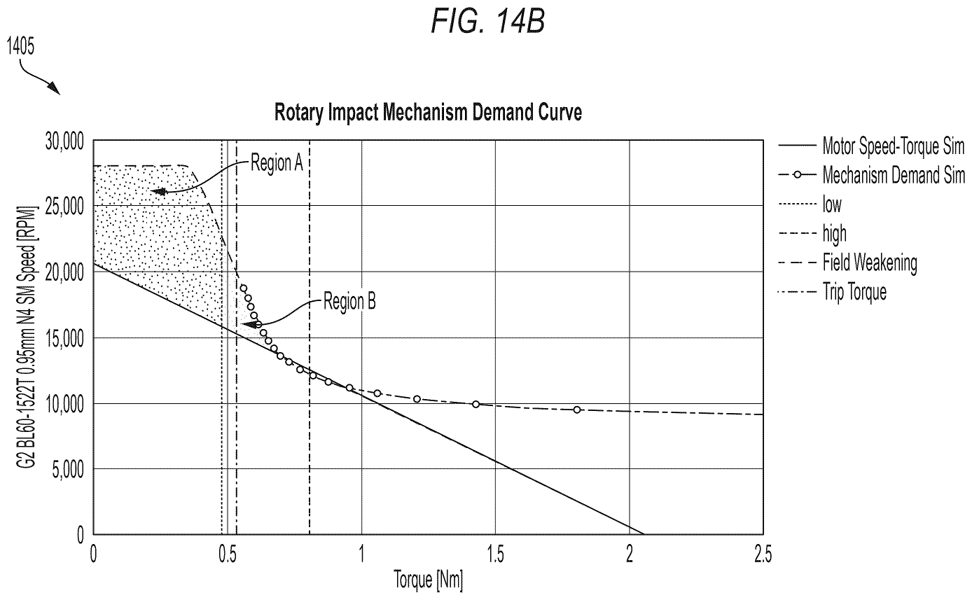

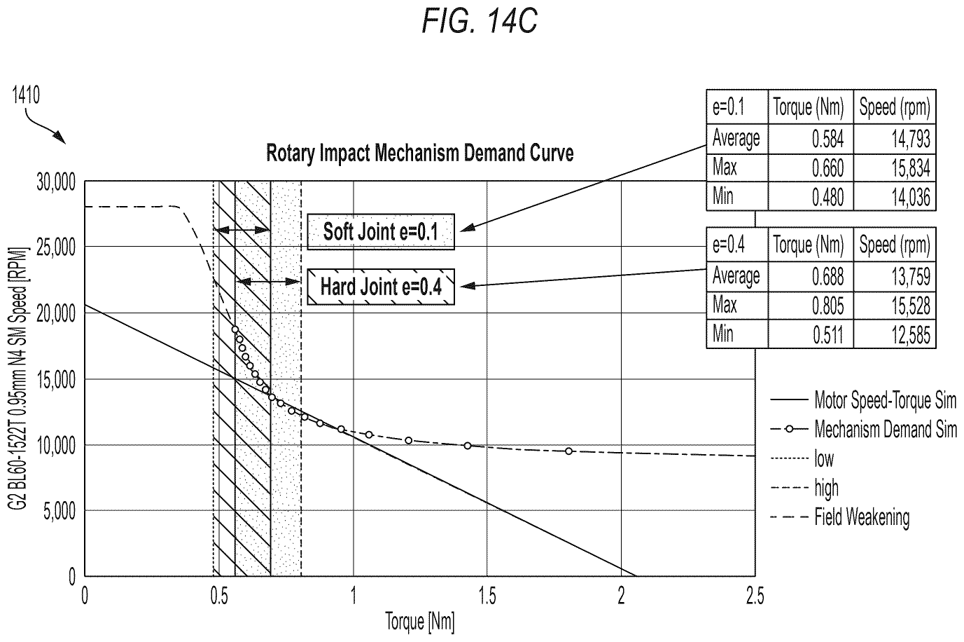

FIG. 14A is a graph 1400 illustrating a relationship between revolutions per minute (“RPM”) of the motor 105 and torque of the motor 105 for determining impact timing of the hammer 175 and the anvil 170. Specifically, the graph 1400 illustrates a gradual decrease in torque of the motor 105 as the RPM of the motor 105 increases. The hammer 175 impacts the anvil 170 at various points along the curve shown in FIG. 14A corresponding to a torque value. The high power state 1305 is initiated based on the measured impact.

The graph 1400 represents the torque-speed relationship(s) which result in varying levels of engagement between the hammer 175 and anvil 170. For example, the hammer 175 can reach a collision along a plurality of heights of the anvil 170 (e.g., along the axis of rotation of the anvil 170) and result in a plurality of rebound coefficients of the hammer 175. The rebound coefficient is a ratio of energy which is subsequently stored in the spring 180 after an impact event. A smaller rebound coefficient, for example 0.2, indicates a large amount of energy absorbed by the anvil 170. In some embodiments, the rebound coefficient is determined as the quotient of hammer speed for a period of time from after the impact event to before the impact event. For example, if the hammer's rotational speed is 100 radians/second (“rad/s”) clockwise (“CW”) before an impact event and 20 rad/s CCW after the same impact event, the rebound coefficient is 0.2. The graph 1400 illustrates that when the power tool 100 is operating on an application producing a rebound coefficient of 0.2, the impact mechanism 165 will operate in a torque-speed range of the motor 105. If the power tool 100 operates on an application producing a greater rebound coefficient, for example 0.4, the torque-speed required will be of higher torque and slower speed than the lower rebound coefficient. In some embodiments, the torque-speed relationship of the motor 105 changes with varying battery voltage or changes to motor commutation strategy while the spring rate biasing the hammer 175, gear ratio, hammer inertia, and other factors may remain static.

FIG. 14B is a graph 1405 illustrating a relationship between torque of the motor 105 and revolutions per minute (“RPM”) of the motor 105 for determining impact timing of the hammer 175 and the anvil 170. The vertical lines “high” and “low” represent typical torque ranges the impact mechanism 165 operates within during normal operation of the motor 105. The “mechanism demand sim” represents the ideal bottom or full anvil 170-hammer 175 engagement line from FIG. 14A. The speed-torque line of the motor 105 falls away from tangent to the demand line at lower demand torques. In some embodiments, the field weakening is used to increase the speed of the motor 105 such that the speed-torque line becomes non-linear, but there is improved fit to the mechanism demand line. “Region B” is the area in which, in lighter duty applications (lower rebound coefficients), an improved hammer 175-anvil 170 engagement can be achieved and at higher speed thus permitting greater power transfer. “Region A” depicts the full range at which field weakening is employed but “Region A” falls at lower torques than the impact mechanism demands.

FIG. 14C is a graph 1410 illustrating the torque demand range of the impact mechanism 165 at different rebound coefficients. In some embodiments, the torque demand range changes at different rebound coefficients and changes the location of “Region B” (see FIG. 14B).

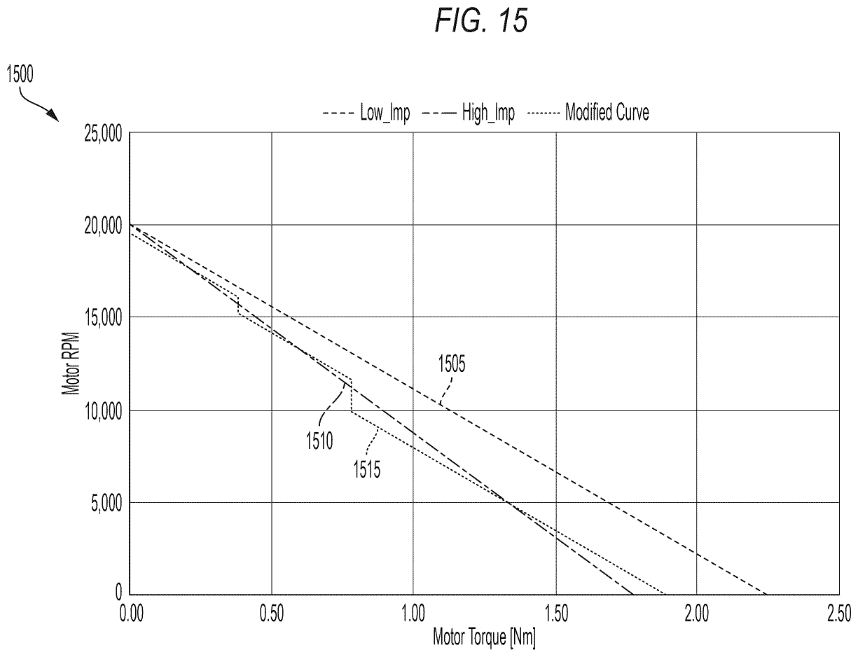

FIG. 15 is a graph 1500 illustrating a relationship between torque of the motor 105 and revolutions per minute (“RPM”) of the motor 105. Specifically, the graph 1500 illustrates an increase in torque of the motor 105 as the RPM of the motor decreases, similar to graph 1400. Line 1505 represents a speed-torque performance of motor 105 with a low impedance battery pack. Line 1510 represents a speed-torque performance of motor 105 with voltage supplied from a high impedance battery pack. The result is similar no-load performance. As torque (e.g., current draw) of the motor 105 is increased, the performance diverges. Line 1515 represents motor control that compensates for varying battery impedance by emulating the slope of the high impedance battery scenario by power-limiting the motor when a lower impedance battery pack is attached. In some embodiments, this is useful for operating an impact wrench since the spring rate biasing the hammer 175, gear ratio, cam geometry, and hammer inertia are static and designed to operate with a static and pre-determined speed-torque slope. Line 1515 maintains durability and performance when a higher speed, higher stall scenario is encountered by use of a lower impedance battery and the lower impedance battery results in the speed-torque curve of the motor 105 no longer laying in an ideal tangency to a demand line. In some embodiments, the line 1515 is positioned such that the hammer 175 and anvil 170 will achieve less engagement at the moment of an impact.

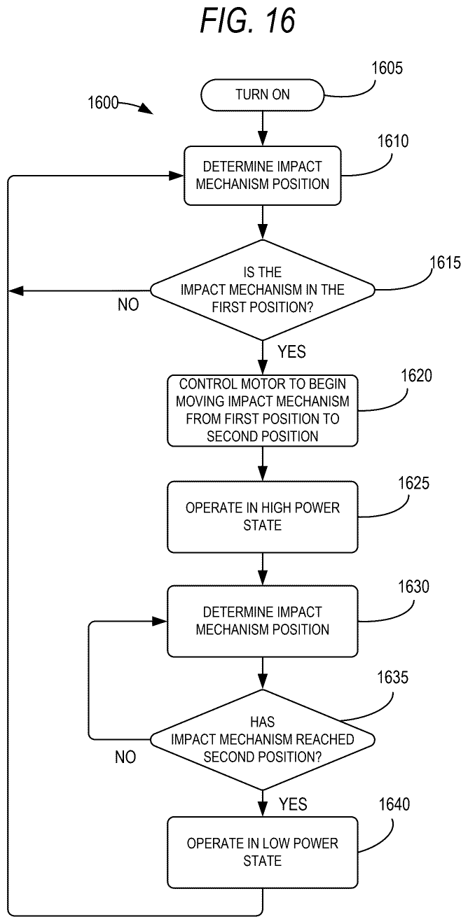

FIG. 16 is a flow chart of a method 1600 for implementing the high power state 1305 and the low power state 1310. The method 1600 begins with the power on of the power tool 100 and the controller 200 (BLOCK 1605). The method 1600 includes the controller 200 determining the position of a component of the impact mechanism 165 (for example, the hammer 175) based on the output information from the one or more hammer position sensors 220 (BLOCK 1610). The method 1600 also includes determining if the hammer 175 is at the first position 1105, via the controller 200, based on the output information (BLOCK 1615). If the hammer 175 is not determined to be at the first position 1105, the method 1600 returns to BLOCK 1610. If the hammer 175 is determined to be at the first position 1105, the controller 200 generates a pulse-width modulated (“PWM”) command to control the motor 105 to move the hammer 175 in a direction from the first position 1105 to the second position 1110 (BLOCK 1620). The method 1600 also includes applying the high power state 1305, via the controller 200, to the motor 105 as the hammer 175 moves from the first position 1105 to the second position 1110 (BLOCK 1625). The method 1600 also includes the controller 200 again determining the position of the hammer 175 based on the output information from the one or more hammer position sensors 220 (BLOCK 1630). The method 1600 also includes determining if the hammer 175 is at the second position 1110, via the controller 200, based on the output information (BLOCK 1635).

If the hammer 175 is not determined to be at the second position 1110, the method 1600 returns to BLOCK 1630. If the hammer 175 is determined to be at the second position 1105, the controller 200 applies the low power state 1310 to the motor 105 as the hammer 175 moves from the second position 1110 to the first position 1105 (BLOCK 1640). Once the low power state 1310 has been applied, the method 1600 returns to BLOCK 1610.

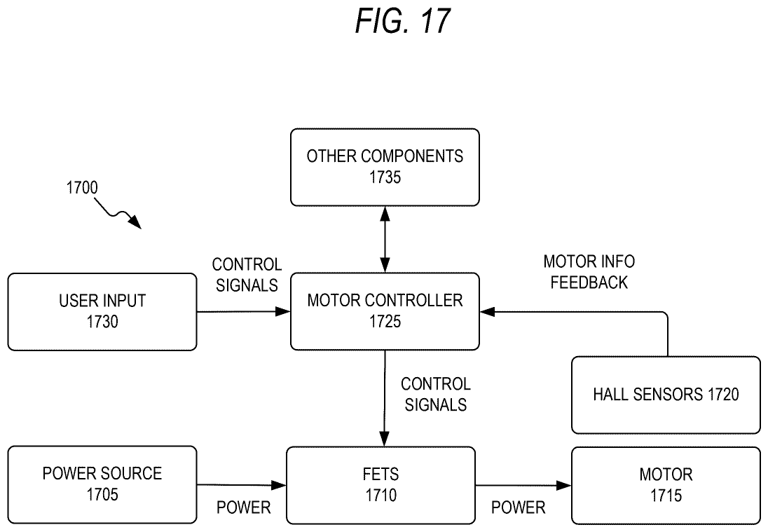

FIG. 17 illustrates a simplified block diagram of an embodiment 1700 of the power tool 100 that implements sensored motor control for implementing the field weakening of the method 1600. The power tool 1700 includes a power source 1705, switches or Field Effect Transistors (“FETs”) 1710, a motor 1715, Hall effect sensors 1720, a motor controller 1725 (e.g., controller 200), user input 1730, and other components 1735 (e.g., a battery pack fuel gauge, work lights (LEDs), current/voltage sensors, etc.). The power source 1705 provides DC power to the various components of the power tool 700 and may be a power tool battery pack that is rechargeable and uses, for instance, lithium ion cell technology. In some instances, the power source 1705 may receive AC power (e.g., 120V/60 Hz) from a tool plug that is coupled to a standard wall outlet, and then filter, condition, and rectify the received power to output DC power. Each Hall effect sensor 1720 outputs motor feedback information, such as an indication (e.g., a pulse) when a magnet of the rotor rotates across the face of that Hall effect sensor 1720. Based on the motor feedback information from the Hall effect sensors 1720, the motor controller 1725 can determine the position, velocity, and/or acceleration of a rotor of the motor 1715. The motor controller 1725 also receives user controls from user input 1730, such as by depressing the trigger 150. In response to the motor feedback information and user controls, the motor controller 1725 transmits control signals to control the FETs 1710 to drive the motor 1715. By selectively enabling and disabling the FETs 1710, power from the power source 1705 is selectively applied to stator coils of the motor 1715 to cause rotation of the rotor. Although not shown, the motor controller 1725 and other components of the power tool 1700 are electrically coupled to the power source 1705 such that the power source 1705 provides power thereto.

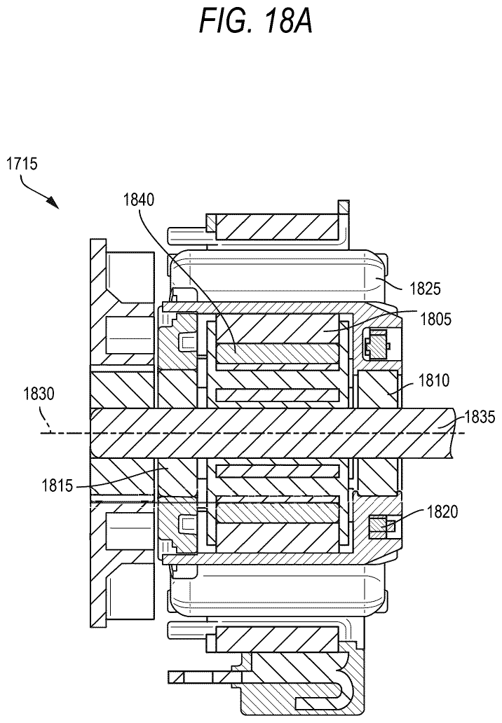

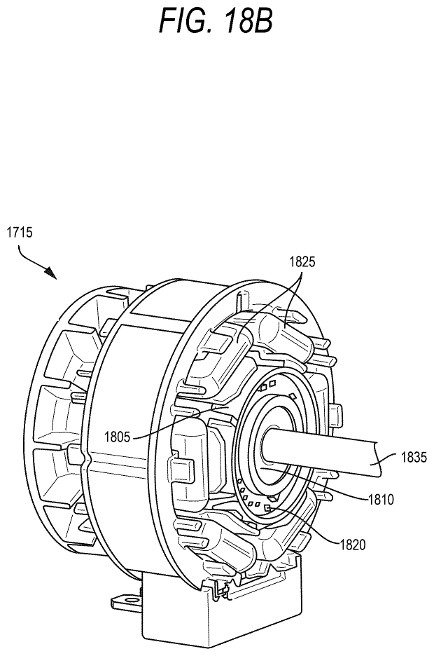

FIGS. 18A and 18B illustrates the motor 1715 in the power tool 1700. The motor 1715 includes a rotor 1805, a front bearing 1810, a rear bearing 1815 (collectively referred to as the bearings 1810, 1815), a position sensor board assembly 1820 within a stator envelope of the motor 1715, and a motor shaft 1835. Stator coils 1825 are parallel to the length of a rotor axis 1830. Rotor magnets 1840 are brought into proximity of the Hall effect sensors 1720 on the position sensor board assembly 1820 in order to detect the rotor position. Recessing the rotor 1805, the bearings 1810, 1815, and the position sensor board assembly 1820 within the stator envelope allows a more compact motor 1715 in the axial direction.

In some embodiments, the embodiment 1700, including the motor 1715 and motor controller 1725, executes the method 1600 for implementing a high power state 1305 and a low power state 1310. In some embodiments, the one or more hammer sensors 220 are included in the other components 1735. For example, the motor controller 1725 determines if the hammer 175 is at the first position 1105 based on the output information from the one or more hammer position sensors 220, such as in BLOCK 1615 of method 1600. The motor controller 1725 transmits a control signal to control the FETs 1710 to drive the motor 1715 that begins moving the hammer 175 from the first position 1105 to the second position 1110, such as in BLOCK 1620. As the hammer 175 moves from the first position 1105 to the second position 1110, the motor controller 1725 determines the position of the rotor of the motor 1715 based on the motor feedback information of the Hall sensors 1720. The motor controller 1720 also implements the high power state 1305 by transmitting a control signal to the FETs 1710 to apply a phase advance and/or increase the conduction angle of the motor 1715 up to a value of less than or equal to 180 degrees, for example, up to 175 degrees, such as in BLOCK 1625. The motor controller 1725 determines if the hammer 175 is at the second position 1110 based on the output information from the one or more hammer position sensors 220, such as in BLOCK 1630 of method 1600. If the hammer 175 is determined to be at the second position 1110 such as in BLOCK 1635, the motor controller 1725 implements the low power state 1310 as the hammer 175 advances to the first position 1105 from the second position 1110 such as in BLOCK 1640. For example, during the low power state 1310, the motor controller 1725 transmits a control signal to the FETs 1710 to return the conduction angle to a lower value (e.g., between 90 degrees and 120 degrees) and transmits a separate pulse-width modulated (“PWM”) control signal to implement a phase advance or conduction angle at a variable duty cycle. In some embodiments, the PWM control signal includes an 100% duty cycle. In other embodiments, the PWM control signal includes a duty cycle less than 100% which allows the embodiments 1700 to further reduce motor power. Reducing motor power in the low power state 1310 allows the motor 105 to cool and reduce the heating effects experienced by the motor 105 during the high power state 1305. By cooling the motor during the low power state 1310, the motor 105 can produce a greater amount of torque during the high power state 1305. Once the low power state 1310 is implemented, the method 1600 returns to BLOCK 1615 in which the motor controller 1725 determines if the hammer 175 is at the first position 1105 based on the output information from the one or more hammer position sensors 220.

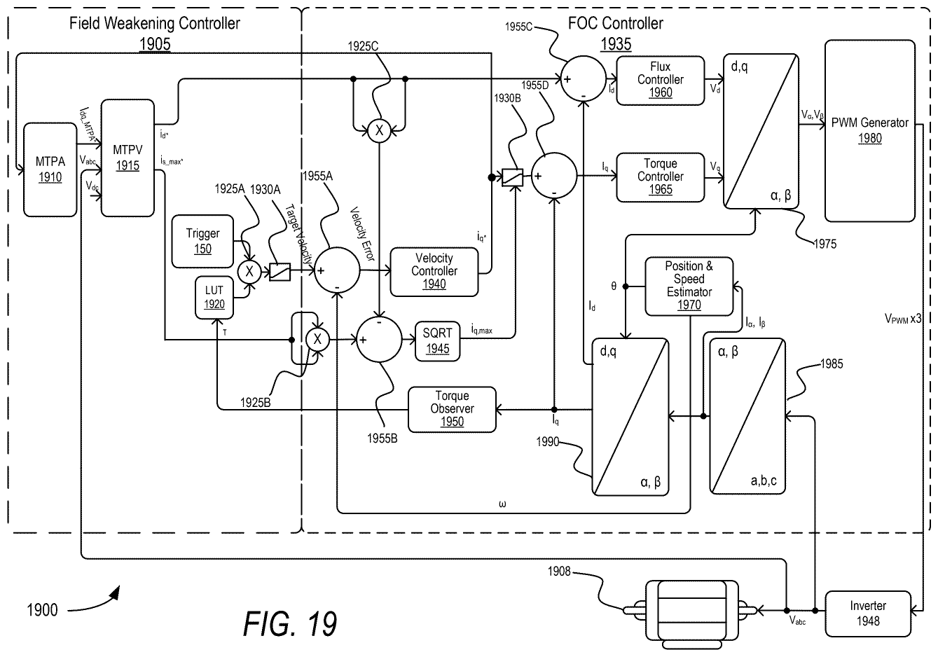

FIG. 19 is a block diagram for a control system 1900 of a sensorless field weakening algorithm for use in the power tool 100. The control system 1900 can be implemented by the controller 200 and can include one or more additional controllers (e.g., dedicated controllers). For example, as illustrated by FIG. 19, the control system 1900 includes a field weakening controller 1905 and a sensorless or field-oriented control (“FOC”) controller 1935. The field weakening controller 1905 and the FOC controller 1935 may include one or more mathematical operator blocks, such as multiplication blocks 1925A-C which multiply two or more input values, linear scaling blocks 1930A-B which linearly scale an input value based on a scaling factor, square root blocks 1945 which determine the square root of an input value, and/or addition/subtraction blocks 1955A-D which add or subtract two or more input values. In some embodiments the mathematical operator blocks may perform different mathematical operations. For example, the linear scaling blocks 1930A-B may scale a value up or down based on a non-linear function. The field weakening controller 1905 and the FOC controller 1935 may each include one or more components that are configured to send and receive signals between the field weakening controller 1905 and the FOC controller 1935. In some embodiments, a sensorless motor control technique other than FOC is implemented.

The field weakening controller 1905 includes a control block for controlling a max-torque-per-amps (“MTPA”) algorithm (“MTPA block 1910”) and a control block for controlling a max-torque-per-volts (“MTPV”) algorithm (“MTPV block 1915”). The MTPA block 1910 receives one or more inputs, such as an input i_{q}* from the FOC controller 1935 relating to a torque current. The MTPA block 1910 may perform one or more mathematical operations to generate and output a signal I_{dq_MTPA}* relating to a flux current and a torque current. The MTPV block 1915 receives one or more signals, such as an input I_{dq_MTPA}* from the MTPA block 1910 relating to a flux current and a torque current, an input V_{abc} relating to voltages applied to the phases of the sensorless motor 1908, and/or an input V_{dc} relating to a voltage of a battery pack connected to the power tool 100. The MTPV block 1915 may further generate one or more output signals, such as a signal i_{d}* relating to a flux current determined by the MTPV block 1915 and/or a signal i_{s_max}* relating to a maximum current of a stator of the motor 308 determined by the MTPV block 1915.

The field weakening controller 1905 may further include a look-up table (“LUT”) 1920 which contains one or more output values based on one or more input values. For example, the LUT 1920 may receive a signal τ relating to a present torque of the motor 308. The LUT 1920 may determine and output a signal based on the received torque signal τ. In some embodiments, the LUT 1920 is a speed map. The speed map receives an estimated load torque as an input, and outputs a speed reference value based on the estimated load torque. The speed map may be modifiable by a user to create tool-specific speed-torque characteristics. The field weakening controller 1905 may further include a first multiplication block 1925A which receives a first signal from the LUT 1920 and a second signal from the trigger 150 of the power tool 100, and multiplies the first and second signals to generate an output signal. The field weakening controller 1905 may further include a first linear scaling block 1930A which receives a signal from the first multiplication block 1925A and scales the signal based on a linear function, and outputs a signal corresponding to the result of the scaling. In some embodiments, the function is non-linear. The signal output by the first linear scaling block 1930A may be a target velocity for the motor 308.

The FOC controller 1935 includes a first addition/subtraction block 1955A configured to add a first signal received from the first linear scaling block 1930A corresponding to a target velocity for the motor 1908 and to subtract a second signal @ corresponding to a present velocity of the motor 1908. The first addition/subtraction block 1955A may be further configured to output a signal corresponding to the result of the first addition/subtraction block 1955A. The signal output by the first addition/subtraction block 1955A may be a velocity error of the motor 1908. The FOC controller 1935 may further include a velocity controller 1940 configured to receive a signal from the first addition/subtraction block 1955A corresponding to a velocity error of the motor 308. The velocity controller 1940 may generate an output signal i_{q}* based on the velocity error and output the output signal i_{q}* to the MTPA block 1910.

The FOC controller 1935 may further include a second multiplication block 1925B configured to receive two signals i_{s_max} (i.e., the same signal twice) from the MTPV block 1915 of the field weakening controller 1905. The second multiplication block 1925B may multiply the two signals i_{s_max} together to generate a squared value of i_{s_max} and generate an output signal corresponding to the squared value of i_{s_max}. The FOC controller 1935 may further include a third multiplication block 1925C configured to receive two signals i_{d}* (i.e., the same signal twice) from the MTPV block 1915 of the field weakening controller 1905. The third multiplication block 1925C may multiply the two signals id together to generate a squared value of i_{d}*, and generate an output signal corresponding to the squared value of i_{d}*. The FOC controller 1935 may further include a second addition/subtraction block 1955B configured to receive and add a first signal from the second multiplication block 1925B corresponding to the squared value of i_{s_max}. The second addition/subtraction block 1955B may be further configured to receive and subtract a second signal from the third multiplication block 1925C corresponding to the squared value of i_{d}*. The second addition/subtraction block 1955B may be further configured to generate an output signal corresponding to the result of the second addition/subtraction block 1955B. The FOC controller 1935 may further include a square root block 1945 configured to receive a signal from the second addition/subtraction block 1955B corresponding to a result of the second addition/subtraction block 1955B. The square root block 1945 may be further configured to generate and output a signal i_{q,max} corresponding a to a square root value of the signal received from the second addition/subtraction block 1955B. That is to say, the combination of the second multiplication block 1925B, the third multiplication block 1925C, the second addition/subtraction block 1955B, and the square root block 1945 may be configured to perform a Pythagorean operation on the outputs of the MTPV block 1915 to break the current Is of the stator of the motor 308 into its component vectors, the flux current id and the torque current i_{q}.

The FOC controller 1935 may further include a third addition/subtraction block 1955C configured to receive and add a first signal i_{d}* from the MTPV block 1915 corresponding to the flux current determined by the MTPV block 1915. The third addition/subtraction block 1955C may be further configured to receive and subtract a second signal I_{d} corresponding to a total flux current of the motor 308. The third addition/subtraction block 1955C may be configured to output a signal I_{d} corresponding to the result of the third addition/subtraction block 1955C. The FOC controller 1935 may further include a flux controller 1960 configured to receive an input signal I_{d} from the third addition/subtraction block 1955C and generate and output a flux voltage signal Va based on the input signal I_{d}.

The FOC controller 1935 further includes a second linear scaling block 1930B configured to receive a first signal i_{q}* from the velocity controller 1940 and a second signal i_{q,max} from the square root block 1945. The second linear scaling block 1930B may be further configured to linearly scale the first signal i_{q}* based on the second signal i_{q,max} and output a signal corresponding to the result of the second linear scaling block 1930B. The FOC controller 1935 further includes a fourth addition/subtraction block 1955D configured to receive and add a first signal corresponding to the result of the second linear scaling block 1930B. The fourth addition/subtraction block 1955D may be further configured to receive and subtract a second signal I_{q} corresponding to a total torque current of the motor 308. The fourth addition/subtraction block 1955D may be configured to output a signal I_{q} corresponding to the result of the fourth addition/subtraction block 1955D. The FOC controller 1935 may further include a torque controller 1965 configured to receive an input signal I_{q} from the fourth addition/subtraction block 1955D and generate and output a torque voltage signal V_{q} based on the input signal I_{q}.

The FOC controller 1935 may further include an inverse Park transform block 1975 configured to receive a first signal Va from the flux controller corresponding to a flux voltage, a second signal V_{q} from the torque controller corresponding to a torque voltage, and a third signal θ corresponding to a present angular position of a rotor of the motor 1908. The inverse Park transform block 1975 may be configured to convert the first signal V_{d} and second signal V_{q} to orthogonal stationary reference frame quantities V_{α} and V_{β} based on the third signal θ. The inverse Park transform block 1975 may be further configured to output a signal corresponding to the orthogonal stationary reference frame quantities V_{α} and V_{β}. The FOC controller 1935 may further include a PWM generator 1980 including an inverse Clarke transform block, a PWM modulator, or both. The PWM generator 1980 may be configured to receive the signal corresponding to the orthogonal stationary reference frame quantities Va and VB from the inverse Park transform block 1975 and generate a plurality of pulse-width modulated (“PWM”) control signals V_{PWM}×3 configured to control the inverter 1948. The inverter 1948 may be configured to receive the plurality of PWM control signals V_{PWM}×3 and convert a DC power supply to a three-phase signal V_{abc} for controlling the motor 1908. The three-phase signal V_{abc} may also be received by the MTPV block 1915.

The FOC controller 1935 further includes a three-phase-to-two-phase reference frame converter 1985 configured to receive the three-phase signal V_{abc} from the inverter and generate and output a two-phase current signal I_{α}, I_{β} based on the three-phase signal V_{abc}. The FOC controller 1935 furthers include a position and speed estimator 1970 configured to receive the two-phase current signal I_{α}, I_{β} from the three-phase-to-two-phase reference frame converter 1985 and estimate a position and speed of the sensorless motor 1908 based on the two-phase current signal I_{α}, I_{β}. The position and speed estimator 1970 may be further configured to output a first signal θ relating to the current angular position of the rotor of the motor 1908 and a second signal ω relating to the present rotational speed of the rotor of the motor 308. The first signal θ is received by the inverse Park transform block 1975. The second signal @ is also received by the first addition/subtraction block 1955A. The FOC controller 1935 further includes a Park transform block 1990 configured to receive the two-phase current signal I_{α}, I_{β} from the three-phase-to-two-phase reference frame converter 1985 and the first signal θ relating to the present angular position of the rotor of the motor 1908 from the position and speed estimator 1970. The Park transform block 1990 is further configured to generate a first signal I_{q} corresponding to a total torque current of the motor 1908 and a second signal I_{d} corresponding to a total flux current of the motor 1908 based on the two-phase current signal I_{α}, I_{β} and the first signal θ. The first signal I_{q} may be received by the torque observer 1950 and the fourth addition/subtraction block 1055D. The second signal I_{d} may be received by the third addition/subtraction block 1955C.

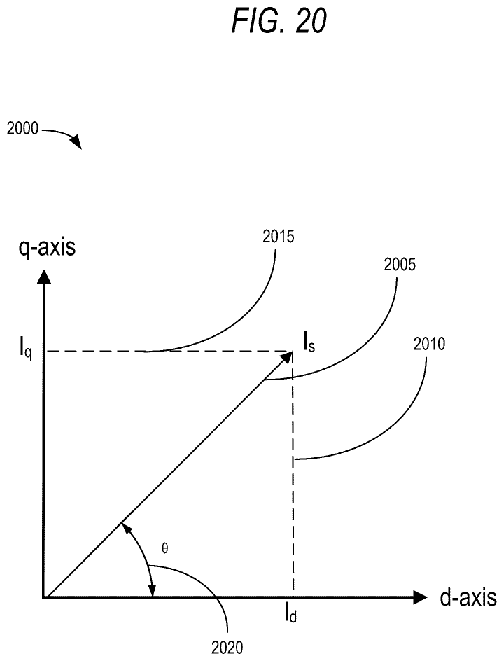

FIG. 20 is a graph 2000 illustrating a relationship between stator flux current and stator torque current on a q-d coordinate plane. The graph 2000 illustrates that the stator flux current i_{d} 2010 and the stator torque current i_{q} 2015 are both component vectors of the stator current Is 2005. In particular, as illustrated by the graph 2000, i_{d} 2010 can be calculated as a function of Iₛ 2005 and the angle between Iₛ 2005 and the d-axis, θ 2020, by equation (1).

$${i}_{d} = {I}_{s} cos θ \qquad ( 1 )$$

Similarly, as illustrated by the graph 2000, i_{q} 2015 can be calculated as a function of Iₛ 2005 and θ 2020 by equation (2).

$${i}_{q} = {I}_{s} sin θ \qquad ( 2 )$$

A sensorless motor (for example, the motor 1908 of FIG. 19), includes a rotor with a permanent magnet. This permanent magnet generates magnetic saliency, which in turn produces a reluctance torque from the difference between an inductance on the d-axis and an inductance on the q-axis. The reluctance torque, Tₑ, can be determined by equation (3), where P is the number of pole pairs of the motor, φ_{f} is the stator flux, L_{d} is a direct inductance on the d-axis, and L_{q} is a quadrature inductance on the q-axis.

$${T}_{e} = 1.5 P ( {φ}_{f} {i}_{q} + ( {L}_{d} - {L}_{q} ) {i}_{d} {i}_{q} ) \qquad ( 3 )$$

Based on equation (3), it can be noted that a negative value of i_{d} 2010 will ensure that Tₑ remains positive, which is favorable. Furthermore, the above equations (1), (2), and (3) can be combined to create equation (4).

$${T}_{e} = 1.5 P ( {Φ}_{f} {I}_{s} sin θ + 0.5 ( {L}_{d} - {L}_{q} ) {I}_{s}^{2} sin 2 θ ) \qquad ( 4 )$$

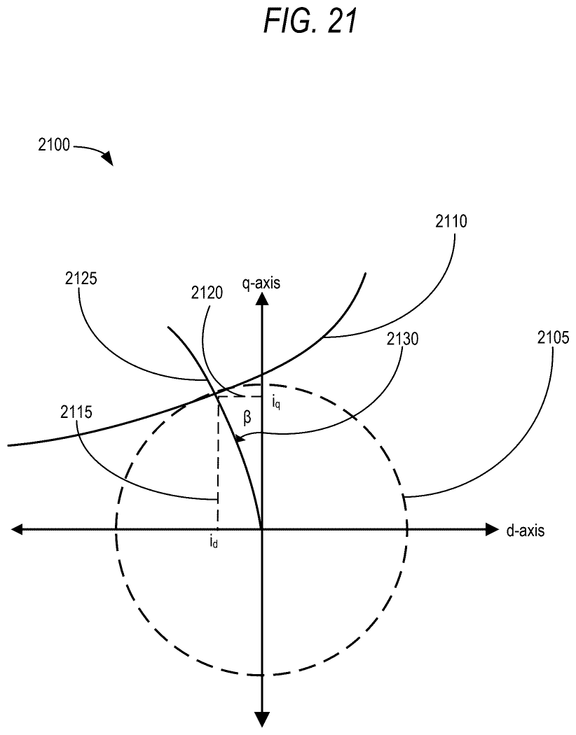

FIG. 21 is a graph 2100 illustrating a negative stator flux current for use in sensorless field weakening determined by a max-torque-per-amps (“MTPA”) algorithm. In particular, the graph 2100 illustrates an MTPA vector 2125 generated by an MTPA block (for example, MTPA block 1910) based on a crossing between of a constant current 2105 and a constant torque 2110 of the motor 1908. In some embodiments, the MTPA vector 2125 is a minimum current space vector that satisfies at least one constraint of the MTPA algorithm. The MTPA vector 2125 further includes a beta-angle 2130. In some embodiments, the beta-angle 2130 is optimized between 0° and 45° from the q-axis. In some embodiments, the beta-angle 2130 being between 0° and 45° is a constraint of the MTPA algorithm. The point at which the MTPA vector 2125 crosses the constant current 2105 and the constant torque 2110 can be defined by a flux current i_{d} 2115 and a torque current i_{q} 2120. As can be seen by FIG. 21, at the point where the MTPA vector 2125 is optimized, the flux current i_{d} 2115 is negative in terms of the d-axis. In some embodiments, the MTPA vector 2125 may be at a different beta-angle 2130 while still satisfying being between 0° and 45° from the q-axis. However, in these embodiments, the MTPA vector 2125 may not be a minimum current space vector, and therefore not optimized.

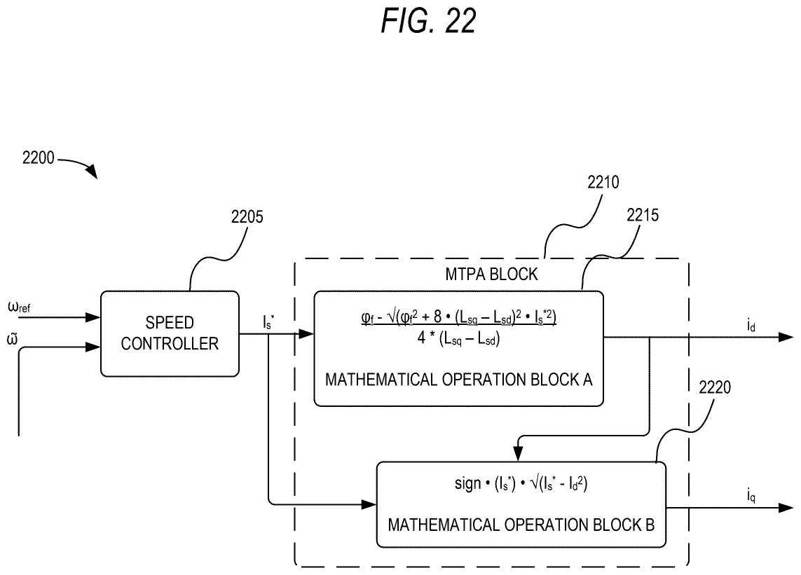

FIG. 22 is a block diagram of a control system 2200 for an MTPA algorithm. The control system 2200 includes a speed controller 2205 configured to receive a first signal ω_{ref} corresponding to a present angular speed of the rotor of the motor 1908 and a second signal \tilde{ω} corresponding to a target angular speed for the rotor, and generate a stator current signal Iₛ* to control the stator based on the present angular speed ω_{ref} in reference to the target angular speed \tilde{ω}. The control system 2200 may further include an MTPA block 2210 including a first mathematical operation block 2215 and a second mathematical operation block 2220. The first mathematical operation block 2215 is configured to receive the stator current signal Iₛ* and generate a flux current signal i_{d}. The second mathematical operation block 2220 is configured to receive the stator current signal Iₛ* and the flux current signal i_{d} and generate a torque current signal i_{q}. The MTPA block 2210 is configured to generate a flux current signal i_{d} and a torque current signal i_{q} that, for example, satisfies the constraints identified with respect to FIG. 21 that the beta angle be between 0° and 45° from the q-axis and the MPTA vector (i.e., the vector created by the component i_{d} and i_{q} vectors) be a minimum current space vector. The values for i_{d} and i_{q} that satisfy these constraints can be determined by equations (5), (6), and (7).

$${i}_{d} = \frac{{Φ}_{f} - \sqrt{{Φ}_{f}^{2} + 8 {( {L}_{q} - {L}_{d} )}^{2} {I}_{s}^{2}}}{4 ( {L}_{q} - {L}_{d} )} \qquad ( 5 )$$

$${i}_{q} = sign ( {I}_{s} ) \sqrt{{I}_{s}^{2} - {i}_{d}^{2}} \qquad ( 6 )$$

$$sign ( {I}_{s} ) = 1 if {I}_{s} \geq 0 , \qquad ( 7 )$$

$$sign ( {I}_{s} ) = - 1 if {I}_{s} \leq 0$$

The first mathematical operation block 2215 is configured to generate the flux current signal i_{d} based on equation (5). The second mathematical operation block 2220 is configured to generate the torque current signal i_{q} based on equations (6) and (7).

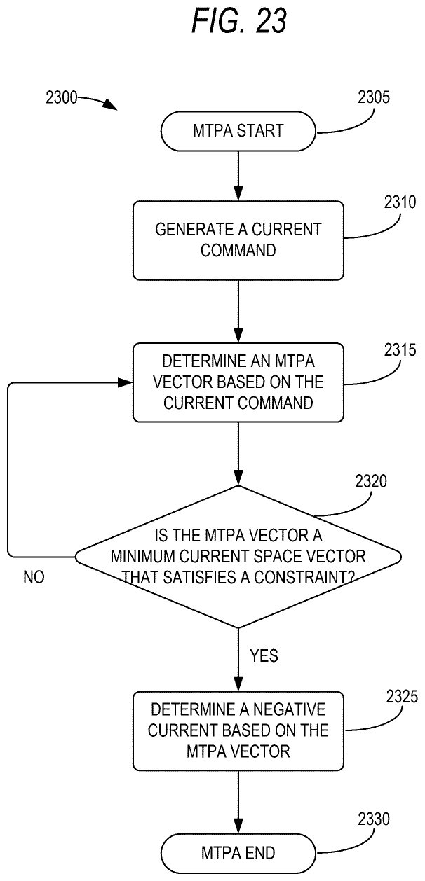

FIG. 23 is a flow chart of a method 2300 for implementing an MTPA algorithm. The method 2300 begins with the controller 200 executing the method 2300 and receiving a command to begin the MTPA algorithm (BLOCK 2305). The method 2300 includes generating a current command (BLOCK 2310). The current command may be generated by a speed controller (for example, speed controller 2205) based on a current angular speed ω_{ref} of the rotor of the motor 1908 and a target angular speed \tilde{ω} for the rotor. The method 2300 also includes determining an MTPA vector (for example, the MTPA vector 2125) based on the current command (BLOCK 2315). The MTPA vector may be generated by an MTPA block (for example, MTPA block 2210) based on equation (5). The MTPA vector includes a torque current component, i_{q}, and a flux current component, i_{d}. The method 2300 also includes determining if the MTPA vector is a minimum current space vector that satisfies one or more constraints (BLOCK 2320). The one or more constraints may be one or more of the constraints identified with respect to FIG. 21, for example that the angle between the q-axis and the MTPA vector is between 0° and 45°.

If the MTPA vector is not a minimum current space vector that satisfies the one or more constraints, the method 2300 returns to BLOCK 2315 and recalculates the MTPA vector. Returning to BLOCK 2320, if the MTPA vector is a minimum current space vector that satisfies the one or more constraints, the method 2300 includes determining a negative current based on the MTPA vector (BLOCK 2325). The negative current may be a stator flux current component of the MTPA vector, that is, i_{d}. Once the negative current has been identified, the MTPA algorithm has been completed and the method 2300 ends (BLOCK 2330).

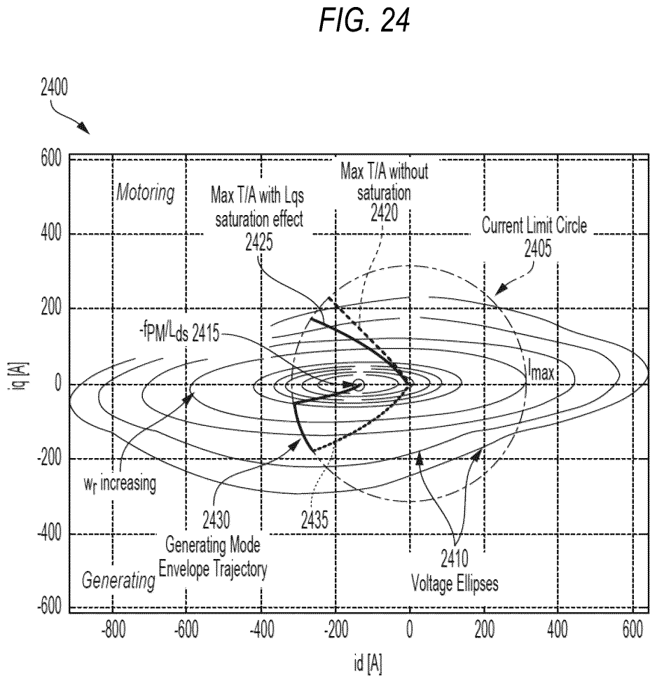

FIG. 24 is a graph 2400 illustrating a relationship between stator flux current and stator torque current. The graph 2400 includes a current limit 2405 as a circle with an amplitude centered at the origin, and a voltage limit 2410 as a family of nested ellipses centered at the point at which the MTPA vector is optimized (that is, the value of i_{d} counteracts the reluctance torque Tₑ based on equation [3]). The radii of the ellipses of the voltage limit 2410 may vary inversely with a speed of the rotor of the motor 1908. In some embodiments, the ellipses of the voltage limit 2410 are distorted along the vertical q-axis because of a saturation effect, and the diameters of the ellipses of the voltage limit 2410 exhibit a counter-clockwise tilt along the horizontal d-axis because of stator resistance effects. At any given speed, the motor 1908 can operate at any combination of i_{q} and i_{d} values that falls within the overlapping area of the current limit 2405 and the voltage limit 2410 associated with that speed. The value of negative I_{d} at which it completely opposes and negates the permanent magnet flux of the motor 1908 is identified at 2415.

The graph 2400 also includes a first MTPA vector 2420 without the effects of magnetic saturation and a second MTPA vector 2425 with the effects of magnetic saturation. The first MTPA vector 2420 forms an angle with the negative d-axis that exceeds 45°, while the second MTPA vector 2425 forms an angle with the negative q-axis that does not exceed 45°. The graph 2400 also includes a maximum output power point 2430 that follows the periphery of the current limit 2405 towards the negative d-axis. This motion may be forced by the increasing speed that progressively shrinks the voltage limit 2410, preventing the machine from operating based on the MTPA algorithm, identified by a dashed line 2435.

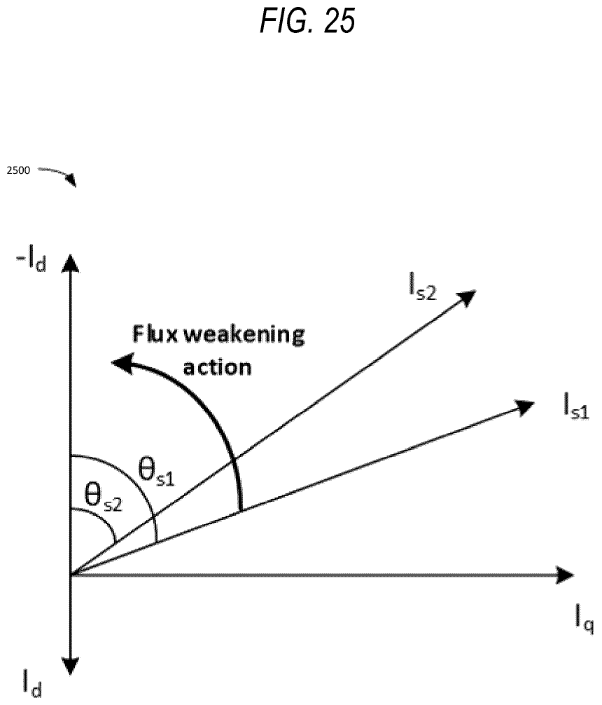

The maximum output power point 2430 for speeds above the corner point may be an optimistic outer limit for the current vector locus that can only be approached but never quite reached for an actual current regulated drive. This is true because the outer boundary of the voltage limit 2410 at any speed corresponds to six-step voltage operation, representing a condition in which current regulator loops are completely saturated. Since a current regulator loses control of phase currents under such conditions, the current vector command can be continually adjusted so that it always resides safely inside the voltage limit 2410. However, it is desirable to approach the voltage limit 2410 as closely as possible under heavy load conditions in order to deliver maximum power from the motor 1908, taking full advantage of the power supplied by the inverter 1948. Therefore, the angle between the commanded current vector and the negative d-axis is reduced as the shrinking voltage limit 2410 progressively intrudes on the current limit 2405 for speeds above the corner point. This can be controlled by an MTPV algorithm, explained below with respect to FIGS. 25-27.

FIG. 25 is a graph 2500 illustrating the results of a sensorless field weakening operation. Specifically, FIG. 25 illustrates how the angle, θs, between the commanded current vector, Is, is reduced as the shrinking voltage limit 2410 (see FIG. 24) progressively intrudes on the current limit 2405 for speeds above the corner point. This action illustrated in FIG. 25 forms the basis for implementing an MTPV control algorithm.

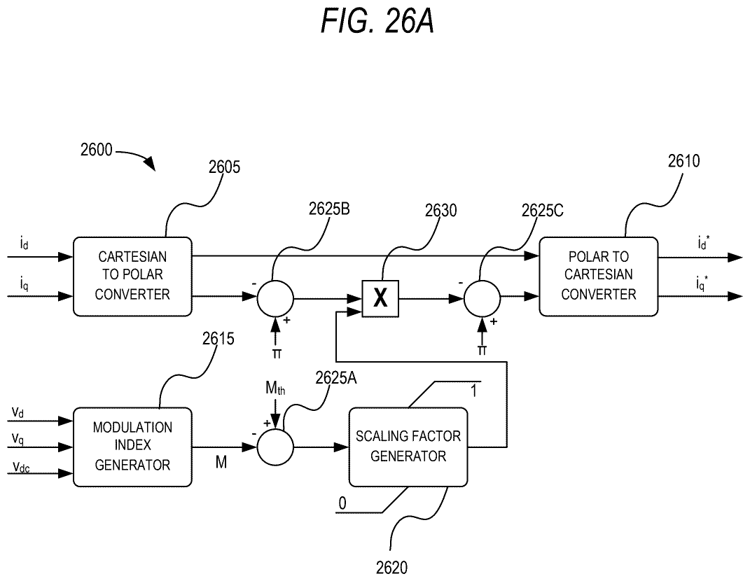

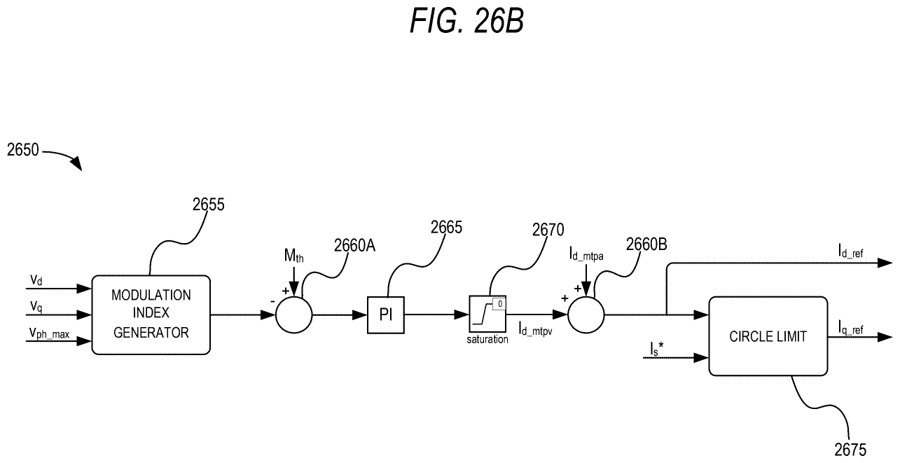

FIG. 26A is a block diagram of a control system 2600 for an MTPV algorithm, according to a first embodiment. The control system 2600 includes a cartesian-to-polar converter 2605 configured to receive a first signal corresponding to stator flux current i_{d} and a second signal corresponding to stator torque current i_{q}, and convert these signals from cartesian values to polar values. The cartesian-to-polar converter 2605 is configured to output a first signal corresponding to the polar i_{d} value and a second signal corresponding to the polar i_{q} value. The control system 2600 further includes a polar-to-cartesian converter 2610 configured to receive a first signal corresponding to the polar i_{d} value and a second signal corresponding to the polar i_{q} value. The polar i_{d} value may be received directly from the cartesian-to-polar converter 2605, while the polar i_{q} value may be received by an intervening control block.

The control system 2600 includes a modulation index generator 2615 configured to receive a first input signal v_{d} corresponding to a flux voltage, a second input signal v_{q} corresponding to a torque voltage, and a third input signal v_{dc} corresponding to a DC link voltage applied to the inverter 1948. The modulation index generator 2615 generates a PWM modulation index M based on the three input signals according to equation (8).

$$M = \frac{\sqrt{{( {v}_{d} )}^{2} + {( {v}_{d} )}^{2}}}{\frac{2}{π} {v}_{dc}} \qquad ( 8 )$$

The modulation index generator 2615 outputs the PWM modulation index M. The control system 2600 further includes a first addition/subtraction block 2625A configured to receive and add an Mth value, wherein the Mth value is a preset modulation threshold value. The first addition/subtraction block 2625A also receives and subtracts the PWM modulation index M from the modulation index generator 2615. The first addition/subtraction block 2625A is further configured to output a signal corresponding to a result of the first addition/subtraction block 2625A. The control system 2600 includes a scaling factor generator 2620 configured to generate and output a signal corresponding to a scaling factor β between 0 and 1 based on the received signal from the first addition/subtraction block 2625A. By generating a scaling factor of between 0 and 1, only the angle of the current vector Iₛ, and not its amplitude, is directly controlled by the MTPV algorithm. Therefore, by using a scaling factor β of 1, the current vector generated by the MTPA control system 2200 is not affected. Referring back to FIG. 19, by using a scaling factor β of 1, the MTPV block 1915 is effectively ignored while the field weakening controller 1905 calculates values for i_{d}* and i_{q}*.

The control system 2600 also includes a second addition/subtraction block 2625B configured to receive and add a first signal n corresponding to Pi and receive and subtract a second signal corresponding to the polar torque current i_{q} from the cartesian-to-polar converter 2605. The second addition/subtraction block 2625B is configured to output a signal corresponding to a result of the second addition/subtraction block 2625B. The control system 2600 further includes a multiplication block 2630 configured to receive a first signal β from the scaling factor generator 2620 corresponding to the generated scaling factor between 0 and 1, and a second signal from the second addition/subtraction block 2625B corresponding to a result of the second addition/subtraction block 2625B. The multiplication block 2630 is configured to output a signal corresponding to a product of the first signal and the second signal. The control system 2600 includes a third addition/subtraction block 2625C configured to receive and add a first signal π corresponding to Pi (e.g., Pi radians) and receive and subtract a second signal from the multiplication block 2630 corresponding to a result of the multiplication block 2630. The third addition/subtraction block 2625C is configured to output a signal corresponding to a result of the third addition/subtraction block 2625C. The polar-to-cartesian converter is configured to receive this signal from the third addition/subtraction block 2625C.

FIG. 26B is a block diagram of a control system 2650 for an MTPV algorithm, according to a second embodiment. The control system 2650 includes a modulation index generator 2655 configured to receive a first input signal v_{d} corresponding to a flux voltage, a second input signal V_{q} corresponding to a torque voltage, and a third input signal v_{ph_max} corresponding to a DC link voltage applied to the inverter 1948. The modulation index generator 2655 generates a PWM modulation index M based on the three input signals according to equation (9).

$$M = \frac{\sqrt{{( {v}_{d} )}^{2} + {( {v}_{d} )}^{2}}}{\frac{2}{π} {v}_{ph\_max}} \qquad ( 9 )$$

The modulation index generator 2655 outputs the PWM modulation index M. The control system 2650 further includes a first addition/subtraction block 2660A configured to receive and add an Mth value, wherein the Mth value is a preset modulation threshold value. The first addition/subtraction block 2660A also receives and subtracts the PWM modulation index M from the modulation index generator 2655. The first addition/subtraction block 2660A is further configured to output a signal corresponding to a result of the first addition/subtraction block 2660A. The control system 2650 includes a PI block 2665 configured to receive the signal from the first addition/subtraction block 2660A. The PI block 2665 is further configured to output a signal corresponding to a result of the PI block 2665. The signal output by the PI block 2665 is received by a saturation block 2670. The saturation block 2670 is configured to output a signal corresponding to a result of the saturation block 2670, which is a d-axis component of an MTPV current vector I_{d_mtpv}.

The control system 2650 further includes a second addition/subtraction block 2660B configured to receive and add I_{d_mtpv}, as well as receive and add a signal corresponding to a d-axis component of an MTPA current vector I_{d_mtpa}. I_{d_mtpa} may be received from an MTPA control block, such as MTPA block 2210 of FIG. 22. The second addition/subtraction block 2660B is further configured to output a signal corresponding to a result of the second addition/subtraction block 2660B. The signal output by the second addition/subtraction block 2660B is a d-axis component of a reference current vector I_{d_ref}. I_{d_ref} is an output signal provided by the control system 2650. I_{d_ref} is also received by a circle limit block 2675 of the control system 2650. The circle limit block 2675 is further configured to receive a current signal Iₛ*. The circle limit block 2675 is configured to output a signal corresponding to a result of the circle limit block 2675. The signal is a q-axis component of a reference current vector I_{q_ref}. I_{q_ref} is an output signal provided by the control system 2650.

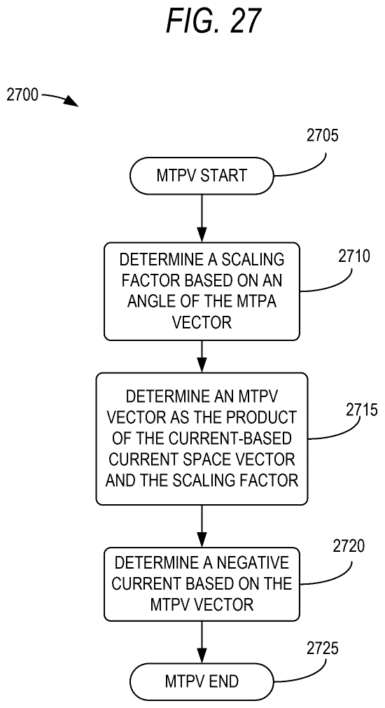

FIG. 27 is a flow chart of a method 2700 for implementing an MTPV algorithm. The method 2700 begins when a controller executing the method 2700 receives a command to begin the MTPV algorithm (BLOCK 2705). The method includes determining a scaling factor based on an angle of the MTPA vector output by the MTPA algorithm (for example, in BLOCK 2325 of FIG. 23) (BLOCK 2710). The scaling factor may be between 0 and 1. The method 2700 also includes determining an MTPV vector as the product of the MTPA vector and the scaling factor (BLOCK 2715). In some embodiments, the scaling factor is 1. In these embodiments, the MTPV vector is the same as the MTPA vector. The method 2700 also includes determining a negative current based on the MTPV vector (BLOCK 2720). The negative current may be the flux current component i_{d} of the MTPV vector, that is, i_{d}. Once the negative current has been identified, the MTPV algorithm has been completed and the method 2700 ends (BLOCK 2725).

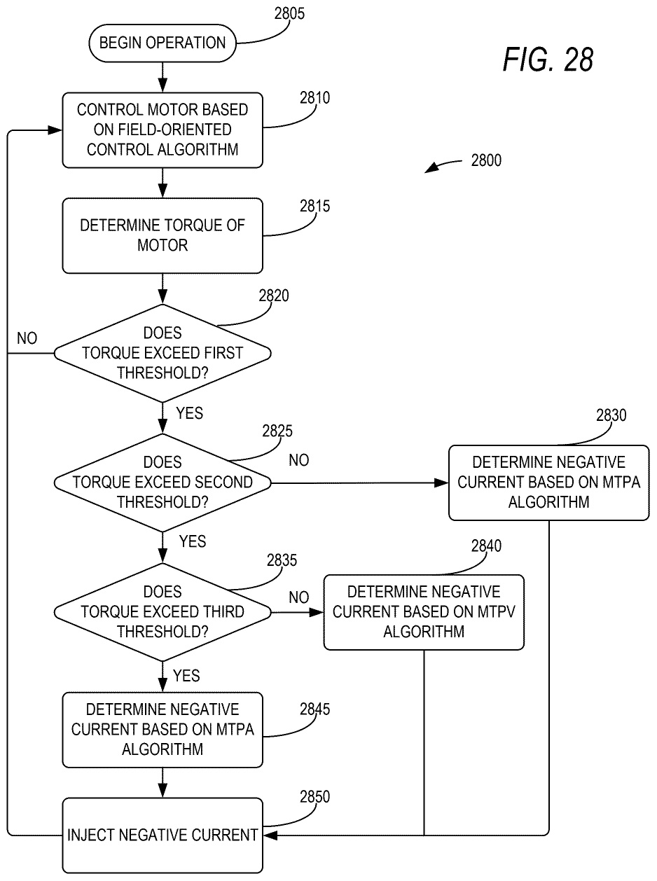

FIG. 28 is a flow chart of a method 2800 for implementing sensorless field weakening in the power tool 100 based on the above disclosures. The method 2800 begins when the power tool 10 begins operation (BLOCK 2805). In some embodiments, the power tool 100 may be capable of switching between field weakening and non-field weakening modes. The method 2800 includes controlling the motor 1908 of the power tool 100 based on a sensorless field-oriented control (“FOC”) algorithm (BLOCK 2810). The FOC algorithm may be implemented on the FOC controller 1935. The method 2800 then includes determining a torque of the motor 1908 (BLOCK 2815). The method 2800 may determine torque based on the torque observer 1950. The method 2800 then determines if the torque exceeds a first predetermined threshold (BLOCK 2820). In some embodiments, the first predetermined threshold is 0 Nm (i.e., sensorless field weakening is implemented whenever the sensorless motor is in an operating mode). If the torque does not exceed the first predetermined threshold, the method 2800 then returns to BLOCK 2810. In some embodiments, the method 2800 may include determining a parameter of the sensorless motor other than the torque in BLOCK 2815. For example, the method 2800 may instead determine a speed, a temperature, an operating time, or another parameter. In these embodiments, the first predetermined threshold (and other thresholds) may be based on the determined parameter. For example, in an embodiment in which motor speed is determined, the first predetermined threshold may be a speed threshold.

Returning to BLOCK 2820, if the method 2800 determines that the torque does exceed the first predetermined threshold, the method 2800 includes determining if the torque also exceeds a second predetermined threshold (BLOCK 2825). If the torque does not exceed the second predetermined threshold, the method 2800 includes determining a negative stator flux current based on a max-torque-per-amps (“MTPA”) algorithm, such as the algorithm described by FIG. 23 (BLOCK 2830). In some embodiments, the MTPA algorithm is applied in the same manner for the high power state 1305 and the low power state 1310. Returning to BLOCK 2825, if the method 2800 determines that the torque does exceed the second predetermined threshold, the method 2800 includes determining if the torque also exceeds a third torque threshold (BLOCK 2835). If the torque does not exceed the third predetermined threshold, the method 2800 includes determining a negative stator flux current based on a max-torque-per-volts (“MTPV”) algorithm, such as the algorithm described by FIG. 27 (BLOCK 2840). In some embodiments, the MTPV algorithm is applied in the same manner for the high power state 1305 and the low power state 1310. Returning to BLOCK 2835, if the method 2800 determines that the torque does exceed the third predetermined threshold, the method 2800 includes determining a negative stator flux current based on the MTPA algorithm, such as the algorithm described by FIG. 23 (BLOCK 2845). Following the determination of a negative stator flux current by any of BLOCKS 2830, 2840, or 2845, the method 2800 also includes injecting the negative stator flux current into the motor 308 to weaken a magnetic field generated by the rotor, therefore increasing the speed of the rotor (BLOCK 2850). It is important to note that the method 2800 requires significant processing power to complete the associated MPTA and MPTV algorithms. Conventional power tools (e.g., handheld power tools) lack the processing power required to implement the method 2800. However, the power tool 100 is capable of implementing the method 2800.

In some embodiments, the embodiment 1900, including the sensorless motor 1908, field weakening controller 1905, and FOC controller 1935, executes the method 1600 for implementing the high power state 1305 and the low power state 1310. In some embodiments, the high power state 1305 and the low power state 1310 are implemented according to the description above with regard to FIGS. 19-28. For example, the controller 200 determines if the hammer 175 is at the first position 1105 based on the output information from the one or more hammer position sensors 220, such as in BLOCK 1615 of method 1600. The controller 200 transmits a control signal to control the FETs 210 to drive the motor 1908 that begins moving the hammer 175 from the first position 1105 to the second position 1110, such as in BLOCK 1620. As the hammer 175 moves from the first position 1105 to the second position 1110, the FOC controller 1935 determines the position of the rotor of the motor 1908 based on a current determined by the MTPA algorithm 2300 of FIG. 23 or the MTPV algorithm 2700 of FIG. 27. The FOC controller 1935 also implements the high power state 1305 (e.g., a field-oriented control algorithm) by injecting a negative current to the motor 1908 as described with regard to FIG. 28, such as in BLOCK 1625. For example, the injected negative current is less than 0 Id. The controller 200 determines if the hammer 175 is at the second position 1110 based on the output information from the one or more hammer position sensors 220, such as in BLOCK 1630 of method 1600. If the hammer 175 is determined to be at the second position 1110 such as in BLOCK 1635, the FOC controller 1935 implements the low power state 1310 (e.g., a field-oriented control algorithm) as the hammer 175 advances to the first position 1105 from the second position 1110, such as in BLOCK 1640. For example, during the low power state 1310, the FOC controller 1935 transmits injects a negative current, that is different than the negative current injected during the high power state 1305, to the motor 308 as described with regard to FIG. 28. In some embodiments, the injected negative current during the low power state 1310 is −0 Id. In other embodiments, the injected negative current during the low power state 1310 is less than −0 Id. Once the low power state 1310 is implemented, the method 1600 returns to BLOCK 1615 in which the motor controller 1725 determines if the hammer 175 is at the first position 1105 based on the output information from the one or more hammer position sensors 220.

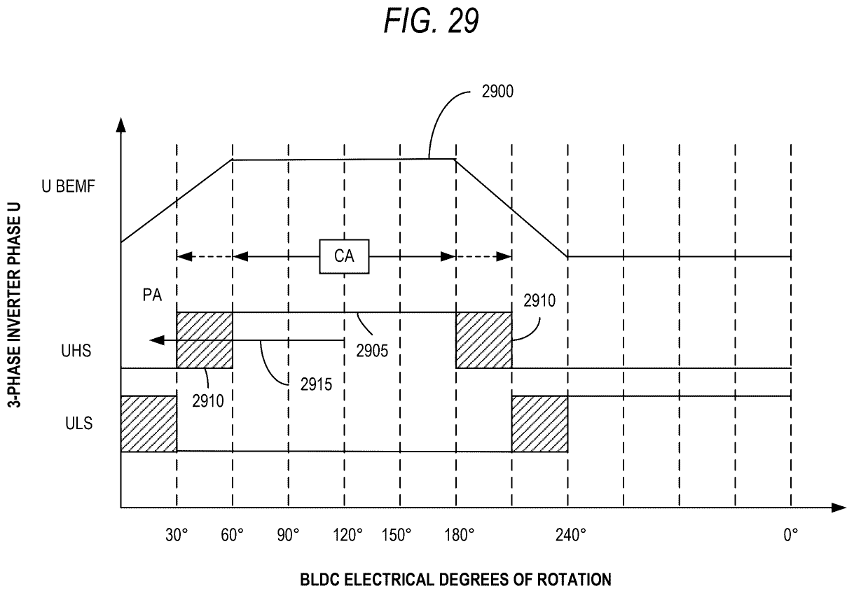

In still further examples, the conduction angle of the motor 105 may be varied to increase the conduction angle. Generally, a conduction angle applied to a BLDC motor (e.g., the motor 105) is approximately 120°. However, in order to increase speed, such as via field weakening, the conduction angle for a given phase may be increased up to a maximum value, such as 180°. As shown in FIG. 29, an example of commutation applied to a BLDC motor is shown. The back emf (“BEMF”) 2900 generally tracks with the conduction angle 2905. As shown in FIG. 29, the conduction angle may generally be 120° and applied to either a high side switch (such as high side FETs) or low side switches (such as low side FETs) as described above, in order to drive a motor, such as motor 105. As further shown in FIG. 29, the conduction angle 2905 may be increased (as shown by optional conduction regions 2910) from 120° to a maximum value, such as 180°. Further, as noted above, the conduction angle 2905 may be shifted to occur earlier in the conduction cycle (phase advance), as shown by phase advance line 2915.

In some embodiments, controller 200 executes the method 1600 for implementing a high power state 1305 and a low power state 1310 based on conduction angle control as described above with regard to FIG. 29. For example, the controller 200 determines if the hammer 175 is at the first position 1105 based on the output information from the one or more hammer position sensors 220, such as in BLOCK 1615 of method 1600. The controller 200 transmits a control signal to control the FETs 210 to drive the motor 105 that begins moving the hammer 175 from the first position 1105 to the second position 1110, such as in BLOCK 1620. As the hammer 175 moves from the first position 1105 to the second position 1110, the controller 200 determines the position of the rotor of the motor 105 based on the motor feedback information of the Hall effect sensors 215. The controller 200 also implements the high power state 1305 by transmitting a control signal to the FETs 210 to apply phase advance or increase the conduction angle of the motor 105 up to less than or equal to 180 degrees, for example, up to 175 degrees, such as in BLOCK 1625. The controller 200 determines if the hammer 175 is at the second position 1110 based on the output information from the one or more hammer position sensors 220, such as in BLOCK 1630 of method 1600. If the hammer 175 is determined to be at the second position 1110 such as in BLOCK 1635, the controller 200 implements the low power state 1310 as the hammer 175 advances to the first position 1105 from the second position 1110, such as in BLOCK 1640. For example, during the low power state 1310, the controller 200 transmits a control signal to the FETs 210 to return the conduction angle to a lower value. In some embodiments, the conduction angle of the motor 105 is changed to an angle of between 90 degrees and 120 degrees. Once the low power state 1310 is implemented, the method 1600 returns to BLOCK 1615 in which the controller 200 determines if the hammer 175 is at the first position 1105 based on the output information from the one or more hammer position sensors 220.

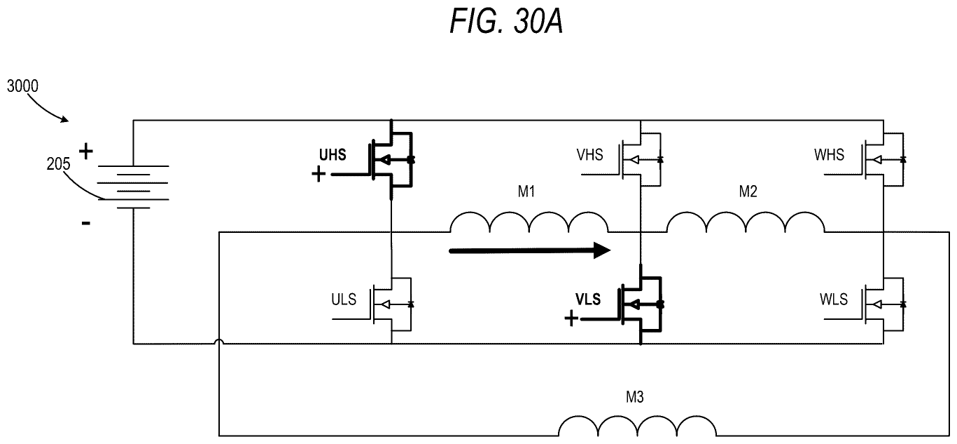

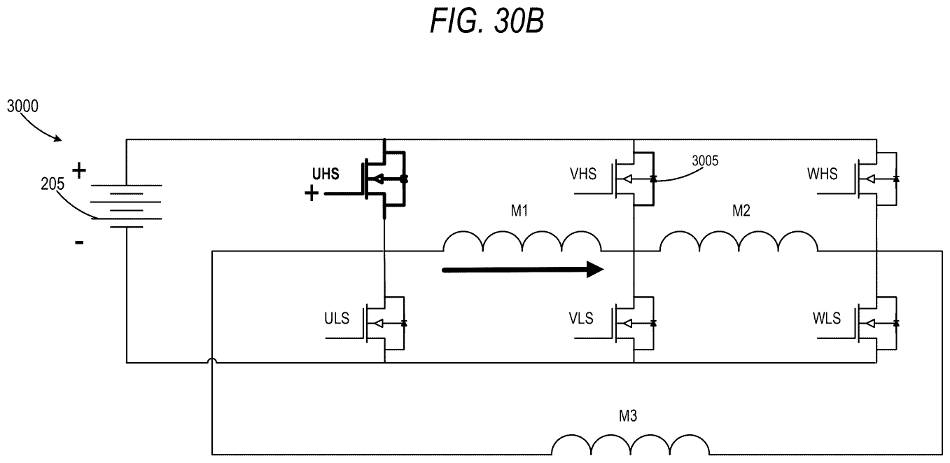

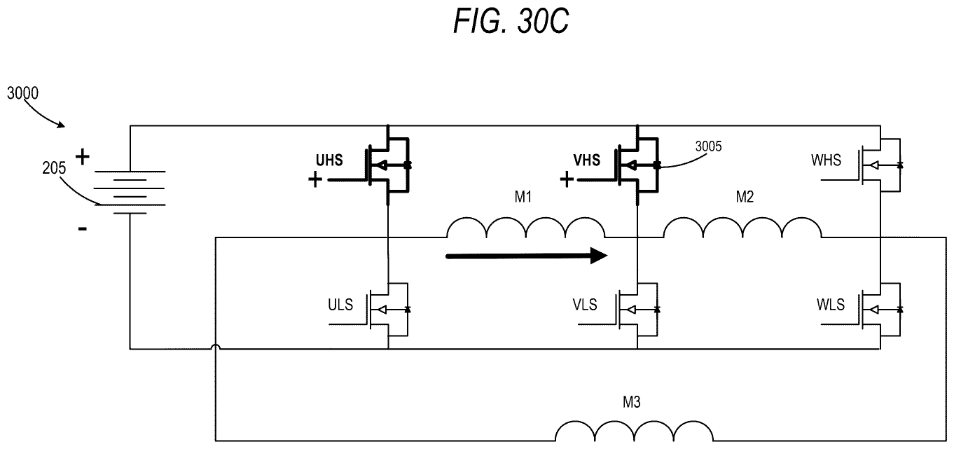

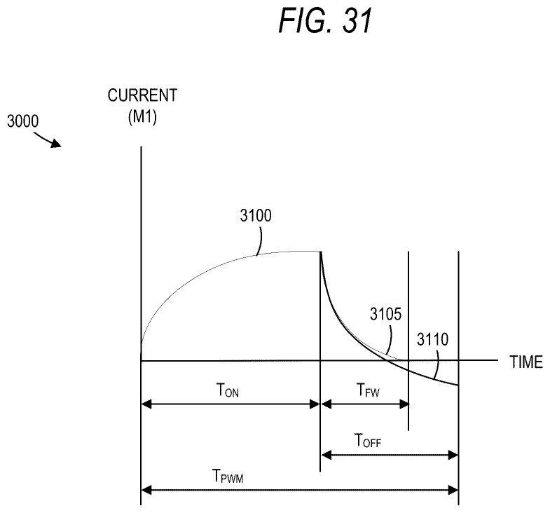

Additionally or alternatively to the field weakening techniques described above, the power tool 100 can also be controlled to implement, for example, synchronous rectification. FIGS. 30A-30C illustrate one example of the power switching network 3000 for powering the motor 105, and the operation of the power switching network 3000 during different portions of a PWM cycle. FIG. 31 illustrates motor current during the PWM cycle. The controller 200 controls the power switching network 3000 to power the motor 105.

As illustrated in FIG. 30A, the power switching network 3000 includes three high side FETs, UHS, VHS, WHS, and three low-side FETs, ULS, VLS, WLS each having a first conducting state and a second non-conducting state. The motor 105 has windings M1, M2, M3. The power switching network 3000 is used to selectively apply power from the power source 205 to the motor 105. The high-side switches and the low side switches may be controlled by the controller 200 using pulse-width modulated (“PWM”) commutation, centerline commutation, or other commutation schemes. In some embodiments, a PWM commutation sequence is used to control the motor 105 to rotate in a forward direction. Each of the high-side FETs UHS, VHS, WHS is periodically conducting during a commutation phase. When one of the FETs UHS, VHS, WHS stops conducting, the next high-side FET begins conducting. Similarly, each of the low-side FETs ULS, VLS, WLS is periodically conducting during the commutation phase. When one of the FETs ULS, VLS, WLS stops conducting, the next low-side FET begins conducting. However, one or both of the high-side or low-side FETs may be activated for only a period of the commutations phase (e.g., with a PWM signal having a 75%, 50%, 25%, or another duty ratio) based on the desired speed of the motor 105 or the load on the motor 105. To drive the motor 105 in a forward direction, the high-side and low-side FETs are activated in predetermined pairs and in a predetermined sequence. For example, UHS and VLS are first activated, followed by VHS and WLS, followed by WHS and ULS. This sequence is continued for the duration of the runtime of the motor 105 in the forward operation. To rotate in a reverse direction, UHS and WLS are first activated, followed by WHS and VLS, followed by VHS and ULS. This sequence is continued for the duration of the runtime of the motor 105 in the reverse operation. In some embodiments, one or more variations to the sequence can be performed based on the desired motor operation. For example, one or both of the high-side and low-side FETs may be switched at a frequency during their activation phase to control the speed of the motor. Additionally, the activation phases of the high-side and low-side FETs may be shifted to create an overlap with other activations to achieve different controls (e.g., field oriented control).

FIG. 30A illustrates the power switching network 3000 during a portion of PWM cycle where the winding M1 is being powered, represented by an interval, TON, in FIG. 31. The total PWM cycle is represented by an interval, TPWM, in FIG. 31 The FETs UHS and VLS are active, causing current to flow from the battery to the winding M1, as represented by the signal 3100 in FIG. 31. In the example of FIGS. 30A-30C, PWM is applied to the FET VLS control signal by enabling and disabling the VLS control signal at a particular duty cycle and frequency.

The controller 200 controls the power switching network 3000 using two different rectification modes, a freewheeling (“FW”) mode and a synchronous rectification (“SR”) mode. As described in greater detail below, the selected rectification mode depends on factors such as motor current, source current, PWM frequency, duty cycle, or the like. When the FET VLS is turned off, represented by an interval, TOFF, in FIG. 31, the motor current decays. The manner in which the current decays depends on the rectification mode.

FIG. 30B illustrates the configuration of the power switching network 3000 in the FW mode. As illustrated in FIG. 30B, the FET UHS remains enabled, and the FET VLS is turned off. The current decays during an interval, TFW, in FIG. 31, by flowing through a body diode 3005 of the FET VHS to create a current loop with the FET UHS. The body diode 3005 conducts the freewheeling current and switches off to block any discontinuous current once the diode becomes reverse biased, as represented by the signal 3105. The current decays as represented by the signal 3105. A voltage drop across the body diode 3005 causes power losses and heating during the decay.

FIG. 30C illustrates the configuration of the power switching network 3000 in the SR mode. Synchronous rectification is employed to reduce power losses and increase system efficiency during the TOFF interval. Since the ON resistance of the FET VHS is lower than the ON resistance of the body diode 3005, the power loss and heating can be reduced (compared to FIG. 30B) by enabling the FET VHS during the TOFF interval. As illustrated in FIG. 30C, the FET UHS remains enabled, the FET VLS is turned off, and the FET VHS is enabled. The current decays by flowing through the current loop defined by the FETs UHS, VHS. In some embodiments, synchronous rectification is applied to devices other than the exemplary embodiment power tool 100 (e.g., other hand-held or similar power tools).

However, an undesirable affect may be present when SR mode is applied under some operating conditions, such as when TOFF>TON. In some cases, the motor 105 has very low impedance-specifically, inductance. Due to this low inductance, switching currents in the motor 105 decay quickly. When SR mode is used, a quickly decaying phase current can become discontinuous. When this situation occurs, energy is removed from the back EMF of the motor 105, reversing the current in the winding and leading to lower motor efficiency and higher heating, as represented by the signal 3110 in FIG. 31. Note that the signal 3110 is undesirable, and, as described in greater detail below, the controller 200 controls the operating mode to avoid discontinuous operation.

The example of FIG. 30C involves applying the PWM signal to the FET VLS and enabling the FET VHS when the FET VLS is disabled in the PWM duty cycle. In some embodiments, the PWM signal is alternatively applied to the FET UHS while the FET VLS remains enabled, and the FET ULS is enabled when the FET VLS is disabled during the PWM duty cycle to provide synchronous rectification.

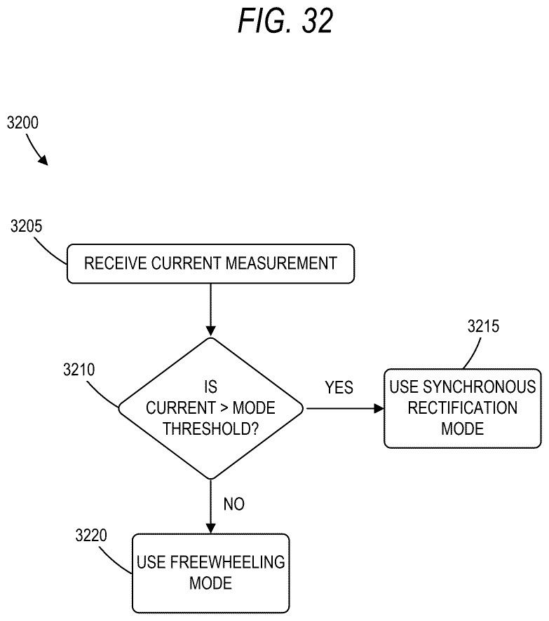

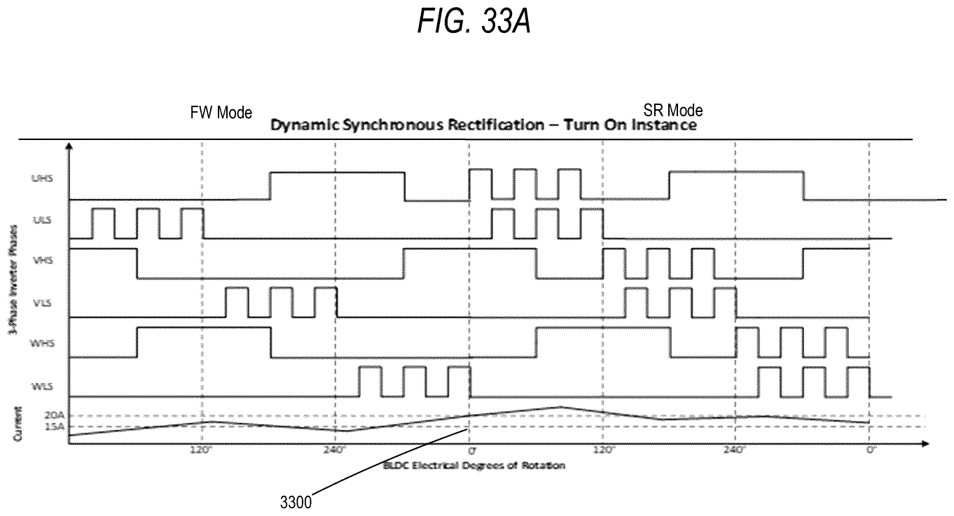

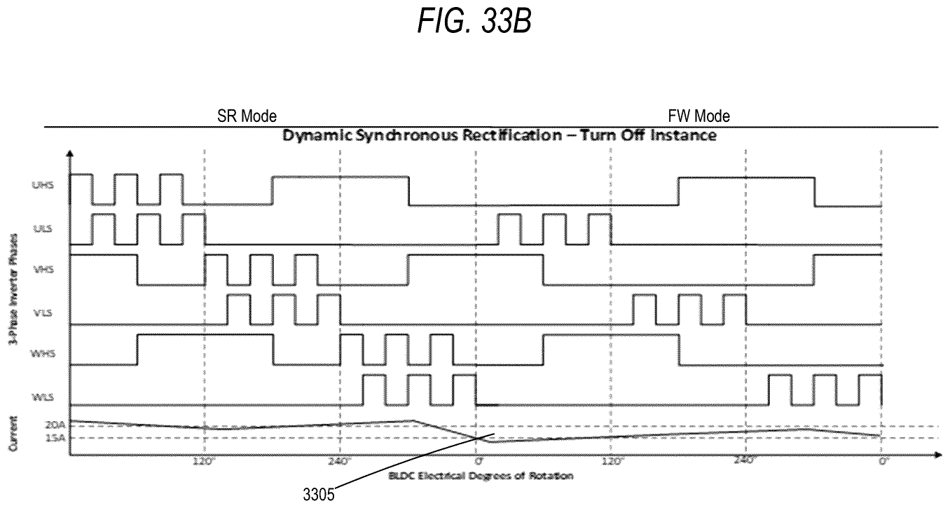

FIG. 32 is a flowchart of an example method 3200 for controlling the rectification mode of the motor 105 of the power tool 100 of FIG. 1. FIGS. 33A and 33B are timing diagrams illustrating rectification mode changes using the method 3200 of FIG. 32.

Referring to FIG. 32, the controller 200 receives a current measurement, as shown in block 3205. In some embodiments, the controller 200 controls the rectification mode based on the current measurement, such as motor current sensed by a motor current sensor or source current measured by a battery current sensor. In some embodiments, the motor current measurement is indirect. For example, motor torque or output torque measurement is an indirect measurement of motor current (e.g., an estimation of motor current).

As shown in block 3210, the controller 200 determines if the current is greater than a mode threshold. For a given motor 105, a current range may be empirically determined where discontinuous conduction occurs if SR mode is employed. The mode threshold is selected to be above a current range where discontinuous conduction occurs for the motor 105.

If the current is greater than the mode threshold in block 3210, the controller 200 employs synchronous rectification mode in block 3215. If the current is not greater than the mode threshold in block 3210, the controller 200 employs freewheeling mode in block 3220. The SR mode and FW mode intervals are labeled in FIGS. 33A and 33B. As seen in FIGS. 33A and 33B, in the SR mode, the FET VHS is turned on when the FET VLS is turned off to provide the active current decay described in FIG. 30C.

In some embodiments, a hysteresis band is employed to avoid oscillation of the rectification mode if the current is near the mode threshold. Accordingly, the mode threshold may be adjusted depending on the current rectification mode. For example, consider a nominal mode threshold of 15A. A 5A hysteresis band may be provided for mode changes. If the controller 200 is operating in FW mode and the current exceeds 20 A (the 15A nominal threshold plus the hysteresis band), the controller 200 changes to SR mode. As shown in FIG. 33A, the current exceeds 20 A at point 3300, and the controller 200 changes from FW mode to SR mode.

If the controller 200 is operating in SR mode and the current falls below the 15A nominal threshold, the controller 200 changes to FW mode. As shown in FIG. 33B, the current falls below 15 A at point 3305, and the controller 200 changes from SR mode to FW mode.

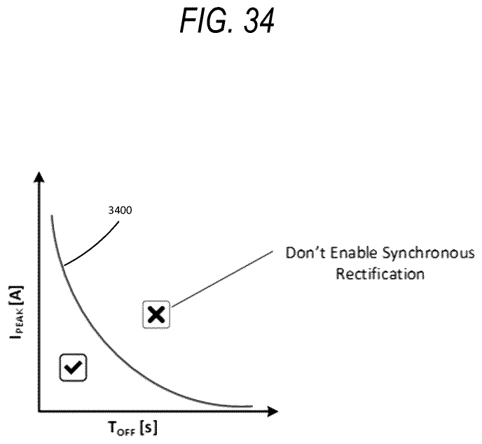

FIG. 34 is a diagram illustrating a rectification mode curve 3400 for implementing freewheeling and synchronous rectification modes. In some embodiments, other decision parameters may be included in addition to current. For example, the duty cycle and switching frequency of the PWM signal applied to the motor 105 may be used to calculate TOFF. The rectification curve 3400 may relate current as a function of TOFF to indicate the current for a given TOFF that results in discontinuous conduction. Thus, operation in SR mode in the region above the curve 3400 results in discontinuous conduction, while operation in SR mode in regions below the curve 3400 does not result in discontinuous conduction. The curve 3400 may be integrated into the processing in the method 3200 of FIG. 32, where the mode threshold is dynamically updated based on the operating parameters, such as duty cycle, switching frequency, and current. A hysteresis band may also be incorporated into the curve 3400 as described above to prevent oscillation.

In some embodiments, controller 200 executes the method 1600 for implementing a high power state 1305 and a low power state 1310 via the power switching network 3000 that also implements synchronous rectification, as described above with regard to FIGS. 30-34. For example, the controller 200 determines if the hammer 175 is at the first position 1105 based on the output information from the one or more hammer position sensors 220, such as in BLOCK 1615 of method 1600. The controller 200 transmits a control signal to control the FETs 210 to drive the motor 105 that begins moving the hammer 175 from the first position 1105 to the second position 1110, such as in BLOCK 1620. In some embodiments, the FETs 210 are the same as the three high side FETs, UHS, VHS, WHS and the three low-side FETs, ULS, VLS, WLS, as shown in FIGS. 30A-30C. As the hammer 175 moves from the first position 1105 to the second position 1110, the controller 200 determines the position of the rotor of the motor 105 based on the motor feedback information. The controller 200 also implements the high power state 1305 by applying a PWM signal to the FET VLS and enabling the FET VHS when the FET VLS is disabled in the PWM duty cycle. In some embodiments, the PWM signal is alternatively applied to the FET UHS while the FET VLS remains enabled, and the FET ULS is enabled when the FET VLS is disabled during the PWM duty cycle to provide synchronous rectification, such as in BLOCK 1625. In some embodiments, the operation of BLOCK 1625 is performed according to method 3200 as shown in FIG. 32, relative to the power switching circuit shown in FIG. 30C. The controller 200 determines if the hammer 175 is at the second position 1110 based on the output information from the one or more hammer position sensors 220, such as in BLOCK 1630 of method 1600. If the hammer 175 is determined to be at the second position 1110 such as in BLOCK 1635, the controller 200 implements the low power state 1310 as the hammer 175 advances to the first position 1105 from the second position 1110 such as in BLOCK 1640. For example, during the low power state 1310, the controller 200 applies a PWM signal to the power switching circuit 3000, as illustrated in FIG. 30B, the FET UHS remains enabled, and the FET VLS is turned off. The current decays during an interval, TFW, as shown in FIG. 31, by flowing through a body diode 3005 of the FET VHS to create a current loop with the FET UHS. The body diode 3005 conducts the freewheeling current and switches off to block any discontinuous current once the diode becomes reverse biased, as represented by the signal 3105. In some embodiments, the conduction angle of the motor 105 is changed to an angle less than 120 degrees. In other embodiments, the controller 200 implements a low power state 1310 similar to the high power state 1305 as described relative to BLOCK 1625. However, in the low power state 1305, the conduction angle generated by enabling the FET VHS when the FET VLS is disabled in the PWM duty cycle is less than 120 degrees. Once the low power state 1310 is implemented, the method 1600 returns to BLOCK 1615 in which the controller 200 determines if the hammer 175 is at the first position 1105 based on the output information from the one or more hammer position sensors 220.

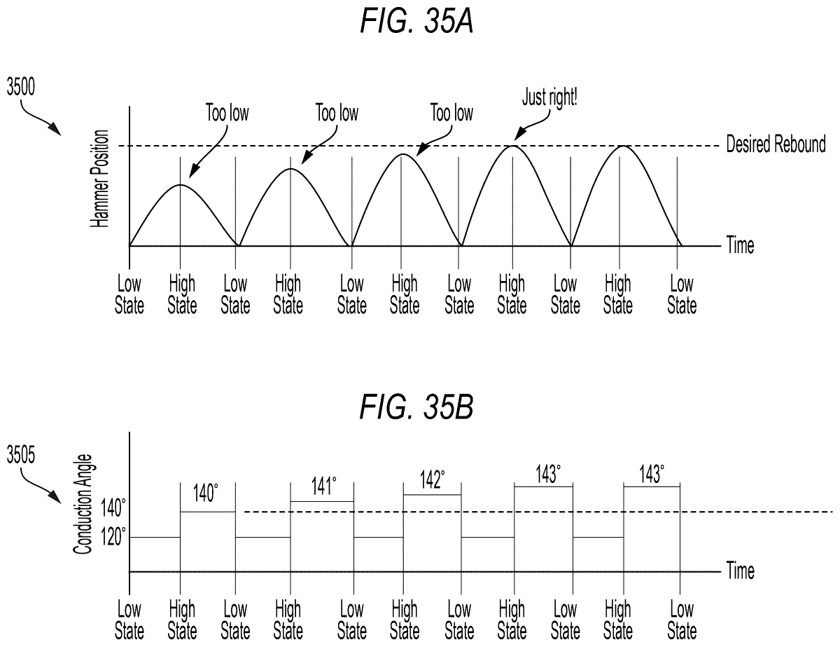

In some embodiments, the high power state 1305 and/or the low power state 1310 are varied based on characteristics of the impact mechanism 165 during an impact event to adjust, for example, the average power supplied to the hammer 175. As illustrated in FIGS. 35A and 35B, the high power state 1305 is varied with respect to a hammer rebound threshold by changing the conduction angle of the motor 105 following subsequent impact events. FIG. 35A illustrates graph 3500 of a relationship between a position of the hammer 175 (e.g., a rebound position of the hammer 175) over time and the hammer rebound threshold, during the high power state 1305 and the low power state 1310. In some instances, the hammer rebound threshold is a distance from the second position 1110 that the hammer 175 rebounds after disengaging the anvil 170 to facilitate an optimal subsequent impact event. For example, the hammer rebound threshold is the first position 1105 prior to an initial impact event. FIG. 35B illustrates a graph 3505 of the conduction angle of the motor 105 over time corresponding to the rebound position of the hammer 175, during the high power state 1305 and the low power state 1310.

As illustrated by FIGS. 35A and 35B, by increasing the conduction angle (e.g., via the controller 200) of the motor 105 following subsequent impact events, the high power state 1305 is controlled to increase the rebound position of the hammer 175 and increase the average power supplied to the hammer 175 by the motor 105. In some embodiments, the motor 105 operates at a first conduction angle (e.g., 120 degrees) during the low power state 1310, and operates at a second conduction angle (e.g., 140 degrees) during the high power state 1305. With reference to FIG. 16, the method 1600 varies the high power state 1305 as illustrated in FIGS. 35A and 35B. For example, the controller 200 determines the position of the hammer 175 based on the output information from the one or more hammer position sensors 220, such as in BLOCK 1610 following the controller 200 applying the first conduction angle to the motor 105 during the low power state 1310. The controller 200 then determines if the hammer 175 is at the hammer rebound threshold (e.g., first position 1105) based on the output information from the one or more hammer position sensors 220, such as in BLOCK 1615. If the controller 200 determines that the hammer 175 rebounds to a distance less than the hammer rebound threshold (FIG. 35A), the controller 200 increases the second conduction angle (e.g., to 141 degrees or another conduction angle value to reach the hammer rebound threshold) as illustrated in FIG. 35B, and proceeds to BLOCK 1620.

Moving ahead to BLOCK 1625, the controller 200 applies the high power state 1305 at the increased second conduction angle and proceeds through BLOCKS 1630-1640. Once the low power state 1310 has been applied at BLOCK 1640 and the method 1600 returns to BLOCK 1610 the controller 200 again determines the position of the hammer 175 based on the output information from the one or more hammer position sensors 220. The controller 200 again determines if the hammer 175 is at the hammer rebound threshold (e.g., first position 1105) based on the output information from the one or more hammer position sensors 220, such as in BLOCK 1615. If the controller 200 determines again that the hammer 175 rebounds to a distance less than the hammer rebound threshold, the controller 200 increases the second conduction angle again (e.g., to 142 degrees or another conduction angle value to reach the hammer rebound threshold) and proceeds to BLOCK 1620. In some embodiments, the controller 200 continues to increase the second conduction angle until the hammer 175 rebounds to the hammer rebound threshold. Although described herein with respect to the method 1600, in other embodiments, the high power state 1305 and the low power state 1310 are implemented according to the description above with regard to FIGS. 19-28, FIG. 29, FIGS. 30A-34, or any other methods of the description.

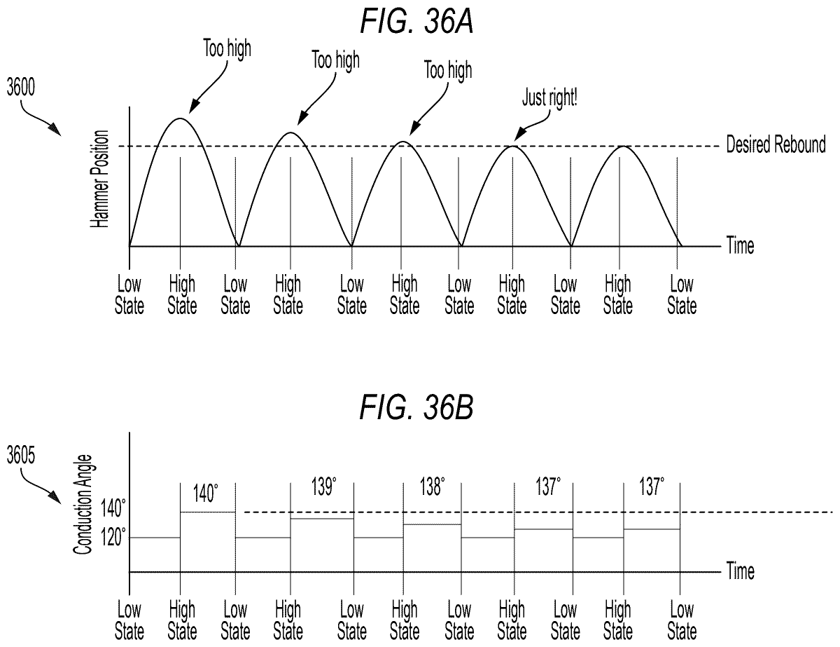

As illustrated in FIGS. 36A and 36B, the high power state 1305 is varied with respect to a hammer rebound threshold by changing the conduction angle of the motor 105 following subsequent impact events to adjust the average power supplied to the hammer 175. FIG. 36A illustrates graph 3600 of a relationship between the position of the hammer 175 (e.g., the rebound position of the hammer 175) over time and the hammer rebound threshold, during the high power state 1305 and the low power state 1310. FIG. 36B illustrates a graph 3605 of the conduction angle of the motor 105 over time corresponding to the rebound position of the hammer 175 during the high power state 1305 and the low power state 1310.

As illustrated by FIGS. 36A and 36B, by decreasing the conduction angle (e.g., via the controller 200) of the motor 105 following subsequent impact events, the high power state 1305 is varied to decrease the rebound position of the hammer 175. As described above with respect to FIGS. 35A and 35B, the motor 105 operates at the first conduction angle (e.g., 120 degrees) during the low power state 1310, and operates at the second conduction angle (e.g., 140 degrees) during the high power state 1305. With reference to FIG. 16, the method 1600 varies the high power state 1305 as illustrated in FIGS. 36A and 36B. For example, the controller 200 determines the position of the hammer 175 based on the output information from the one or more hammer position sensors 220, such as in BLOCK 1610 following the controller 200 applying the first conduction angle to the motor 105 during the low power state 1310. The controller 200 then determines if the hammer 175 is at the hammer rebound threshold (e.g., first position 1105) based on the output information from the one or more hammer position sensors 220, such as in BLOCK 1615. If the controller 200 determines that the hammer 175 rebounds to a distance greater than the hammer rebound threshold (FIG. 36A), the controller 200 decreases the second conduction angle (e.g., to 139 degrees or another conduction angle value to reach the hammer rebound threshold) as illustrated in FIG. 36B to decrease the average power supplied to the hammer 175, and proceeds to BLOCK 1620.

Moving ahead to BLOCK 1625, the controller 200 applies the high power state 1305 at the decreased second conduction angle and proceeds through BLOCKS 1630-1640. Once the low power state 1310 has been applied at BLOCK 1640 and the method 1600 returns to BLOCK 1610 the controller 200 again determines the position of the hammer 175 based on the output information from the one or more hammer position sensors 220. The controller 200 again determines if the hammer 175 is at the hammer rebound threshold (e.g., first position 1105) based on the output information from the one or more hammer position sensors 220, such as in BLOCK 1615. If the controller 200 determines again that the hammer 175 rebounds to a distance greater than the hammer rebound threshold, the controller 200 decreases the second conduction angle again (e.g., to 138 degrees or another conduction angle value to reach the hammer rebound threshold) to further decrease the average power supplied to the hammer 175, and proceeds to BLOCK 1620. In some embodiments, the controller 200 continues to decrease the second conduction angle until the hammer 175 rebounds to the hammer rebound threshold. Although described herein with respect to the method 1600, in other embodiments, the high power state 1305 and the low power state 1310 are implemented according to the description above with regard to FIGS. 19-28, FIG. 29, FIGS. 30A-34, or any other methods of the description.

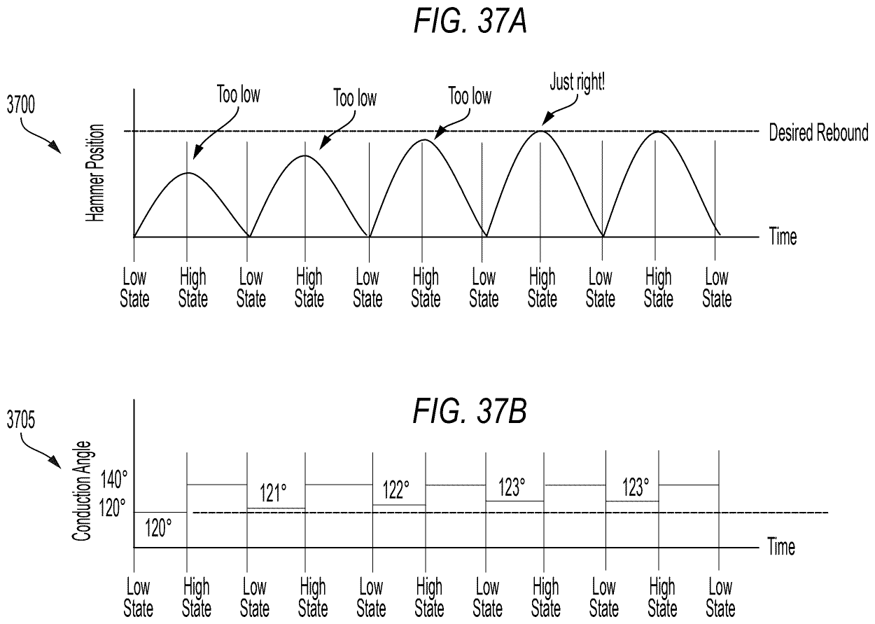

As illustrated in FIGS. 37A and 37B, the low power state 1320 is varied with respect to the hammer rebound threshold by changing the conduction angle of the motor 105 following subsequent impact events to adjust the average power supplied to the hammer 175. FIG. 37A illustrates graph 3700 of a relationship between the position of the hammer 175 over time and the hammer rebound threshold, during the high power state 1305 and the low power state 1310. FIG. 37B illustrates a graph 3705 of the conduction angle of the motor 105 over time corresponding to the rebound position of the hammer 175, during the high power state 1305 and the low power state 1310.

As illustrated by FIGS. 37A and 37B, by increasing the conduction angle (e.g., via the controller 200) of the motor 105 following subsequent impact events, the low power state 1310 is controlled to increase the rebound position of the hammer 175 and the average power supplied to the hammer 175. As described above with respect to FIGS. 35A and 35B, the motor 105 operates at the first conduction angle (e.g., 120 degrees) during the low power state 1310, and operates at the second conduction angle (e.g., 140 degrees) during the high power state 1305. With reference to FIG. 16, the method 1600 varies the low power state 1310 as illustrated in FIGS. 37A and 37B. For example, the controller 200 determines the position of the hammer 175 based on the output information from the one or more hammer position sensors 220, such as in BLOCK 1610 following the controller 200 applying the first conduction angle to the motor 105 during the low power state 1310. The controller 200 then determines if the hammer 175 is at the hammer rebound threshold (e.g., first position 1105) based on the output information from the one or more hammer position sensors 220, such as in BLOCK 1615. If the controller 200 determines that the hammer 175 rebounds to a distance less than the hammer rebound threshold (FIG. 37A), the controller 200 increases the first conduction angle (e.g., to 121 degrees or another conduction angle value to reach the hammer rebound threshold) as illustrated in FIG. 37B to increase the average power supplied to the hammer 175 during a subsequent impact event, and proceeds to BLOCK 1620.

Moving ahead to BLOCK 1625, the controller 200 applies the high power state 1305 at the second conduction angle and proceeds through BLOCKS 1630-1640. Once the low power state 1310 has been applied with the increased first conduction angle at BLOCK 1640 and the method 1600 returns to BLOCK 1610, the controller 200 again determines the position of the hammer 175 based on the output information from the one or more hammer position sensors 220. The controller 200 again determines if the hammer 175 is at the hammer rebound threshold (e.g., first position 1105) based on the output information from the one or more hammer position sensors 220, such as in BLOCK 1615. If the controller 200 determines again that the hammer 175 rebounds to a distance less than the hammer rebound threshold, the controller 200 increases the first conduction angle again (e.g., to 122 degrees or another conduction angle value to reach the hammer rebound threshold) to further increase the average power supplied to the hammer 175, and proceeds to BLOCK 1620. In some embodiments, the controller 200 continues to increase the first conduction angle until the hammer 175 rebounds to the hammer rebound threshold and the motor 105 supplies a sufficient average power to the hammer 175. Although described herein with respect to the method 1600, in other embodiments, the high power state 1305 and the low power state 1310 are implemented according to the description above with regard to FIGS. 19-28, FIG. 29, FIGS. 30A-34, or any other methods of the description.

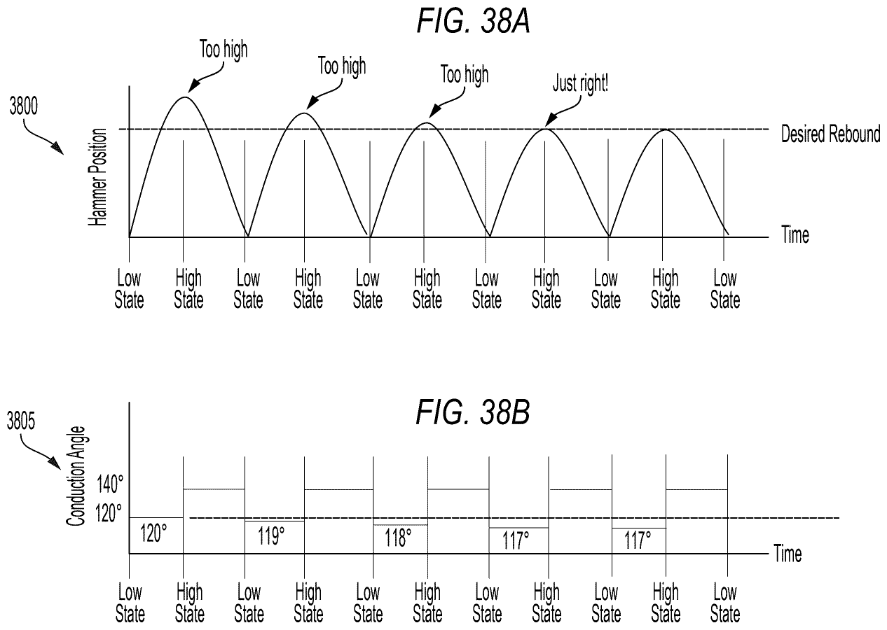

As illustrated in FIGS. 38A and 38B, the low power state 1310 is varied with respect to a hammer rebound threshold by changing the conduction angle of the motor 105 following subsequent impact events to adjust the average power supplied to the hammer 175. FIG. 38A illustrates graph 3800 of a relationship between the position of the hammer 175 (e.g., the rebound position of the hammer 175) over time and the hammer rebound threshold, during the high power state 1305 and the low power state 1310. FIG. 38B illustrates a graph 3805 of the conduction angle of the motor 105 over time corresponding to the rebound position of the hammer 175 during the high power state 1305 and the low power state 1310.

As illustrated by FIGS. 38A and 38B, by decreasing the conduction angle (e.g., via the controller 200) of the motor 105 following subsequent impact events, the low power state 1310 is varied to decrease the rebound position of the hammer 175. As described above with respect to FIGS. 35A and 35B, the motor 105 operates at the first conduction angle (e.g., 120 degrees) during the low power state 1310, and operates at the second conduction angle (e.g., 140 degrees) during the high power state 1305. With reference to FIG. 16, the method 1600 varies the low power state 1310 as illustrated in FIGS. 38A and 38B. For example, the controller 200 determines the position of the hammer 175 based on the output information from the one or more hammer position sensors 220, such as in BLOCK 1610 following the controller 200 applying the first conduction angle to the motor 105 during the low power state 1310. The controller 200 then determines if the hammer 175 is at the hammer rebound threshold (e.g., first position 1105) based on the output information from the one or more hammer position sensors 220, such as in BLOCK 1615. If the controller 200 determines that the hammer 175 rebounds to a distance greater than the hammer rebound threshold (FIG. 38A), the controller 200 decreases the first conduction angle (e.g., to 119 degrees or another conduction angle value to reach the hammer rebound threshold) as illustrated in FIG. 38B to decrease the average power supplied to the hammer 175, and proceeds to BLOCK 1620.

Moving ahead to BLOCK 1625, the controller 200 applies the high power state 1305 at the second conduction angle and proceeds through BLOCKS 1630-1640. Once the low power state 1310 has been applied with the decreased first conduction angle at BLOCK 1640 and the method 1600 returns to BLOCK 1610, the controller 200 again determines the position of the hammer 175 based on the output information from the one or more hammer position sensors 220. The controller 200 again determines if the hammer 175 is at the hammer rebound threshold (e.g., first position 1105) based on the output information from the one or more hammer position sensors 220, such as in BLOCK 1615. If the controller 200 determines again that the hammer 175 rebounds to a distance greater than the hammer rebound threshold, the controller 200 decreases the first conduction angle again (e.g., to 118 degrees or another conduction angle value to reach the hammer rebound threshold) to further decrease the average power supplied to the hammer 175, and proceeds to BLOCK 1620. In some embodiments, the controller 200 continues to decrease the first conduction angle until the hammer 175 rebounds to the hammer rebound threshold and the motor 105 supplies a sufficient average power to the hammer 175. Although described herein with respect to the method 1600, in other embodiments, the high power state 1305 and the low power state 1310 are implemented according to the description above with regard to FIGS. 19-28, FIG. 29, FIGS. 30A-34, or any other methods of the description.

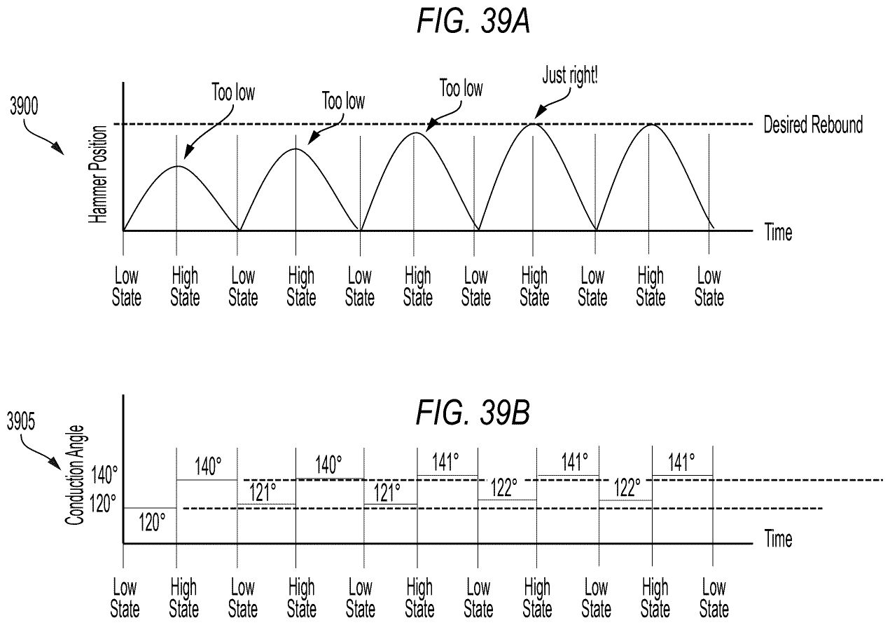

As illustrated in FIGS. 39A and 39B, the high power state 1305 and the low power state 1320 are varied with respect to a hammer rebound threshold by changing the conduction angle of the motor 105 following subsequent impact events to adjust the average power supplied to the hammer 175. FIG. 39A illustrates graph 3900 of a relationship between a position of the hammer 175 (e.g., the rebound position of the hammer 175) over time and the hammer rebound threshold, during the high power state 1305 and the low power state 1310. FIG. 39B illustrates a graph 3905 of the conduction angle of the motor 105 over time corresponding to the rebound position of the hammer 175, during the high power state 1305 and the low power state 1310.

As illustrated by FIGS. 39A and 39B, by increasing the conduction angle (e.g., via the controller 200) of the motor 105 following subsequent impact events, the high power state 1305 and the low power state 1310 are controlled to increase the rebound position of the hammer 175 and increase the average power supplied to the hammer 175 by the motor 105. As described above with respect to FIGS. 35A and 35B, the motor 105 operates at the first conduction angle (e.g., 120 degrees) during the low power state 1310, and operates at the second conduction angle (e.g., 140 degrees) during the high power state 1305. With reference to FIG. 16, the method 1600 varies the high power state 1305 and the low power state 1310 as illustrated in FIGS. 39A and 39B. For example, the controller 200 determines the position of the hammer 175 based on the output information from the one or more hammer position sensors 220, such as in BLOCK 1610 following the controller 200 applying the first conduction angle to the motor 105 during the low power state 1310. The controller 200 then determines if the hammer 175 is at the hammer rebound threshold (e.g., first position 1105) based on the output information from the one or more hammer position sensors 220, such as in BLOCK 1615. If the controller 200 determines that the hammer 175 rebounds to a distance less than the hammer rebound threshold (FIG. 39A), the controller 200 increases the first conduction angle (e.g., to 121 degrees or another conduction angle value to reach the hammer rebound threshold) and/or the second conduction angle (e.g., to 141 degrees or another conduction angle value to reach the hammer rebound threshold) as illustrated in FIG. 39B to increase the average power supplied to the hammer 175, and proceeds to BLOCK 1620.

Moving ahead to BLOCK 1625, the controller 200 applies the high power state 1305 and the low power state 1310 at the increased conduction angle and proceeds through BLOCKS 1630-1640. Once the high power state 1305 and the low power state 1310 have been applied with the increased conduction angles at BLOCK 1640 and the method 1600 returns to BLOCK 1610, the controller 200 again determines the position of the hammer 175 based on the output information from the one or more hammer position sensors 220. The controller 200 again determines if the hammer 175 is at the hammer rebound threshold (e.g., first position 1105) based on the output information from the one or more hammer position sensors 220, such as in BLOCK 1615. If the controller 200 determines again that the hammer 175 rebounds to a distance less than the hammer rebound threshold, the controller 200 increases the first conduction angle (e.g., to 122 degrees or another conduction angle value to reach the hammer rebound threshold) and/or the second conduction angle (e.g., to 142 degrees or another conduction angle value to reach the hammer rebound threshold) to further increase the average power supplied to the hammer 175, and proceeds to BLOCK 1620. In some embodiments, the controller 200 continues to increase the first conduction angle and/or the second conduction angle until the hammer 175 rebounds to the hammer rebound threshold. Although described herein with respect to the method 1600, in other embodiments, the high power state 1305 and the low power state 1310 are implemented according to the description above with regard to FIGS. 19-28, FIG. 29, FIGS. 30A-34, or any other methods of the description.

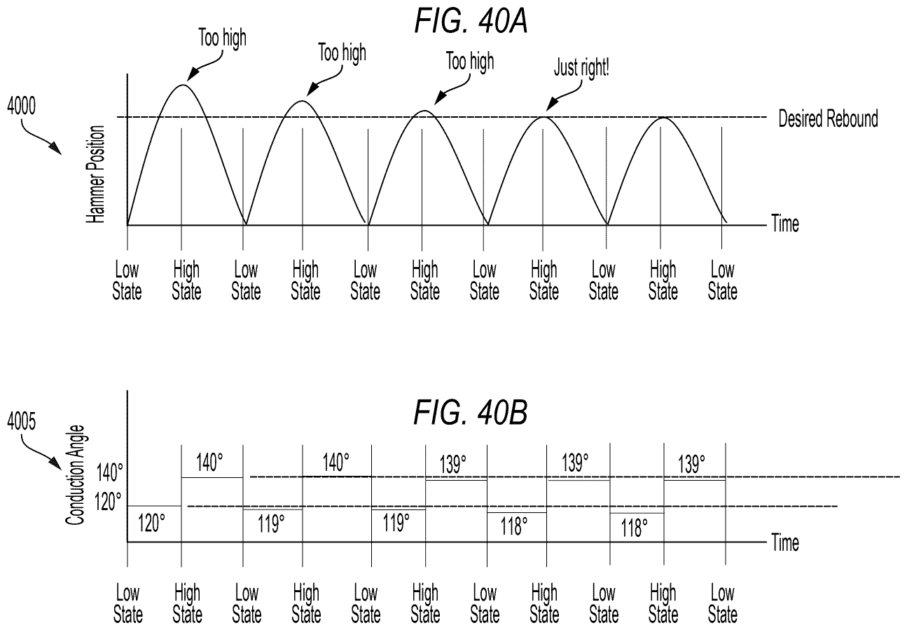

As illustrated in FIGS. 40A and 40B, the high power state 1305 and the low power state 1310 are varied with respect to a hammer rebound threshold by changing the conduction angle of the motor 105 following subsequent impact events to adjust the average power supplied to the hammer 175. FIG. 40A illustrates graph 4000 of a relationship between the position of the hammer 175 (e.g., the rebound position of the hammer 175) over time and the hammer rebound threshold, during the high power state 1305 and the low power state 1310. FIG. 40B illustrates a graph 4005 of the conduction angle of the motor 105 over time corresponding to the rebound position of the hammer 175 during the high power state 1305 and the low power state 1310.

As illustrated by FIGS. 40A and 40B, by decreasing the conduction angle (e.g., via the controller 200) of the motor 105 following subsequent impact events, the high power state 1305 and the low power state 1310 are varied to decrease the rebound position of the hammer 175. As described above with respect to FIGS. 35A and 35B, the motor 105 operates at the first conduction angle (e.g., 120 degrees) during the low power state 1310, and operates at the second conduction angle (e.g., 140 degrees) during the high power state 1305. With reference to FIG. 16, the method 1600 varies the high power state 1305 and the low power state 1310 as illustrated in FIGS. 40A and 40B. For example, the controller 200 determines the position of the hammer 175 based on the output information from the one or more hammer position sensors 220, such as in BLOCK 1610 following the controller 200 applying the first conduction angle to the motor 105 during the low power state 1310. The controller 200 then determines if the hammer 175 is at the hammer rebound threshold (e.g., first position 1105) based on the output information from the one or more hammer position sensors 220, such as in BLOCK 1615. If the controller 200 determines that the hammer 175 rebounds to a distance greater than the hammer rebound threshold (FIG. 40A), the controller 200 decreases the first conduction angle (e.g., to 119 degrees or another conduction angle value to reach the hammer rebound threshold) and/or the second conduction angle (e.g., to 139 degrees or another conduction angle value to reach the hammer rebound threshold) as illustrated in FIG. 40B to decrease the average power supplied to the hammer 175, and proceeds to BLOCK 1620.

Moving ahead to BLOCK 1625, the controller 200 applies the high power state 1305 at the second conduction angle and proceeds through BLOCKS 1630-1640. Once the high power state 1305 and the low power state 1310 have been applied with the decreased conduction angle at BLOCK 1640 and the method 1600 returns to BLOCK 1610 the controller 200 again determines the position of the hammer 175 based on the output information from the one or more hammer position sensors 220. The controller 200 again determines if the hammer 175 is at the hammer rebound threshold (e.g., first position 1105) based on the output information from the one or more hammer position sensors 220, such as in BLOCK 1615. If the controller 200 determines again that the hammer 175 rebounds to a distance greater than the hammer rebound threshold, the controller 200 decreases the first conduction angle (e.g., to 118 degrees or another conduction angle value to reach the hammer rebound threshold) and/or the second conduction angle (e.g., to 138 degrees or another conduction angle value to reach the hammer rebound threshold) to further decrease the average power supplied to the hammer 175, and proceeds to BLOCK 1620. In some embodiments, the controller 200 continues to decrease the first conduction angle and the second conduction angle until the hammer 175 rebounds to the hammer rebound threshold. Although described herein with respect to the method 1600, in other embodiments, the high power state 1305 and the low power state 1310 are implemented according to the description above with regard to FIGS. 19-28, FIG. 29, FIGS. 30A-34, or any other methods of the description.

In addition, other parameters of the motor 105 can additionally or alternatively be used to adjust the average power supplied to the hammer 175 during an impact event as described above with regard to FIGS. 35A-40B. For example, in some embodiments, the controller 200 increases a phase advance angle applied to the motor 105 to increase the average power supplied to the hammer 175 according to the description above with regard to FIG. 13, FIGS. 18A-18B, FIGS. 35A-35B, FIGS. 37A-37B, FIGS. 39A-39B, or any other methods of the description. Likewise, the controller 200 decreases the phase advance angle applied to the motor 105 to decrease the average power supplied to the hammer 175 according to the description above with regard to FIG. 13, FIGS. 18A-18B, FIGS. 36A-36B, FIG. 38A-38B, FIG. 40A-40B, or any other methods of the description. In some embodiments, the controller 200 increases or decreases a duty cycle of a PWM signal supplied to the motor 105 to increase or decrease, respectively, the average power supplied to the hammer 175 according to the description above with regard to FIG. 13, FIGS. 30A-34, FIGS. 35A-40B, or any other methods of the description. In some embodiments, the controller 200 (or the FOC controller 1935) increases or decreases a torque current i_{q} supplied to the motor to increase or decrease, respectively, the average power supplied to the hammer 175 according to the description above with regard to FIGS. 19-28 and FIGS. 35A-40B, or any other methods of the description. Similarly, in other embodiments, the controller 200 (or the FOC controller 1935) increases or decreases a flux current −i_{d} supplied to the motor to increase or decrease, respectively, the average power supplied to the hammer 175 according to the description above with regard to FIGS. 19-28 and FIGS. 35A-40B, or any other methods of the description.

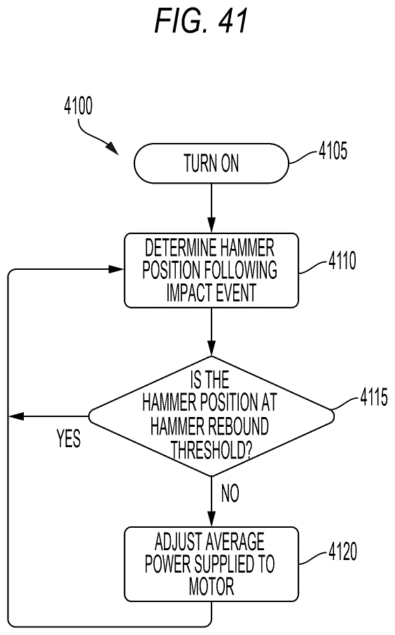

Additionally or alternatively to the method 1600 described above in regard to FIG. 16, FIG. 41 is a flowchart of a method 4100 for adjusting the average power supplied to the motor 105 during implementation of the high power state 1305 and the low power state 1310. The method 4100 begins with the power on of the power tool 100 and the controller 200 (BLOCK 4105). The method 4100 includes the controller 200 determining the position of the hammer 175 based on the output information from the one or more hammer position sensors 220 following an impact event (e.g., after the hammer 175 disengages the anvil 170 and moves toward the first position 1105) (BLOCK 4110). The method 4100 also includes the controller determining whether the position of the hammer 175 is at the hammer rebound threshold (BLOCK 4115). If the position of the hammer 175 is determined to be at the hammer rebound threshold, the method 4100 returns to BLOCK 4110.

If the position of the hammer 175 is not determined to be at the hammer rebound threshold (e.g., the position of the hammer 175 is greater than or less than the hammer rebound threshold), the controller 200 adjusts the average power supplied to the motor 105 (and ultimately the hammer 175 during subsequent impact events) (BLOCK 4120). For example, in some embodiments, the controller 200 adjusts the average power supplied to the motor 105 according to the description above with regard to FIGS. 35A-40B, or any other methods of the description. Once the controller 200 adjusts the average power supplied to the motor 105, the method 4100 returns to BLOCK 4110.

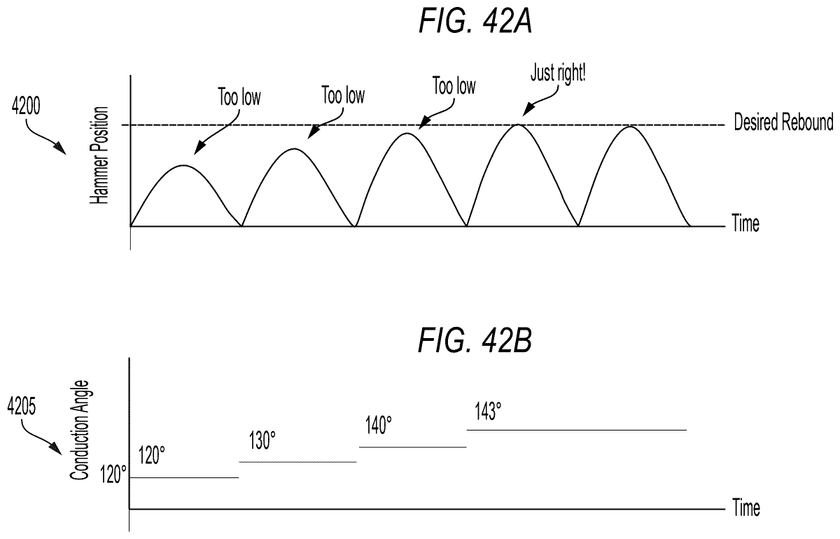

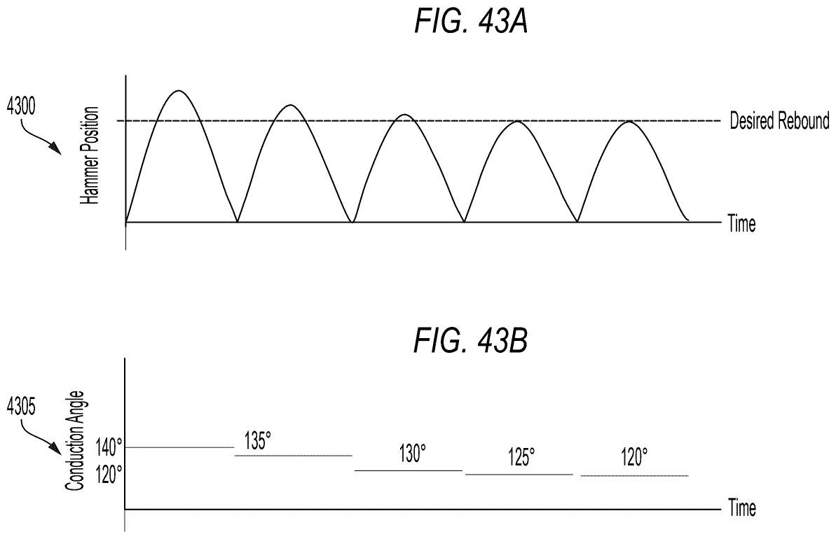

In some embodiments, the method 4100 is implemented without distinctions between the high power state 1305 and the low power state 1310. For example, the overall conduction angle of the motor can be controlled independent of the position of the hammer 175. As shown in FIGS. 42A and 41B, the hammer 175 is not rebounding to the hammer rebound threshold (as shown in graph 4200 in FIG. 42A). As a result, the controller 200 is configured to adjust (e.g., increase) the overall conduction angle being applied to the motor (as shown in graph 4205 in FIG. 42B). In some embodiments, the conduction angle can be adjusted after each impact. The conduction angle will continue to be adjusted until the hammer 175 rebounds to the hammer rebound threshold. Similarly, as shown in FIGS. 43A and 43B, the hammer 175 is rebounding past the hammer rebound threshold (as shown in graph 4300 in FIG. 43A). As a result, the controller 200 is configured to adjust (e.g., decrease) the overall conduction angle being applied to the motor (as shown in graph 4305 in FIG. 43B). In some embodiments, the conduction angle can be adjusted after each impact. The conduction angle will continue to be adjusted until the hammer 175 rebounds to the hammer rebound threshold.

In some embodiments, the high power state 1305 and the low power state 1310 are controlled using sine wave control. Sine wave control includes limiting the applied PWM signal with a duty cycle across an electrical cycle of the motor 105 to approximate applying a sine wave electromotive force (“EMF”) to the motor 105. In the low power state 1310, the motor 105 receives a lower amplitude sine wave than the sine wave received by the motor during the high power state 1305.

In some embodiments, an ideal EMF is applied to the motor 105 during the low power state 1310. The ideal EMF is determined by the controller 200 and applied to the motor 105 to produce ideal phase currents. In some embodiments, the maximum power conversion occurs at an ideal EMF when a power factor is maximized. When the power factor is maximized, the current drawn by the motor 105 and the back-EMF of the motor are the same.

In some embodiments, a stiffer bus voltage or a supercapacitor is used during the high power state 1305. The stiffness of the bus voltage is relative to the current drawn by the motor 105 during operation in the high power state 1305. In some embodiments, the stiffness of the bus voltage is reduced by battery pack impedance. With a higher pack impedance, the bus voltage will decrease at high loads or high power. As bus voltage decreases, the maximum power output and efficiency decreases. A supercapacitor can be used to maintain the bus voltage during a high power event to reduce the average current from the battery pack and reduce losses from the battery pack impedance. Therefore, during the high power state 1305, a higher peak power is maintained.

### Representative Features

Representative features are set out in the following clauses, which stand alone or may be combined, in any combination, with one or more features disclosed in the text and/or drawings of the specification.

1. A power tool comprising:
a housing;
a motor within the housing;
a power switching circuit that provides a supply of power from a battery pack to the motor;
an impact mechanism connected to the motor, the impact mechanism including:
   a hammer driven by the motor,
   an anvil configured to receive an impact from the hammer,
an output drive device configured to be driven by the impact mechanism;
a position sensor configured to generate an output signal indicative of a position of the hammer; and
an electronic controller configured to:
   determine the position of the hammer based on the output signal received from the position sensor;
   determine whether the position of the hammer is at a hammer rebound threshold; and
   adjust, in response to determining that the position of the hammer is not at the hammer rebound threshold, an average power supplied to the motor.

2. The power tool of clause 1, wherein the electronic controller is further configured to:
determine that the position of the hammer is less than the hammer rebound threshold; and
increase a conduction angle of the motor to increase the average power supplied to the motor.

3. The power tool of any of clauses 1-2, wherein the electronic controller is further configured to:
determine that the position of the hammer is greater than the hammer rebound threshold; and
decrease the conduction angle of the motor to decrease the average power supplied to the motor.

4. The power tool of clause 1, wherein the electronic controller is further configured to:
determine that the position of the hammer is less than the hammer rebound threshold; and
increase a phase advance angle of the motor to increase the average power supplied to the motor.

5. The power tool of any of clauses 1 and 4, wherein the electronic controller is further configured to:
determine that the position of the hammer is greater than the hammer rebound threshold; and
decrease the phase advance angle of the motor to decrease the average power supplied to the motor.

6. The power tool of clause 1, wherein the electronic controller is further configured to:
determine that the position of the hammer is less than the hammer rebound threshold; and
increase a duty cycle of a pulse-width modulated (PWM) signal supplied to the motor to increase the average power supplied to the motor.

7. The power tool of any of clauses 1 and 6, wherein the electronic controller is further configured to:
determine that the position of the hammer is greater than the hammer rebound threshold; and
decrease the duty cycle of the PWM signal supplied to the motor to decrease the average power supplied to the motor.

8. The power tool of clause 1, wherein the electronic controller is further configured to:
determine that the position of the hammer is less than the hammer rebound threshold; and
increase a torque current signal associated with the motor to increase the average power supplied to the motor.

9. The power tool of any of clauses 1 and 8, wherein the electronic controller is further configured to:
determine that the position of the hammer is greater than the hammer rebound threshold; and
decrease the torque current signal associated with the motor to decrease the average power supplied to the motor.

10. The power tool of clause 1, wherein the electronic controller is further configured to:
determine that the position of the hammer is less than the hammer rebound threshold; and
increase a flux current signal associated with the motor to increase the average power supplied to the motor.

11. The power tool of any of clauses 1 and 10, wherein the electronic controller is further configured to:
determine that the position of the hammer is greater than the hammer rebound threshold; and
decrease the flux current signal associated with the motor to decrease the average power supplied to the motor.

12. A method for adjusting average power supplied to a motor of a power tool, the power tool including an impact mechanism having a hammer driven by the motor and an anvil configured to receive an impact from the hammer, the method comprising:
determining, via an electronic controller, a position of the hammer based on an output signal received from a position sensor;
determining, via the electronic controller, whether the position of the hammer is at a hammer rebound threshold; and
adjusting, via the electronic controller and in response to determining that the position of the hammer is not at the hammer rebound threshold, an average power supplied to the motor.

13. The method of clause 12, further comprising:
determining, via the electronic controller, that the position of the hammer is less than the hammer rebound threshold; and
increasing, via the electronic controller, a conduction angle of the motor to increase the average power supplied to the motor.

14. The method of any of clauses 12-13, further comprising:
determining, via the electronic controller, that the position of the hammer is greater than the hammer rebound threshold; and
decreasing, via the electronic controller, the conduction angle of the motor to decrease the average power supplied to the motor.

15. The method of clause 12, further comprising:
determining, via the electronic controller, that the position of the hammer is less than the hammer rebound threshold; and
increasing, via the electronic controller, a phase advance angle of the motor to increase the average power supplied to the motor.

16. The method of any of clauses 12 and 15, further comprising:
determining, via the electronic controller, that the position of the hammer is greater than the hammer rebound threshold; and
decreasing, via the electronic controller, the phase advance angle of the motor to decrease the average power supplied to the motor.

17. The method of clause 12, further comprising:
determining, via the electronic controller, that the position of the hammer is less than the hammer rebound threshold; and
increasing, via the electronic controller, a duty cycle of a pulse-width modulated (PWM) signal supplied to the motor to increase the average power supplied to the motor.

18. The method of any of clauses 12 and 17, further comprising:
determining, via the electronic controller, that the position of the hammer is greater than the hammer rebound threshold; and
decreasing, via the electronic controller, the duty cycle of the PWM signal supplied to the motor to decrease the average power supplied to the motor.

19. The method of clause 12, further comprising:
determining, via the electronic controller, that the position of the hammer is less than the hammer rebound threshold; and
increasing, via the electronic controller, a torque current signal associated with the motor to increase the average power supplied to the motor.

20. The method of any of clauses 12 and 19, further comprising:
determining, via the electronic controller, that the position of the hammer is greater than the hammer rebound threshold; and
decreasing, via the electronic controller, the torque current signal associated with the motor to decrease the average power supplied to the motor.

21. The method of clause 12, further comprising:
determining, via the electronic controller, that the position of the hammer is less than the hammer rebound threshold; and
increasing, via the electronic controller, a flux current signal associated with the motor to increase the average power supplied to the motor.

22. The method of any of clauses 12 and 21, further comprising:
determining, via the electronic controller, that the position of the hammer is greater than the hammer rebound threshold; and
decreasing, via the electronic controller, the flux current signal associated with the motor to decrease the average power supplied to the motor.

23. A power tool comprising:
a housing;
a brushless direct current (DC) motor within the housing, the brushless DC motor including a rotor and a stator, the rotor coupled to a motor shaft to produce a rotational output; a power switching circuit that provides a supply of power from a battery pack to the brushless DC motor;
an impact mechanism connected to the motor shaft, the impact mechanism including a first position and a second position;
an output drive device configured to be driven by the impact mechanism as the impact mechanism moves between the first position and the second position; and
an electronic controller configured to:
   determine whether the impact mechanism is in the first position,
   operate, in response to determining that the impact mechanism is in the first position, in a high power state while the impact mechanism is moved from the first position to the second position,
   determine whether the impact mechanism is in the second position, and
   operate, in response to determining that the impact mechanism is in the second position, in a low power state while the impact mechanism is moved from the second position to the first position.

24. The power tool of clause 23, further comprising:
a sensor configured to generate a sensor signal,
wherein the electronic controller is further configured to receive the sensor signal from the sensor.

25. The power tool of clause 24, wherein the sensor signal indicates whether the impact mechanism is in the first position.

26. The power tool of any of clauses 23-25, wherein the sensor is a non-contact sensor.

27. The power tool of any of clauses 23-26, wherein the high power state is configured to apply a greater amount of field weakening than the low power state.

28. The power tool of any of clauses 23-27, wherein the electronic controller is further configured to:
apply a phase advance angle to control the brushless DC motor during the high power state.

29. The power tool of any of clauses 23-28, wherein the electronic controller is further configured to:
apply a field-oriented control (“FOC”) algorithm to control the brushless DC motor.

30. The power tool of any of clauses 23-29, wherein the electronic controller is further configured to:
apply a synchronous rectification mode when controlling the brushless DC motor.

31. The power tool of any of clauses 23-30, wherein the electronic controller is further configured to:
control a conduction angle of the brushless DC motor.

32. The power tool of any of clauses 23-31, wherein the electronic controller includes a machine learning controller.

33. A method of controlling a power tool comprising:
driving a brushless direct current (DC) motor, the brushless DC motor including a rotor and a stator, the rotor is connected to a motor shaft to produce a rotational output;
supplying, via a power switching circuit, power from a battery pack to the brushless DC motor;
driving an output drive device using an impact mechanism, the impact mechanism including a first position and a second position;
determining, using an electronic controller, whether the impact mechanism is in the first position;
operating, in response to determining that the impact mechanism is in the first position, in a high power state while the impact mechanism is moved from the first position to the second position;
determining whether the impact mechanism is in the second position; and
operating, in response to determining that the impact mechanism is in the second position, in a low power state while the impact mechanism is moved from the second position to the first position.

34. The method of clause 33, further comprising:
generating, via a sensor, a sensor signal;
receiving, via the electronic controller, the sensor signal from the sensor.

35. The method of clause 34, wherein the sensor signal indicates whether the impact mechanism is in the first position.

36. The method of any of clauses 33-35, wherein the sensor is a non-contact sensor.

37. The method of any of clauses 33-36, wherein operating in the high power state applies a greater amount of field weakening than operating in the low power state.

38. The method of any of clauses 33-37, further comprising:
applying, via the electronic controller, a phase advance angle to control the brushless DC motor during the high power state.

39. The method of any of clauses 33-38, further comprising:
applying, via the electronic controller, a field-oriented control (“FOC”) algorithm to control the brushless motor.

40. The method of any of clauses 33-39, further comprising:
applying, via the electronic controller, a synchronous rectification mode when controlling the brushless DC motor.

41. The method of any of clauses 33-40, further comprising:
controlling, via the electronic controller, a conduction angle of the brushless DC motor.

42. The method of any of clauses 33-41, wherein the electronic controller includes a machine learning controller.

43. A power tool comprising:
a housing;
a motor within the housing;
a power switching circuit that provides a supply of power from a battery pack to the motor;
an impact mechanism connected to the motor, the impact mechanism including a first position and a second position;
an output drive device configured to be driven by the impact mechanism as the impact mechanism moves between the first position and the second position; and
an electronic controller configured to:
   determine whether the impact mechanism is in the first position,
   operate in a high power state while the impact mechanism is moved from the first position to the second position,
   determine whether the impact mechanism is in the second position, and
   operate in a low power state while the impact mechanism is moved from the second position to the first position.

44. The power tool of clause 43, further comprising:
a sensor configured to generate a sensor signal,
wherein the electronic controller is further configured to receive the sensor signal from the sensor.

45. The power tool of clause 44, wherein the sensor signal indicates whether the impact mechanism is in the first position.

46. The power tool of any of clauses 43-45, wherein the sensor is a non-contact sensor.

47. The power tool of any of clauses 43-46, wherein the high power state is configured to apply a greater amount of field weakening than the low power state.

48. The power tool of any of clauses 43-47, wherein the electronic controller is further configured to:
apply a phase advance angle to control the brushless DC motor during the high power state.

49. The power tool of any of clauses 43-48, wherein the electronic controller is further configured to:
apply a field-oriented control (“FOC”) algorithm to control the brushless DC motor.

50. The power tool of any of clauses 43-49, wherein the electronic controller is further configured to:
apply a synchronous rectification mode when controlling the brushless DC motor.

51. The power tool of any of clauses 43-50, wherein the electronic controller is further configured to:
control a conduction angle of the brushless DC motor.

52. The power tool of clause 51, wherein the electronic controller is further configured to determine whether a hammer of the impact mechanism rebounds to a hammer rebound threshold.

53. The power tool of clause 52, wherein the electronic controller is further configured to:
increase the conduction angle if the hammer of the impact mechanism does not rebound to the hammer rebound threshold.

54. The power tool of clause 53, wherein the electronic controller is further configured to:
decrease the conduction angle if the hammer of the impact mechanism rebound exceeds the hammer rebound threshold.

55. The power tool of any of clauses 43-53, wherein the electronic controller includes a machine learning controller.

Thus, embodiments described herein provide systems and methods for implementing a high power state and a low power state in a power tool. Various features and advantages are set forth in the following claims.

1. A power tool comprising:
a housing;
a motor within the housing;
a power switching circuit that provides a supply of power from a battery pack to the motor;
an impact mechanism connected to the motor, the impact mechanism including:
a hammer driven by the motor,
an anvil configured to receive an impact from the hammer,
an output drive device configured to be driven by the impact mechanism;
a position sensor configured to generate an output signal indicative of a position of the hammer; and
an electronic controller configured to:
determine the position of the hammer based on the output signal received from the position sensor,
determine whether the position of the hammer is at a hammer rebound threshold; and
adjust, in response to determining that the position of the hammer is not at the hammer rebound threshold, an average power supplied to the motor.

2. The power tool of claim 1, wherein the electronic controller is further configured to:
determine that the position of the hammer is less than the hammer rebound threshold; and
increase a conduction angle of the motor to increase the average power supplied to the motor.

3. The power tool of claim 2, wherein the electronic controller is further configured to:
determine that the position of the hammer is greater than the hammer rebound threshold; and
decrease the conduction angle of the motor to decrease the average power supplied to the motor.

4. The power tool of claim 1, wherein the electronic controller is further configured to:
determine that the position of the hammer is less than the hammer rebound threshold; and
increase a phase advance angle of the motor to increase the average power supplied to the motor.

5. The power tool of claim 4, wherein the electronic controller is further configured to:
determine that the position of the hammer is greater than the hammer rebound threshold; and
decrease the phase advance angle of the motor to decrease the average power supplied to the motor.

6. The power tool of claim 1, wherein the electronic controller is further configured to:
determine that the position of the hammer is less than the hammer rebound threshold; and
increase a duty cycle of a pulse-width modulated (PWM) signal supplied to the motor to increase the average power supplied to the motor.

7. The power tool of claim 6, wherein the electronic controller is further configured to:
determine that the position of the hammer is greater than the hammer rebound threshold; and
decrease the duty cycle of the PWM signal supplied to the motor to decrease the average power supplied to the motor.

8. The power tool of claim 1, wherein the electronic controller is further configured to:
determine that the position of the hammer is less than the hammer rebound threshold; and
increase a torque current signal associated with the motor to increase the average power supplied to the motor.

9. The power tool of claim 8, wherein the electronic controller is further configured to:
determine that the position of the hammer is greater than the hammer rebound threshold; and
decrease the torque current signal associated with the motor to decrease the average power supplied to the motor.

10. The power tool of claim 1, wherein the electronic controller is further configured to:
determine that the position of the hammer is less than the hammer rebound threshold; and
increase a flux current signal associated with the motor to increase the average power supplied to the motor.

11. The power tool of claim 10, wherein the electronic controller is further configured to:
determine that the position of the hammer is greater than the hammer rebound threshold; and
decrease the flux current signal associated with the motor to decrease the average power supplied to the motor.

12. A method for adjusting average power supplied to a motor of a power tool, the power tool including an impact mechanism having a hammer driven by the motor and an anvil configured to receive an impact from the hammer, the method comprising:
determining, via an electronic controller, a position of the hammer based on an output signal received from a position sensor;
determining, via the electronic controller, whether the position of the hammer is at a hammer rebound threshold; and
adjusting, via the electronic controller and in response to determining that the position of the hammer is not at the hammer rebound threshold, an average power supplied to the motor.

13. The method of claim 12, further comprising:
determining, via the electronic controller, that the position of the hammer is less than the hammer rebound threshold; and
increasing, via the electronic controller, a conduction angle of the motor to increase the average power supplied to the motor.

14. The method of claim 13, further comprising:
determining, via the electronic controller, that the position of the hammer is greater than the hammer rebound threshold; and
decreasing, via the electronic controller, the conduction angle of the motor to decrease the average power supplied to the motor.

15. The method of claim 12, further comprising:
determining, via the electronic controller, that the position of the hammer is less than the hammer rebound threshold; and
increasing, via the electronic controller, a phase advance angle of the motor to increase the average power supplied to the motor.

16. The method of claim 15, further comprising:
determining, via the electronic controller, that the position of the hammer is greater than the hammer rebound threshold; and
decreasing, via the electronic controller, the phase advance angle of the motor to decrease the average power supplied to the motor.

17. The method of claim 12, further comprising:
determining, via the electronic controller, that the position of the hammer is less than the hammer rebound threshold; and
increasing, via the electronic controller, a duty cycle of a pulse-width modulated (PWM) signal supplied to the motor to increase the average power supplied to the motor.

18. The method of claim 17, further comprising:
determining, via the electronic controller, that the position of the hammer is greater than the hammer rebound threshold; and
decreasing, via the electronic controller, the duty cycle of the PWM signal supplied to the motor to decrease the average power supplied to the motor.

19. The method of claim 12, further comprising:
determining, via the electronic controller, that the position of the hammer is less than the hammer rebound threshold; and
increasing, via the electronic controller, a torque current signal associated with the motor to increase the average power supplied to the motor.

20. The method of claim 19, further comprising:
determining, via the electronic controller, that the position of the hammer is greater than the hammer rebound threshold; and
decreasing, via the electronic controller, the torque current signal associated with the motor to decrease the average power supplied to the motor.

21. The method of claim 12, further comprising:
determining, via the electronic controller, that the position of the hammer is less than the hammer rebound threshold; and
increasing, via the electronic controller, a flux current signal associated with the motor to increase the average power supplied to the motor.

22. The method of claim 21, further comprising:
determining, via the electronic controller, that the position of the hammer is greater than the hammer rebound threshold; and
decreasing, via the electronic controller, the flux current signal associated with the motor to decrease the average power supplied to the motor.

23-55. (canceled)
